(19) United States
(12) Patent Application Publication
(10) Pub. No.: US 2025/0001504 A1
(43) Pub. Date: Jan. 2, 2025

(54) POWDER LOADING IN THREE-DIMENSIONAL PRINTING

(71) Applicant: Velo3D, Inc., Fremont, CA (US)

(72) Inventors: Abraham Saldivar Valdes, Menio Park, CA (US); Alexander Vladimirovich Varlakhanov, San Carlos, CA (US); Joseph Andrew Tralongo, El Cajon, CA (US); Benyamin Buller, Cupertino, CA (US); Gregory Adam Toland, San Jose, CA (US); Alexander John Fisher, San Jose, CA (US); Tyler James Mori, San Jose, CA (US)

(73) Assignee: Velo3D, Inc., Fremont,, CA (US)

(21) Appl. No.: 18/755,606

(22) Filed: Jun. 26, 2024

Related U.S. Application Data
(60) Provisional application No. 63/524,206, filed on Jun. 29, 2023.

(51) Int. Cl. B22F 12/55; B22F 10/30; B22F 12/90; B28B 1/00; B28B 17/00; B33Y 30/00; B33Y 50/00; B33Y 70/00

(52) U.S. Cl. CPC B22F 12/55; B22F 10/30; B22F 12/90; B28B 1/001; B28B 17/0081; B33Y 30/00; B33Y 50/00; B33Y 70/00

(57) ABSTRACT

The present disclosure provides three-dimensional (3D) printing systems, devices, apparatuses, methods, and non-transitory computer readable media for loading new powder into a three-dimensional printer, e.g., during the printing. The manner of loading the new powder may reduce degradation of the powder and/or reduce in the printed 3D object an amount of reaction product(s) of the powder with reactive agent(s) present in the atmosphere.

### CROSS-REFERENCE TO RELATED PATENT APPLICATIONS

This application is a U.S. Non-provisional patent application, which claims the benefit of and priority to U.S. Provisional Patent Application No. 63/524,206 filed on Jun. 29, 2023, entitled “POWDER LOADING IN THREE-DIMENSIONAL PRINTING,” the entirety of which is incorporated by reference herein in its entirety for all purposes.

### BACKGROUND

Three-dimensional (3D) printing (e.g., additive manufacturing) is a process for making a three-dimensional object of any shape from a design. The design may be in the form of a data source such as an electronic data source or may be in the form of a hard copy. The hard copy may be a two-dimensional representation of a 3D object. The data source may be an electronic 3D model. 3D printing may be accomplished through an additive process in which successive layers of material are laid down one on top of another. This process may be controlled (e.g., computer controlled, manually controlled, or both). A 3D printer can be an industrial robot.

3D printing can generate custom parts. A variety of materials can be used in a 3D printing process including elemental metal, metal alloy, ceramic, an allotrope of elemental carbon, or polymeric material. In some 3D printing processes (e.g., additive manufacturing), a first layer of hardened material is formed (e.g., by welding powder), and thereafter successive layers of hardened material are added one by one, wherein each new layer of hardened material is added on a pre-formed layer of hardened material, until the entire designed three-dimensional structure (3D object) is layer-wise materialized.

3D models may be created with a computer aided design package, via 3D scanner, or manually. The manual modeling process of preparing geometric data for 3D computer graphics may be similar to plastic arts, such as sculpting or animating. 3D scanning is a process of analyzing and collecting digital data on the shape and appearance of a real object (e.g., real-life object). Based on this data, 3D models of the scanned object can be produced.

A number of 3D printing processes are currently available. They may differ in the manner layers are deposited to create the materialized 3D structure (e.g., hardened 3D structure). They may vary in the material or materials that are used to materialize the designed 3D object. Some methods melt, sinter, or soften material to produce the layers that form the 3D object. Examples for 3D printing methods include selective laser melting (SLM), selective laser sintering (SLS), direct metal laser sintering (DMLS) or fused deposition modeling (FDM). Other methods cure liquid materials using different technologies such as stereo lithography (SLA). In the method of laminated object manufacturing (LOM), thin layers (made inter alia of paper, polymer, or metal) are cut to shape and joined together.

In some embodiments, a remainder of the starting material utilized for the 3D printing is recycled, e.g., to be used in the 3D printing cycle or for another 3D printing cycle. During the recycling process, the powder may experience loss and/or degradation. The loss and/or degradation may accumulate during multiple recycling cycles of the powder. The accumulating degradation in the powder may affect the resulting 3D object manufactured therefrom, which may compromise performance of the 3D object for its intended purpose. The degradation may accumulate during a printing cycle of a 3D object, e.g., which could result in a gradient of degraded material properties along the layers of hardened material forming the printed 3D object.

### SUMMARY OF THE INVENTION

In some aspects, the present disclosure resolves the aforementioned hardships. In some embodiments, the recycled powder is supplemented with new powder, e.g., in the amount corresponding to the powder loss. Such supplementation may be continuous, intermittent, or semi-continuous (e.g., at an “as needed” basis). Such supplementation may be automatic and/or manual.

In another aspect, a device for three-dimensional (3D) printing a three-dimensional (3D) object, the device comprises: a buffer reservoir configured to enclose new material to be used as starting material for the 3D printing; a valve configured to provide the new material to a remainder material to generate a starting material for the 3D printing, the remainder material being previously used in the 3D printing or in another 3D printing operation, where a powder material comprises the starting material, the new material, or the remainder material; and a powder conveyance system configured to operatively couple with the valve, the powder conveyance system configured to allow the powder material to pass therethrough, the powder material being degraded during its passage in the powder conveyance system and/or during the printing, where accumulation in the 3D object of the powder material that is degraded compromises an intended function of the 3D object when the accumulation is at a first level beyond a threshold, and where the valve is configured to facilitate addition of the new material to the powder conveyance system to maintain in the 3D object a steady state of the powder material that is degraded at a second level below or at the threshold. In some embodiments, the powder conveyance system is configured to enclosure a robust gas comprising a reactive agent in a concentration lower than that in an ambient atmosphere external to the powder conveyance system, the reactive agent being configured to react with the powder material to generate a reaction product (a) during propagation of the powder material in the powder conveyance system and/or (b) during the printing, the degradation of the powder material comprising the reaction product. In some embodiments, the reactive agent comprises hydrogen, oxygen, or hydrogen oxide. In some embodiments, the reactive product comprises an oxide, a hydride, or a hydroxide. In some embodiments, an atmosphere of an enclosure in which the 3D object is printed comprises the robust gas. In some embodiments, the robust gas comprises the reactive agent at a level lower than its level in an ambient atmosphere external to the device. In some embodiments, the robust gas comprises an inert gas. In some embodiments, the robust gas comprises nitrogen or argon. In some embodiments, the device is configured to facilitate the 3D printing of the 3D object that is (e.g., substantially and/or detectibly) devoid of a layerwise gradient of the reaction product in the layers of the 3D object. In some embodiments, the powder material comprises elemental metal, metal alloy, an allotrope of elemental carbon, or a ceramic. In some embodiments, the powder material comprises elemental metal, or metal alloy. In some embodiments, the 3D printing comprises fusing the powder material. In some embodiments, the fusing comprises melting or sintering. In some embodiments, the 3D printing comprises layerwise deposition of the starting material to layerwise print the 3D object. In some embodiments, the 3D printing comprises layerwise deposition of the starting material to generate a material bed from which the 3D object is printed during the 3D printing. In some embodiments, the valve comprises a venturi valve. In some embodiments, the valve is configured to control flow of the new material into the powder conveyance system continuously, intermittently, or not flow. In some embodiments, the valve is configured to control flow of the new material into the powder conveyance at least in part by flowing robust gas into the valve. In some embodiments, the valve is configured to control the flow of the new material into the powder conveyance at least in part by flowing robust gas into the valve in a direction towards an entrance port to the powder conveyance system. In some embodiments, the powder conveyance system comprises a channel, and where the powder conveyance system is configured to operatively couple with the valve by the channel being operatively coupled to the valve. In some embodiments, the channel is included in a recycling system configured to recycle the remainder material to be used as the starting material for a subsequent 3D printing operation. In some embodiments, the powder conveyance system comprises a separator, and where the powder conveyance system is configured to operatively couple with the valve by the separator being operatively coupled to the valve. In some embodiments, the separator is included in a recycling system configured to recycle the remainder material to be used as the starting material for a subsequent 3D printing operation. In some embodiments, the separator comprises a cyclonic separator or a sieve assembly. In some embodiments, the powder conveyance system comprises a reservoir, and where the powder conveyance system is configured to operatively couple with the valve by the reservoir being operatively coupled to the valve. In some embodiments, the reservoir is configured to direct material to a material dispensing mechanism configured to dispense the starting material to print the 3D object. In some embodiments, the reservoir is included in a recycling system configured to recycle the remainder material to be used as the starting material for a subsequent 3D printing operation. In some embodiments, the device is configured to operatively couple with a recycling system that (i) recycles at least a fraction of a portion of the powder (e.g., remainder) material removed by the remover and/or (ii) provides at least a portion of the powder (e.g., starting) material utilized by the dispenser in subsequent deposition. In some embodiments, the portion removed by the remover is at least about 95%, 90%, 80%, 70%, 50% or 30% of the starting material dispensed. In some embodiments, the fraction of the starting material recycled is at least about 70%, 80%, 90%, 95%, or 98% of the portion removed by the remover. In some embodiments, the reservoir is configured to direct material to a material dispensing mechanism as part of a layer dispensing mechanism configured to dispense the starting material layerwise to print the 3D object. In some embodiments, the layer dispensing mechanism is configured to facilitate dispensing of the starting material on the target surface at least in part by layerwise deposition.

In some embodiments, the layer dispensing mechanism is configured to deposit starting material comprising elemental metal, metal alloy, ceramic, or an allotrope of carbon. In some embodiments, the layer dispensing mechanism is configured to is configured to deposit the starting material comprising a polymer or a resin. In some embodiments, the layer dispensing mechanism comprises a remover configured to remove a portion of the starting material dispensed to generate a planar layer of starting material, the planar layer utilized in the 3D printing of the 3D object. In some embodiments, the remover is operatively coupled with an attractive force source sufficient to attract the starting material from the target surface. In some embodiments, the attractive force comprises a magnetic, electric, electrostatic, or vacuum source. In some embodiments, the attractive force comprises a vacuum source. In some embodiments, the buffer reservoir is configured to enclose an internal atmosphere that is different by at least one characteristic from an ambient environment external to the buffer reservoir. In some embodiments, the buffer reservoir is configured to enclose a first internal atmosphere that is different by at least one characteristic from the ambient environment external to the buffer reservoir, and that is (e.g., substantially) the same as the second internal atmosphere of the powder conveyance system. In some embodiments, the powder conveyance system is configured to mix the new material with the remainder material to generate the starting material for a subsequent 3D printing operation. In some embodiments, the 3D printing operation comprises forming a portion of the 3D object. In some embodiments, the 3D printing operation comprises forming at least a portion of an other 3D object. In some embodiments, the powder conveyance system is configured to mix the new material with the remainder material at least in part by (a) flowing it in a channel of the powder conveyance system, (b) inserting it into a separation process in a separator of the powder conveyance system, and/or (c) adding the new material and the remainder material interchangeable into a reservoir of the powder conveyance system. In some embodiments, the reservoir is configured for addition of the powder material such that the added powder is disposed in the reservoir above an exit port. In some embodiments, the reservoir is configured to facilitate gravitational flow of the powder through the exit port. In some embodiments, the reservoir is configured to facilitate mixing of the powder as it flows out of the exit port. In some embodiments, the reservoir is configured to facilitate tumbling of the powder as it flows out of the exit port. In some embodiments, the reservoir is a hopper. In some embodiments, the device further comprises a dosing reservoir configured to allow equilibration of the interior atmosphere of the dosing reservoir to be (e.g., substantially) equal to the atmosphere of an enclosure in which the 3D object is printed in the 3D printing. In some embodiments, an interior atmosphere is (e.g., substantially) equal to the atmosphere of an enclosure in which the 3D object is printed in the 3D printing, the interior atmosphere being of (a) the buffer reservoir and/or (b) the powder conveyance system. In some embodiments, the enclosure comprises a processing chamber and a build module configured to reversibly engage and disengage from the processing chamber. In some embodiments, the powder material is degraded during its passage in the powder conveyance at least in part by colliding with at least one internal wall of a channel of the powder conveyance system. In some embodiments, the powder material is degraded during its passage in the powder conveyance at least in part by powder particles of the powder material colliding with at each other. In some embodiments, an amount of the powder material is degraded at least in part by being lost during the 3D printing. In some embodiments, degradation of the powder due to loss of powder comprises (a) loss of the powder material as it is converted to debris as a byproduct of the 3D printing, and (b) loss of the powder material to generate the 3D object. In some embodiments, the device is configured to add the new material to the powder conveyance system according to its rate of degradation. In some embodiments, the device is configured to add the new material to the powder conveyance system continuously, semi-continuously, or intermittently. In some embodiments, the device is configured to add the new material to the powder conveyance system semi-continuously when there is loss of the powder material. In some embodiments, the device is configured to add the new material to the powder conveyance system semi-continuously when there is loss of the powder material required to print the 3D object. In some embodiments, the buffer reservoir, and/or the powder conveyance system is configured to hold a pressure different than that of the ambient atmosphere. In some embodiments, the buffer reservoir, and/or the powder conveyance system is configured to hold a positive pressure (e.g., overpressure) relative to the pressure of the ambient atmosphere. In some embodiments, at least a portion of the powder conveyance system is configured to convey the powder material gravitationally. In some embodiments, at least a portion of the powder conveyance system is configured to convey the powder material against the gravitational vector pointing towards the gravitational center of the ambient environment. In some embodiments, the gravitational center is a gravitational center of an environment in which the device is disposed. In some embodiments, the environment is Earth. In some embodiments, at least a portion of the powder conveyance system is configured to convey the powder material in a channel of the powder conveyance system in a dilute phase conveyance or in a dense phase conveyance. In some embodiments, the material bed is supported by a build platform comprises at least one fundamental length scale having a value of at least about 300 mm, 350 mm, 400 mm, 600 mm, 1000 mm, 1200, 1500, or 1750 mm. In some embodiments, the material bed comprises a weight of at least about 1000 kg. In some embodiments, the device is configured to facilitate the three-dimensional printing by facilitating vertical translation of a build platform comprising an error in vertical positioning of the vertical translation at most about 10%, 5%, or 2% of the vertical translation of the build platform, the build platform configured to support the 3D object at least during its printing. In some embodiments, the device is configured to facilitate the three-dimensional printing at least in part by being configured to control deposition of the starting material on a target surface. In some embodiments, the target surface comprises (i) an exposed surface of a material bed or (ii) a surface of the build platform. In some embodiments, the powder material comprises a polymer or a resin. In some embodiments, the device is configured to operate under a positive pressure atmosphere relative to an ambient pressure of an ambient atmosphere external to the device. In some embodiments, the device is configured to operate under an atmosphere depleted of a reactive agent relative to its concentration in an ambient atmosphere external to the device, the reactive agent being configured to react at least during the printing with (i) a starting material of the 3D object and/or (ii) a byproduct of the printing. In some embodiments, the reactive agent comprises oxygen, water, or hydrogen sulfide. In some embodiments, the powder conveyance system and/or the buffer reservoir, comprises a seal. In some embodiments, the seal is included, or is operatively coupled to a shutter, a lid, a closure, an envelope, or a flap. In some embodiments, the seal is gas tight. In some embodiments, the seal is a hermetic seal. In some embodiments, the seal is configured to facilitate retaining an internal atmosphere for a time period, the internal atmosphere being different from an ambient atmosphere external to the device, the internal atmosphere being of the powder conveyance system and/or of the buffer reservoir. In some embodiments, the seal is configured to facilitate retaining for a time period (i) a positive pressure within the internal atmosphere relative to an ambient atmosphere external to the device, (ii) a reactive agent at a concentration lower than its concentration in an ambient atmosphere external to the device, the reactive agent being configured to at least react with the powder material and/or byproduct of the 3D printing at least during the 3D printing, or (iii) a combination of (i) and (ii). In some embodiments, the device is configured to facilitate printing the 3D object in an atmosphere maintained to be different from an ambient atmosphere by at least one characteristic, the ambient atmosphere being external to the powder conveyance system and/or to the buffer reservoir. In some embodiments, the at least one characteristic comprises (i) a pressure above a pressure presiding in the ambient atmosphere, or (ii) a reactive agent being at a concentration lower than its concentration in the ambient atmosphere, the reactive agent being reactive at least during the printing with (i) a starting material of the 3D object and/or (ii) a byproduct of the 3D printing. In some embodiments, a 3D printer comprises the device, or is operatively coupled to the device; and where during the 3D printing, the 3D printer is configured to facilitate gas flow away from one or more optical windows and in a direction towards the build platform, the one or more optical windows being of the 3D printer. In some embodiments, the portion of the 3D printing comprises arc welding. In some embodiments, arc welding is by an arc welder to facilitate printing the 3D object comprises: generating a powder stream and focusing an energy beam on the powder stream. In some embodiments, the device is configured to comprise, or operatively coupled to, the arc welder. In some embodiments, the device is configured to facilitate the 3D printing, where a portion of the 3D printing comprises connecting the powder material to facilitate printing the 3D object. In some embodiments, at least a portion of the powder material is disposed in a material bed during the 3D printing. In some embodiments, the portion of the 3D printing comprises a fusing process. In some embodiments, fusing comprises (i) sintering, (ii) melting, (iii) smelting, or (iv) any combination of (i)-(iii). In some embodiments, the powder material comprises a super alloy. In some embodiments, the super alloy comprises Inconel, In Ti F Haynes GRCop-C CA6NM, or Hastelloy-X.

In another aspect, an apparatus for three-dimensional printing, the apparatus comprising at least one controller configured to (i) operatively couple with the device in any of the above devices; and control, or direct control of, one or more operations associated with the device. In some embodiments, the at least one controller comprise at least one connector configured to connect to a power source. In some embodiments, the at least one controller being configured to operatively couple with a power source at least in part by (I) having a power socket and/or (II) being configured for wireless power transfer using inductive charging. In some embodiments, the at least one controller is included in, or comprises, a hierarchical control system. In some embodiments, the hierarchical control system comprises at least three hierarchical control levels. In some embodiments, the at least one controller is included in a control system configured to control the 3D printer that prints the 3D object. In some embodiments, the device comprised in the 3D printer, and where the at least one controller is configured to (i) operatively couple with an other device of the 3D printer and (ii) direct operation of the other device. In some embodiments, the at least one controller is configured to direct operation of the other device for the printing of the 3D object. In some embodiments, the at least one controller is operatively coupled to at least about 900 sensors, or 1000 sensors, operatively coupled with the 3D printer. In some embodiments, at least during the printing, the at least one controller is configured to control a pressure in the device and/or in the 3D printer to be above ambient pressure external to the three-dimensional printer. In some embodiments, the at least one controller is configured to control an internal atmosphere of the buffer reservoir, the powder conveyance system, and/or the 3D printer to be depleted of at least one reactive agent relative to its concentration in an ambient atmosphere external to the device, the reactive agent being configured to react at least during the printing with (i) the powder material and/or (ii) a byproduct of the 3D printing. In some embodiments, the byproduct of the printing comprises soot, spatter, or splatter.

In another aspect, non-transitory computer readable program instructions for three-dimensional printing, the program instructions, when read by one or more processors operatively coupled to the device in any of the above devices, cause the one or more processors to execute, or direct execution of, one or more operations associated with the device. In some embodiments, the program instructions are inscribed in one or more media.

In another aspect, a system for three-dimensional printing, the system comprises: the device of any of the above devices configured to perform the 3D printing; and an energy beam configured to irradiate a planar layer of powder material to print at least a portion of the 3D object by using the 3D printing. In some embodiments, the system further comprises a scanner configured to translate the energy beam along a target surface, where the device is operatively coupled to the scanner disposed in an optical chamber that is modular and/or translatable with respect to the target surface. In some embodiments, the scanner is configured to be translatable with respect to the target surface during the three-dimensional printing. In some embodiments, the system further comprises an energy source configured to generate the energy beam, where the device is operatively coupled to the energy source. In some embodiments, the energy source comprises a laser source or an electron beam source. In some embodiments, the system further comprises at least one controller that (i) is operatively coupled to the device and (ii) direct one or more operations associated with the device. In some embodiments, the system is configured to operatively couple to at least one controller configured to (i) operatively couple to the system and (ii) direct one or more operations associated with the system. In another aspect, a system for effectuating the methods, operations of an apparatus, and/or operations inscribed by non-transitory computer readable program instructions (e.g., inscribed on a media/medium), disclosed herein.

In another aspect, a system for effectuating the methods, operations of an apparatus, operation of a device, and/or operations inscribed by non-transitory computer readable program instructions (e.g., inscribed on a media/medium), disclosed herein.

In another aspect, device(s) (e.g., apparatus) for effectuating the methods, operations of an apparatus, and/or operations inscribed by non-transitory computer readable program instructions (e.g., inscribed on a media/medium).

In other aspects, systems, apparatuses (e.g., controller(s)), and/or non-transitory computer-readable program instructions (e.g., software) that implement any of the methods disclosed herein. In some embodiments, the program instructions is inscribed on at least one medium (e.g., on a medium or on media).

In other aspects, methods, systems, apparatuses (e.g., controller(s)), and/or non-transitory computer-readable program instructions (e.g., software) that implement any of the devices disclosed herein and/or any operation of these devices. In some embodiments, the program instructions is inscribed on at least one medium (e.g., on a medium or on media).

In another aspect, an apparatus (e.g., for printing one or more 3D objects) comprises at least one controller that is configured (e.g., programmed) to direct a mechanism used in a 3D printing methodology to implement (e.g., effectuate) any of the method and/or operations disclosed herein, wherein the controller(s) is operatively coupled with the mechanism. In some embodiments, the controller(s) implements any of the methods and/or operations disclosed herein. In some embodiments, the at least one controller comprises, or be operatively coupled with, a hierarchical control system. In some embodiments, the hierarchical control system comprises at least three, four, or five, control levels. In some embodiments, at least two operations are performed, or directed, by the same controller. In some embodiments, at least two operations are each performed, or directed, by a different controller.

In another aspect, an apparatus (e.g., for printing one or more 3D objects) comprises at least one controller that is configured (e.g., programmed) to implement (e.g., effectuate), or direct implementation of, the method, process, and/or operation disclosed herein. In some embodiments, the at least one controller implements any of the methods, processes, and/or operations disclosed herein.

In another aspect, non-transitory computer readable program instructions (e.g., for printing one or more 3D objects), when read by one or more processors, are configured to execute, or direct execution of, the method, process, and/or operation disclosed herein. In some embodiments, the at least one controller implements any of the methods, processes, and/or operations disclosed herein. In some embodiments, at least a portion of the one or more processors is part of a 3D printer, outside of the 3D printer, or in a location remote from the 3D printer (e.g., in the cloud).

In another aspect, a system for printing one or more 3D objects comprises an apparatus (e.g., used in a 3D printing methodology) and at least one controller that is configured (e.g., programmed) to direct operation of the apparatus, wherein the at least one controller is operatively coupled with the apparatus. In some embodiments, the apparatus includes any apparatus or device disclosed herein. In some embodiments, the at least one controller implements, or direct implementation of, any of the methods disclosed herein. In some embodiments, the at least one controller directs any apparatus (or component thereof) disclosed herein.

In some embodiments, at least two of operations (e.g., instructions) of the apparatus are directed by the same controller. In some embodiments, at least two of operations (e.g., instructions) of the apparatus are directed by different controllers.

In some embodiments, at least two of operations (e.g., instructions) are carried out by the same processor and/or by the same sub-computer software product. In some embodiments, at least two of operations (e.g., instructions) are carried out by different processors and/or by different sub-computer software products.

In another aspect, a computer software product, comprising a (e.g., non-transitory) computer-readable medium/media in which program instructions are stored, which instructions, when read by a computer, cause the computer to direct a mechanism used in the 3D printing process to implement (e.g., effectuate) any of the method disclosed herein, wherein the non-transitory computer-readable medium is operatively coupled with the mechanism. In some embodiments, the mechanism comprises an apparatus or an apparatus component.

In another aspect, a computer system comprising one or more computer processors and non-transitory computer-readable medium/media coupled thereto. In some embodiments, the non-transitory computer-readable medium/media comprises machine-executable code that, upon execution by the one or more computer processors, implements any of the methods and/or operations (e.g., as disclosed herein), and/or effectuates directions of the controller(s) (e.g., as disclosed herein).

In another aspect, a method for three-dimensional printing, the method comprises executing one or more operations associated with at least one configuration of the device(s) disclosed herein.

In another aspect, an apparatus for three-dimensional printing, the apparatus comprising at least one controller is configured (i) operatively couple to the device, and (ii) direct executing one or more operations associated with at least one configuration of the device(s) disclosed herein.

In another aspect, at least one controller is associated with the methods, devices, and software disclosed herein. In some embodiments, the at least one controller comprise at least one connector configured to connect to a power source. In some embodiments, the at least one controller being configured to operatively couple to a power source at least in part by (I) having a power socket and/or (II) being configured for wireless power transfer using inductive charging. In some embodiments, the at least one controller is included in, or comprises, a hierarchical control system. In some embodiments, the hierarchical control system comprises at least three hierarchical control levels. In some embodiments, the at least one controller is included in a control system configured to control a three-dimensional printer that prints the one or more three-dimensional objects. In some embodiments, the at least one controller is configured to control at least one other component of a 3D printing system. In some embodiments, the device disclosed herein is a component of a three-dimensional printing system, and wherein the at least one controller is configured to (i) operatively couple to another component of the three-dimensional printing system and (ii) direct operation of the other component. In some embodiments, the at least one controller is configured to direct operation of the other component at least in part for participation of the other component in three-dimensional printing. In some embodiments, the at least one controller is operatively coupled with at least about 900 sensors, or 1000 sensors operatively couple to the three-dimensional printer. In some embodiments, the at least one controller is configured to control a pressure in the three-dimensional printer to be above ambient pressure external to the three-dimensional printer. In some embodiments, the at least one controller is configured to control an internal atmosphere of the three-dimensional printer to be depleted of a reactive agent relative to its concentration in an ambient atmosphere external to the device, the reactive agent being configured to react with a starting material of the three-dimensional printing at least during the three-dimensional printing.

In another aspect, non-transitory computer readable program instructions for three-dimensional printing, the non-transitory computer readable program instructions, when read by one or more processors operatively coupled to the device, cause the one or more processors to direct executing one or more operations associated with at least one configuration of the device(s) disclosed herein.

In some embodiments, the program instructions are of a computer product.

In another aspect, a system for three-dimensional printing, the system comprising: the any of the devices above; and an energy beam configured to irradiate powder (e.g., a planar layer of powder) to print at least a portion of at least one three-dimensional object at least in part by using three-dimensional printing. In some embodiments, the system further comprising a scanner configured to translate the energy beam along a target surface, wherein the device is operatively coupled with the scanner disposed in an optical system enclosure. In some embodiments, the system further comprises an energy source configured to generate the energy beam, wherein the device is operatively coupled with the energy source. In some embodiments, the energy source comprises a laser source or an electron beam source. In some embodiments, the system further comprises at least one controller that (i) is operatively coupled with the device and (ii) direct one or more operations associated with the device. In some embodiments, the system is configured to operatively couple to at least one controller configured to (i) operatively couple to the system and (ii) direct one or more operations associated with the system.

The various embodiments in any of the above aspects are combinable (e.g., within an aspect), as appropriate.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### BRIEF DESCRIPTION OF THE DRAWINGS

The novel features of the present disclosure are set forth with particularity in the appended claims. A better understanding of the features and advantages of the present disclosure will be obtained by reference to the following detailed description that sets forth illustrative embodiments, in which the principles of the present disclosure are utilized, and the accompanying drawings or figures (also “Fig.” and “Figs.” herein), of which:

FIG. 1 shows various schematic views of 3D printer components, and a path;

FIG. 2 shows various schematic views of 3D printer components;

FIG. 3 shows various schematic views of 3D printer components;

FIG. 4 shows various schematic views of 3D printer components;

FIG. 5 shows various schematic views of 3D printer components;

FIGS. 6A-D show schematically illustrate operations in printing 3D object;

FIG. 7 shows various schematic views of 3D printer components;

FIG. 8 shows various schematic views of 3D printer components;

FIG. 9 shows various schematic views of 3D printer components;

FIG. 10 shows various schematic views of 3D printer components;

FIG. 11 shows various schematic views of 3D printer components;

FIG. 12 schematically illustrate operations in printing 3D object;

FIG. 13 shows graphs related to oxygen pickup using various powder dispensers;

FIG. 14 schematically illustrates various 3D printer components;

FIG. 15 schematically illustrates various 3D printer components;

FIG. 16 schematically illustrates various 3D printer components;

FIG. 17 shows various view of a weighing system and associated components;

FIG. 18 shows various view of a weighing system and associated components; and

FIG. 19 schematically illustrates a processing (e.g., computer) system.

The figures and components therein may not be drawn to scale. Various components of the figures described herein may not be drawn to scale.

### DETAILED DESCRIPTION

While various embodiments of the invention have been shown, and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein might be employed. The various embodiments disclosed herein are combinable, as appropriate.

Terms such as “a”, “an” and “the” are not intended to refer to only a singular entity but include the general class of which a specific example may be used for illustration. The terminology herein is used to describe specific embodiments in the present disclosure, but their usage does not delimit to the specific embodiments of the present disclosure. The term “includes” means includes but not limited to, the term “including” means including but not limited to, and the term “based on” means based at least in part on.

When ranges are mentioned, the ranges are meant to be inclusive, unless otherwise specified. For example, a range between value 1 and value 2 is meant to be inclusive and include value 1 and value 2. The inclusive range will span any value from about value 1 to about value 2. The term “adjacent” or “adjacent to,” as used herein, includes “next to,” “adjoining,” “in contact with,” and “in proximity to.” When ranges are mentioned (e.g., between, at least, at most, and the like) the endpoint(s) of the range is/are also claimed. For example, when the range is from X to Y, the values of X and Y are also claimed. For example, when the range is at most Z, the value of Z is also claimed. For example, when the range is at least W, the value of W is also claimed.

The conjunction “and/or” as used herein in “X and/or Y”—including in the specification and claims—is meant to include the options (i) X, (ii) Y, and (iii) X and Y, as applicable. The conjunction of “and/or” in the phrase “including X, Y, and/or Z” is meant to include any combination and any plurality thereof, as applicable. For example, it is meant to include the following: (1) a single X, (2) a single Y, (3) a single Z, (4) a single X and a single Y, (5) a single X and a single Z, (6) a single Y and a single Z, (7) a single X, a single Y, and a single Z, (8) a plurality of X, (9) a plurality of Y, (10) a plurality of Z, (11) a plurality of X and a single Y, (12) a plurality of X, a single Y and a single Z, (13) a plurality of X and a single Z, (14) a plurality of Y and a single X, (15) a plurality of Y, a single X, and a single Z, (16) a plurality of Y and a single Z, (17) a plurality of Z and a single X, (18) a plurality of Z, a single X, and a single Y (19) a plurality of Z and a single Y, (20) a plurality X and a plurality Y, (21) a plurality X and a plurality Z, (22) a plurality Y and a plurality Z, and (23) a plurality X, a plurality Y, and a plurality Z. The phrase “including X, Y, and/or Z” is meant to have the same meaning as the phrase “comprising X, Y, or Z.”

The term “operatively coupled” or “operatively connected” refers to a first mechanism that is coupled (or connected) to a second mechanism to allow the intended operation of the second and/or first mechanism. The coupling may comprise physical or non-physical coupling. The non-physical coupling may comprise signal induced coupling (e.g., wireless coupling).

The phrase “is/are structured” or “is/are configured,” when modifying an article, refers to a structure of the article that is able to bring about the referred result.

Fundamental length scale (abbreviated herein as “FLS”) comprises any suitable scale (e.g., dimension) of an object. For example, an FLS of an object may comprise a length, a width, a height, a diameter, a spherical equivalent diameter, a diameter of a bounding circle, a diameter of a bounding sphere, a radius, a spherical equivalent radius, or a radius of a bounding circle, or a radius of a bounding sphere.

A central tendency as understood herein comprises mean, median, or mode. The mean may comprise a geometric mean.

“Real time” as understood herein may be during at least part of the printing of a 3D object. Real time may be during a print operation. Real time may be during a print cycle. Real time may comprise: during formation of (i) a 3D object, (ii) a layer of hardened material as part of the 3D object, (iii) a hatch line, or (iv) a melt pool.

Performing a reversible first operation is understood herein to mean performing the first operation and being capable of performing the opposite of that first operation (e.g., which is a second operation). For example, when a controller directs reversibly opening a shutter, that shutter can also close, and the controller can optionally direct a closure of that shutter. For example, when a layer dispensing mechanism (e.g., recoater) reversibly translates in a first direction, that layer dispensing mechanism (e.g., recoater) can also translate in a second direction opposite to the first direction. For example, when a controller directs reversibly translating a recoater in a first direction, that recoater can translate in the first direction and can also translate in a second direction opposite to the first direction, e.g., when the controller directs the recoater to translate in the second direction.

Where suitable, one or more of the features shown in a figure comprising a 3D printer and/or components thereof can be combined with one or more of the various features of other 3D printers and/or components thereof described herein. A figure shown herein may not show certain features of a 3D printer and/or components thereof described herein. It should be understood that any such features can be incorporated within the 3D printer as requested and where suitable.

Any of the apparatuses and/or their components disclosed herein may be built by a material disclosed herein. The apparatuses and/or their components comprise a transparent or non-transparent (e.g., opaque) material. For example, the apparatuses and/or their components may comprise an organic or an inorganic material. For example, the apparatuses and/or their components may comprise an elemental metal, metal alloy, ceramic, or an allotrope of elemental carbon. For example, the enclosure, platform, recycling system, or any of their components may comprise an elemental metal, metal alloy, ceramic, or an allotrope of elemental carbon.

The present disclosure provides three-dimensional (3D) printing apparatuses, systems, software, and methods for forming a 3D object. For example, a 3D object may be formed by sequential addition of material or joining of starting material (e.g., source material, e.g., powder) to form a structure in a controlled manner (e.g., under manual or automated control).

Transformed material, as understood herein, is a material that underwent a physical change. The physical change can comprise a phase change. The physical change can comprise fusing (e.g., melting or sintering), connecting, or bonding (e.g., physical, or chemical bond). The physical change can be a phase transformation such as from a solid to a partially liquid, or to a liquid phase.

The 3D printing process may comprise printing one or more layers of hardened material in a building cycle, e.g., in a printing cycle. A building cycle (e.g., printing cycle), as understood herein, comprises printing the (e.g., hardened, or solid) material layers of a print job (e.g., all, or substantially all, the layers of a printing job), which may comprise printing one or more 3D objects above a platform (e.g., in a single powder bed). The one or more 3D object(s) may or may not be physically anchored to the platform (e.g., a build platform) above which it/they are printed.

Pre-transformed material (also referred to herein as “starting material”), as understood herein, is a material before it has been transformed (e.g., once transformed) by an energy beam during an upcoming 3D printing process, e.g., it is a starting material for an upcoming 3D printing process. The pre-transformed material may be a material that was, or was not, transformed prior to its use in the upcoming 3D printing process. The pre-transformed material may be a material that was partially transformed prior to its use in the upcoming 3D printing process. The pre-transformed material may be a starting material for the upcoming 3D printing process. The pre-transformed material may be liquid, solid, or semi-solid (e.g., gel). The pre-transformed material may be a particulate material. For example, the particulate material comprises a powder. The powder may comprise solid particles of material(s). The particulate material may comprise vesicles (e.g., containing liquid or semi-solid material). The particulate material may comprise solid or semi-solid material particles. The starting material may be pulverous. The starting material may have been introduced during a 3D printer process prior to the upcoming 3D printing process, and was left as a remainder material. For example, in a first 3D printing process (having a first build cycle), powder was used to form a 3D object. A remainder of the powder of the first 3D printing process may become a starting material for an upcoming second 3D printing process (having a second build cycle). Thus, even though the remainder powder of the first 3D printing process may comprise transformed material (e.g., bits of sintered powder, spatter, splatter, or other forms of debris), it is considered a starting material relative to the second 3D printing process. The remainder can be filtered and otherwise recycled for use as a pre-transformed material in the second 3D printing process. In some embodiments, a large percentage of the powder deposited in a layer dispensing operation is recycled, while a smaller percentage is utilized as planar layers of powder utilized for the 3D printing. The larger percentage can be at least about 99%, 98%, 97%, 95%, 90%, 80%, 70% or 60%, the percentage being volume per volume. The larger percentage (v/v) can be any of the above referenced larger percentages, e.g., from about 99% to about 60%, from about 99% to about 90%, from about 80% to about 60%, or from about 98% to about 60%. The smaller percentage can be at most about 1%, 2%, 2.5%, 3%, 5%, 10%, 15%, 20%, 30%, or 40%, the percentage being volume per volume. The smaller percentage (v/v) can be any of the above referenced smaller percentages, e.g., from about 40% to about 1%, from about 40% to about 5%, or from about 20% to about 1%.

In some embodiments, in a 3D printing process, the deposited powder may be fused (e.g., sintered or melted), bound, or otherwise connected to form at least a portion of the requested 3D object. Fusing, binding, or otherwise connecting the material is collectively referred to herein as “transforming” the material. Fusing the material may refer to melting, smelting, or sintering a powder.

In some embodiments, melting may comprise liquefying the material (i.e., transforming to a liquefied state). A liquefied state refers to a state in which at least a portion of a transformed material is in a liquid state. Melting may comprise liquidizing the material (i.e., transforming to a liquidus state). A liquidus state refers to a state in which an entire transformed material is in a liquid state. The apparatuses, methods, software, and/or systems provided herein are not limited to the generation of a single 3D object but may be utilized to generate one or more 3D objects simultaneously (e.g., in parallel) or separately (e.g., sequentially). The plurality of 3D objects may be formed in one or more powder beds (e.g., powder bed). In some embodiments, a plurality of 3D objects is formed in one powder bed.

At times, the printing of a (e.g., complex) 3D object involves using a combination of methodologies (e.g., having respective process parameters). In some cases, different methodologies may be used to transform different portions of the object. In some examples, 3D printing methodologies comprise extrusion, wire, granular, laminated, light polymerization, or powder bed and inkjet head 3D printing. Extrusion 3D printing can comprise robo-casting, fused deposition modeling (FDM) or fused filament fabrication (FFF). Wire 3D printing can comprise electron beam freeform fabrication (EBF3). Granular 3D printing can comprise direct metal laser sintering (DMLS), arc welding (e.g., powder based arc welding), electron beam melting (EBM), selective laser melting (SLM), selective heat sintering (SHS), or selective laser sintering (SLS). Powder bed and inkjet head 3D printing can comprise plaster-based 3D printing (PP). Laminated 3D printing can comprise laminated object manufacturing (LOM). Light polymerized 3D printing can comprise stereo-lithography (SLA), digital light processing (DLP), or laminated object manufacturing (LOM). 3D printing methodologies can comprise Direct Material Deposition (DMD). The Direct Material Deposition may comprise Laser Metal Deposition (LMD, also known as, Laser deposition welding). 3D printing methodologies can comprise powder feed, or wire deposition. Various apparatuses (e.g., controllers), systems (e.g., 3D printers), software, methods related to types of energy beam and formation of 3D objects, as well as various control schemes are described in U.S. patent application Ser. No. 15/435,128; International Patent Application number PCT/US17/18191; European Patent Application number EP17156707.6; and International Patent Application number PCT/US18/20406, each of which is entirely incorporated herein by reference.

In some examples, 3D printing methodologies differ from methods traditionally used in semiconductor device fabrication (e.g., vapor deposition, etching, annealing, masking, or molecular beam epitaxy). In some instances, 3D printing may further comprise one or more printing methodologies that are traditionally used in semiconductor device fabrication. 3D printing methodologies can differ from vapor deposition methods such as chemical vapor deposition, physical vapor deposition, or electrochemical deposition. In some instances, 3D printing may further include vapor deposition methods.

In an aspect provided herein is a system for generating a 3D object comprising: an enclosure for accommodating at least one planar layer of powder; at least one energy (e.g., energy beam) capable of transforming the powder to form a transformed material; and at least one controller (e.g., as part of a control system) that directs the energy beam(s) to impinge on the exposed surface of the layer of powder and translate along a path (e.g., as described herein). The transformed material may be capable of hardening to form at least a portion of a 3D object. The system may comprise at least one energy source generating the energy beam(s), at least one optical system, a layer dispensing mechanism such as a recoater, gas source(s), pump(s), nozzle(s), valve(s), sensor(s), display(s), chamber(s), processor(s) comprising or software inscribed on a computer readable media/medium. The control system may be configured to control attributes including temperature, pressure, gas flow, optics, actuator(s), energy source(s), energy beam(s), and/or atmosphere(s). The chamber may comprise a base (e.g., also referred to herein as “build platform,” or “build plate”) and a substrate. The substrate may comprise a piston. The system for generating at least one 3D object (e.g., in a printing cycle) and its components may be any 3D printing system. Examples of 3D printers, their components, and associated methods, software, systems, devices, and apparatuses, can be found in International Patent Application Serial No. PCT/US17/60035, filed Nov. 3, 2017; and in International Patent Application Serial No. PCT/US22/16550, filed Feb. 26, 2022; each of which is entirely incorporated herein by reference.

In some embodiments, the deposited powder within the enclosure is a liquid material, semi-solid material (e.g., gel), or a solid material (e.g., powder). The deposited powder within the enclosure can be in the form of a powder, wires, sheets, or droplets. The powder (e.g., pre-transformed, transformed, and/or hardened) may comprise elemental metal, metal alloy, ceramics, or an allotrope of elemental carbon. The allotrope of elemental carbon may comprise amorphous carbon, graphite, graphene, amorphous carbon, carbon fiber, carbon nanotube, diamond, or fullerene. The fullerene may be selected from the group consisting of a spherical, elliptical, linear, and tubular fullerene. The fullerene may comprise a buckyball, or a carbon nanotube. The ceramic material may comprise cement. The ceramic material may comprise alumina, zirconia, or carbide (e.g., silicon carbide, or tungsten carbide). The ceramic material may include high performance material (HPM). The ceramic material may include a nitride (e.g., boron nitride or aluminum nitride). The material may comprise sand, glass, or stone. In some embodiments, the material may comprise an organic material, for example, a polymer or a resin (e.g., 114 W resin). The organic material may comprise a hydrocarbon. The polymer may comprise styrene or nylon (e.g., nylon 11). The polymer may comprise a thermoplast. The organic material may comprise carbon and hydrogen atoms. The organic material may comprise carbon and oxygen atoms. The organic material may comprise carbon and nitrogen atoms. The organic material may comprise carbon and sulfur atoms. In some embodiments, the material may exclude an organic material. The material may comprise a solid or a liquid. In some embodiments, the material may comprise a silicon-based material, for example, silicon-based polymer or a resin. The material may comprise an organosilicon-based material. The material may comprise silicon and hydrogen atoms. The material may comprise silicon and carbon atoms. In some embodiments, the material may exclude a silicon-based material. The powder may be coated by a coating (e.g., organic coating such as the organic material (e.g., plastic coating)). The material may be devoid of organic material. The liquid material may be compartmentalized into reactors, vesicles, or droplets. The compartmentalized material may be compartmentalized in one or more layers. The material may be a composite material comprising a secondary material. The secondary material can be a reinforcing material (e.g., a material that forms a fiber). The reinforcing material may comprise a carbon fiber, Kevlar®, Twaron®, ultra-high-molecular-weight polyethylene, or glass fiber. The material can comprise powder (e.g., granular material) and/or wires. The bound material can comprise chemical bonding. Transforming can comprise chemical bonding. Chemical bonding can comprise covalent bonding.

The printed 3D object can be made of a single material (e.g., single material type) or a plurality of materials (e.g., a plurality of material types). Sometimes one portion of the 3D object and/or of the powder bed may comprise one material, and another portion may comprise a second material different from the first material. The material may be a single material type (e.g., a single alloy or a single elemental metal). The material may comprise one or more material types. For example, the material may comprise two alloys, an alloy and an elemental metal, an alloy and a ceramic, or an alloy and an elemental carbon. The material may comprise an alloy and alloying elements (e.g., for inoculation). The material may comprise blends of material types. The material may comprise blends with elemental metal or with metal alloy. The material may comprise blends excluding (e.g., without) elemental metal or including (e.g., with) metal alloy. The material may comprise a stainless steel. The material may comprise a titanium alloy, aluminum alloy, and/or nickel alloy.

In some cases, a layer within the 3D object comprises a single type of material. In some examples, a layer of the 3D object may comprise a single elemental metal type, or a single alloy type. In some examples, a layer within the 3D object may comprise several types of material (e.g., an elemental metal and an alloy, an alloy and a ceramic, an alloy and an elemental carbon). In certain embodiments, each type of material comprises only a single member of that type. For example: a single member of elemental metal (e.g., iron), a single member of metal alloy (e.g., stainless steel), a single member of ceramic material (e.g., silicon carbide or tungsten carbide), or a single member of elemental carbon (e.g., graphite). In some cases, a layer of the 3D object comprises more than one type of material. In some cases, a layer of the 3D object comprises more than one member of a type of material.

In some examples, the powder bed, and/or 3D printing system (or any component thereof such as a build platform) may comprise any material disclosed herein. The material may comprise a material type which constituents (e.g., atoms) readily lose their outer shell electrons, resulting in a free-flowing cloud of electrons within their otherwise solid arrangement. The powder bed may comprise a particulate material (e.g., powder). In some examples the material (e.g., powder, and/or 3D printer component) may comprise a material characterized in having high electrical conductivity (e.g., at least about 1*10⁵ Siemens per meter (S/m)), low electrical resistivity (e.g., at most about 1*10⁻⁵ ohm times meter (Ω*m)), high thermal conductivity (e.g., at least about 10 Watts per meter times Kelvin (W/mK)), or high density (e.g., at least about 1.5 grams per cubic centimeter (g/cm³)). The density can be measured at ambient temperature (e.g., at R.T., or 20° C.) and at ambient atmospheric pressure (e.g., at 1 atmosphere).

In some embodiments, the elemental metal is an alkali metal, an alkaline earth metal, a transition metal, a rare-earth element metal, a precious metal, or another elemental metal. The elemental metal may comprise Titanium, Copper, Platinum, Gold, Aluminum, or Silver.

In some embodiments, the metal alloy comprises iron-based alloy, nickel-based alloy, cobalt-based alloy, chrome-based alloy, cobalt chrome-based alloy, titanium-based alloy, magnesium-based alloy, or copper-based alloy. The alloy may comprise an oxidation or corrosion resistant alloy. The alloy may comprise a super alloy (e.g., Inconel, In718, Ti64, F357, Haynes282, GRCop-42, C22, CA6NM, Hastelloy-X). The alloy may comprise an alloy used for aerospace applications, automotive application, surgical application, or implant applications. The metal may include a metal used for aerospace applications, automotive application, surgical application, or implant applications.

In some embodiments, the metal alloys are refractory alloys. The refractory metals and alloys may be used for heat coils, heat exchangers, furnace components, or welding electrodes. The refractory alloys may comprise a high melting points, low coefficient of expansion, high mechanical strength, low vapor pressure at elevated temperatures, high thermal conductivity, or high electrical conductivity.

In some embodiments, the material (e.g., alloy or elemental) comprises a material used for applications in industries comprising aerospace (e.g., aerospace super alloys), jet engine, missile, automotive, marine, locomotive, satellite, defense, oil & gas, energy generation, semiconductor, fashion, construction, agriculture, printing, or medical. The material may comprise an alloy used for products comprising, devices, medical devices (human & veterinary), machinery, cell phones, semiconductor equipment, generators, engines, pistons, electronics (e.g., circuits), electronic equipment, agriculture equipment, motor, gear, transmission, communication equipment, computing equipment (e.g., laptop, cell phone, tablet), air conditioning, generators, furniture, musical equipment, art, jewelry, cooking equipment, or sport gear. The material may comprise an alloy used for products for human or veterinary applications comprising implants, or prosthetics. The metal alloy may comprise an alloy used for applications in the fields comprising human or veterinary surgery, implants (e.g., dental), or prosthetics.

In some embodiments, the alloy includes a high-performance alloy. The alloy may include an alloy exhibiting at least one of excellent mechanical strength, resistance to thermal creep deformation, good surface stability, resistance to corrosion, and resistance to oxidation. The alloy may include a face-centered cubic austenitic crystal structure. The alloy can be a single crystal alloy. Examples of materials, 3D printers, and associated methods, software, systems, devices, materials (e.g., alloys), and apparatuses, can be found in International Patent Application Serial No. PCT/US17/60035, filed Nov. 3, 2017; and in International Patent Application Serial No. PCT/US22/16550, filed Feb. 26, 2022; each of which is entirely incorporated herein by reference.

In some embodiments, the material comprises powder (also referred to herein as a “pulverous material”). The powder may comprise a solid comprising fine particles. The powder may be a granular material. The powder can be composed of individual particles. At least some of the particles can be spherical, oval, prismatic, cubic, or irregularly shaped. At least some of the particles can have a fundamental length scale (e.g., diameter, spherical equivalent diameter, length, width, depth, or diameter of a bounding sphere). The central tendency of the fundamental length scale (abbreviated herein as “FLS”) of the particles can be from about 5 micrometers (μm) to about 100 μm, from about 10 μm to about 70 μm, or from about 50 μm to about 100 μm. The particles can have central tendency of the FLS of at most about 75 μm, 65 μm, 50 μm, 30 μm, 25 μm or less. The particles can have a central tendency of the FLS of at least 10 μm, 25 μm, 30 μm, 50 μm, 70 μm, or more. A central tendency of the distribution of an FLS of the particles (e.g., range of an FLS of the particles between largest particles and smallest particles) can be about at least about 5 μm, 10 μm, 20 μm, 30 μm, 40 μm, 53 μm, 60 μm, or 75 μm. The particles can have a central tendency of the FLS of at most about 65 μm. In some cases, the powder particles may have central tendency of the FLS between any of the afore-mentioned FLSs.

In some embodiments, the powder comprises a particle mixture, which particle comprises a shape. The powder can be composed of a homogenously shaped particle mixture such that all the particles have substantially the same shape and FLS magnitude within at most about 1%, 5%, 8%, 10%, 15%, 20%, 25%, 30%, 35%, or 40% distribution of FLS.

At times, a plurality of build modules may be situated in an enclosure comprising the processing chamber. At times, the build module may be connected to, or may comprise an autonomous guided vehicle (AGV). The AGV may have at least one of the following: a movement mechanism (e.g., wheels), positional (e.g., optical) sensor, and controller. The controller may enable self-docking (e.g., to a docking station) and/or self-driving of the AGV. The self-docking and/or self-driving may be to and from the processing chamber. The build module may reversibly engage with (e.g., couple to) the processing chamber. The engagement of the build module with the processing chamber may be controlled (e.g., by a controller). The control may be automatic and/or manual. The engagement of the build module with the processing chamber may be reversible. In some embodiments, the engagement of the build module with the processing chamber may be permanent.

In some embodiments, the powder (e.g., starting material for the 3D printing) is deposited in an enclosure, e.g., a build module. The build module container can contain the powder (e.g., without spillage). Material may be placed in or inserted to the container. The material may be deposited in, pushed to, sucked into, or lifted to the container. The material may be layered (e.g., spread) in the enclosure such as by using a layer dispensing mechanism. The build module container may be configured to enclosure a substrate (e.g., an elevator piston). The substrate may be situated adjacent to the bottom of the build module container. Bottom may be relative to the gravitational field along gravitational vector pointing towards gravitational center, or relative to the position of the footprint of the energy beam on the layer of powder as part of a powder bed. The build module container may comprise a platform comprising a substrate or a base (e.g., a build plate). The platform may be situated within the build module container. The base may be situated within the build module container. The base may reside adjacent to the substrate. For example, the base may (e.g., reversibly) connect to the substrate. The powder may be layer-wise deposited adjacent to a side of the build module container, e.g., above and/or on the bottom of the build module container. The powder may be layered adjacent to the substrate and/or adjacent to the base. Adjacent to may be above. Adjacent to may be directly above, or directly on. The substrate may have one or more seals that enclose the material in a selected area within the build module container. The one or more seals may be flexible or non-flexible. The seal may be a hermetic seal such as a gas tight seal. The one or more seals may comprise a polymer or a resin. The enclosure, processing chamber, and/or building module container may comprise (I) a window (e.g., an optical window and/or a viewing window) or (II) an optical system. The optical window may allow the energy beam to pass through without (e.g., substantial) energetic loss. The viewing window may be any window disclosed herein. The viewing window may be a single or a double pane window. The viewing window may be an insulated glass unit (IGU). The viewing window may be configured to withstand positive pressure within the processing chamber, e.g., during printing. The positive pressure is above ambient pressure external to the build module, e.g., the ambient pressure may be about one atmosphere. During the 3D printing, a ventilator and/or gas flow may prevent debris (e.g., spatter) from accumulating on the surface of the optical window that is disposed within the enclosure (e.g., within the processing chamber). A portion of the enclosure that is occupied by the energy beam (e.g., during the 3D printing) can define a processing cone (e.g., a truncated processing cone). During the 3D printing may comprise during the entire 3D printing. The processing cone can be the space that is occupied by a non-reflected energy beam during the (e.g., entire) 3D printing. The processing cone can be the space that is occupied by an energy beam that is directed towards the powder bed during the (e.g., entire) 3D printing. During the 3D printing may comprise during printing of a layer of hardened material.

In some embodiments, the 3D printer comprises a gas flow mechanism. The gas flow mechanism may be in fluidic contact with one or more enclosures of the 3D printer. For example, the gas flow mechanism may be in fluidic contact with (i) a processing chamber, (ii) a build module, (iii) an optical system enclosure, or (iv) any combination thereof. The gas flow mechanism may be in fluidic contact with a processing chamber and/or a build module. The gas flow mechanism may be in fluid communication with the optical system enclosure. At times, a gas flow assembly may be in fluid communication with the optical system enclosure. The gas flow assembly may be configured to flow gas into and out of the optical system enclosure. The gas flow assembly may be separate from the gas flow mechanism. For example, the gas flow mechanism and the gas flow assembly may be isolated (e.g., fluidically separate) from each other. The gas flow mechanism may be configured to flow gas into and out of the processing chamber. The gas flow mechanism may or may not be included in the gas conveyance system, e.g., as disclosed herein. In an example, the gas flow mechanism and the gas conveyance system can be separate from each other. In an example, the gas flow mechanism can be included in the gas conveyance system.

In some embodiments, the 3D printer comprises a layer dispensing mechanism. The powder may be deposited in the enclosure by a layer dispensing mechanism (also referred to herein as a “layer dispenser,” “layer forming apparatus,” or “layer dispensing mechanism”). The layer dispensing mechanism may comprise a recoater. In some embodiments, the layer dispensing mechanism includes one or more material dispensers (also referred to herein as “dispensers” or “material dispensing mechanism”), and/or at least one powder removal mechanism (also referred to herein as material “remover” or “material remover”) to form a layer of powder (e.g., starting material) as at least a portion of powder bed, e.g., within the enclosure. The deposited starting material may be shaped (e.g., leveled) by a shaping operation (e.g., leveling operation). Shaping the powder bed may comprise altering a shape of the exposed surface of the powder bed. In some embodiments, the layer dispensing mechanism includes a leveler to planarize (e.g., smooth, such as substantially planarize) an exposed surface of a powder bed within the enclosure. In some embodiments, the layer dispensing mechanism is devoid of a leveler to planarize (e.g., smooth, such as substantially planarize) an exposed surface of a powder bed within the enclosure. The leveling operation may comprise using a material removal mechanism that does not contact the exposed surface of the powder bed. The material removed can comprise a powder or debris. The layer dispensing mechanism and energy beam(s) can translate and form the 3D object adjacent to (e.g., above) the platform and/or within the powder bed (e.g., as described herein), while the platform gradually (e.g., sequentially and/or stepwise) lowers its vertical position to facilitate layer-wise formation of the 3D object. The material dispensing mechanism (e.g., the dispenser) can comprise a reservoir configured to retain a volume of powder. The volume of powder may be equivalent to about the volume of powder sufficient for at least one or more dispensed layers above the platform. For example, the volume of powder may be equivalent to about the volume of starting material sufficient for at least an integer number of dispensed layers above the platform. For example, the volume of powder retained within the reservoir can be at least about 2 cubic centimeters (cc), 15 cc, 20 cc, 50 cc, 100 cc, 250 cc, 1500 cc, 2000 cc, or 2500 cc. The material dispensing mechanism can comprise a reservoir configured to retain a volume of powder can be between any of the afore-mentioned amounts, for example, from about 2 cc to about 2500 cc. The material dispensing mechanism can dispense material at a dispensing rate (e.g., flow rate from the material dispensing mechanism) of at least 0.2 cubic centimeters per second (cm³/sec) or (cc/sec), 0.5 cc/sec, 2 cc/sec, 2.5 cc/sec, 3.5 cc/sec, 5 cc/sec, 10 cc/sec, 30 cc/sec, 50 cc/sec, 75 cc/sec, 90 cc/sec, 100 cc/sec, 110 cc/sec, 125 cc/sec, or 150 cc/sec. The dispensing rate can be between any of the afore-mentioned dispensing rates (e.g., from about 2 cc/sec to about 150 cc/sec). The layer dispensing mechanism may include components comprising a material dispensing mechanism, material leveling mechanism, material removal mechanism, or any combination or permutation thereof. Examples of 3D printing systems, apparatuses, devices, components (e.g., material dispensing mechanisms and material removal mechanisms), controllers, software, and 3D printing processes can be found in Patent Application serial number PCT/US15/36802 filed on Jun. 19, 2015; in U.S. patent application Ser. No. 17/881,797, filed Aug. 5, 2022; or in International Patent Application serial number PCT/US16/66000 filed on Dec. 9, 2016; each of which is incorporated herein in its entirety.

In some embodiments, a layer dispensing mechanism is utilized for the 3D printing. The layer dispensing mechanism can be in a layer forming mode when dispensing the material and/or shaping the powder bed. The layer dispensing mechanism can be in a parked mode when the layer dispensing mechanism is in an idle position such as a parked position. In some embodiments, the layer dispensing mechanism may reside within an ancillary chamber. The layer dispenser may be physically secluded from the processing chamber when residing in the ancillary chamber. The ancillary chamber may be connected (e.g., reversibly) to the processing chamber. The ancillary chamber may be connected (e.g., reversibly) to the build module. The ancillary chamber may convey the layer dispensing mechanism adjacent to a platform (e.g., that is disposed within the build module). The layer dispensing mechanism may be retracted into the ancillary chamber (e.g., when the layer dispensing mechanism does not perform dispensing). Examples of 3D printing systems, apparatuses, devices, components (e.g., material dispensing mechanisms and material removal mechanisms), controllers, software, and 3D printing processes can be found in Patent Application serial number PCT/US15/36802 filed on Jun. 19, 2015; in Provisional Patent Application Ser. No. 62/317,070 filed Apr. 1, 2016; in International Patent Application serial number PCT/US16/66000 filed on Dec. 9, 2016; in International Patent Application Ser. No. 62/265,817, filed Dec. 10, 2015; or in Provisional Patent Application Ser. No. 63/357,901, filed on Jul. 1, 2022; each of which is incorporated herein in its entirety.

In some embodiments, the 3D object(s) are printed from a powder bed. At least one FLS (e.g., width, depth, and/or height) of the powder bed can be at least about 50 millimeters (mm), 60 mm, 70 mm, 80 mm, 90 mm, 100 mm, 200 mm, 250 mm, 280 mm, 400 mm, 500 mm, 600 mm, 800 mm, 900 mm, 1 meter (m), 2 m, or 5 m. The at least one FLS (e.g., width, depth, and/or height) of the powder bed can be at most about 50 millimeters (mm), 60 mm, 70 mm, 80 mm, 90 mm, 100 mm, 200 mm, 250 mm, 280 mm, 400 mm, 500 mm, 600 mm, 800 mm, 900 mm, 1 meter (m), 2 m, or 5 m. The at least one FLS of the powder bed can be between any of the afore-mentioned values (e.g., from about 50 mm to about 5 m, from about 250 mm to about 500 mm, from about 280 mm to about 1 m, or from about 500 mm to about 5 m). In some embodiments, a FLS of the powder bed is in the direction of the gas flow. The build module may be configured to accommodate the powder bed, e.g., having the at least one FLS disclosed herein.

In some embodiments, the 3D printer has a capacity to complete at least 1, 2, 3, 4, or 5 printing cycles before requiring human intervention. Human intervention may be required for refilling the powder, unloading the build modules, unpacking the 3D object, removing the debris byproduct of the 3D printing, or any combination thereof. The 3D printer operator may condition the 3D printer at any time during operation of the 3D printing system (e.g., during the 3D printing process). Conditioning of the 3D printer may comprise refilling the powder that is used by the 3D printer, replacing gas source, or replacing filters. The conditioning may be with or without interrupting the 3D printing system. For example, refilling and unloading from the 3D printer can be done at any time during the 3D printing process without interrupting the 3D printing process. Conditioning may comprise refreshing the 3D printer.

In some examples, the 3D printing system requires operation of maximum an operator during a single standard daily work shift. The 3D printing system may require operation by a human operator working at most of about 8 hours (h), 7 h, 6 h, 5 h, 4 h, 3 h, 2 h, 1 h, or 0.5 h a day. The 3D printing system may require operation by a human operator working between any of the afore-mentioned time frames (e.g., from about 8 h to about 0.5 h, from about 8 h to about 4 h, from about 6 h to about 3 h, from about 3 h to about 0.5 h, or from about 2 h to about 0.5 h a day).

In some embodiments, the enclosure and/or processing chamber of the 3D printing system may be opened to the ambient environment sparingly. In some embodiments, the enclosure and/or processing chamber of the 3D printing system may be opened by an operator (e.g., human) sparingly. Sparing opening may be at most once in at most every 1, 2, 3, 4, or 5 weeks. The weeks may comprise weeks of standard operation of the 3D printer. In some embodiments, the 3D printer has a capacity of 1, 2, 3, 4, or 5 full prints in terms of powder reservoir capacity. The 3D printer may have the capacity to print a plurality of 3D objects in parallel, e.g., in one powder bed. For example, the 3D printer may be able to print at least 2, 3, 4, 5, 6, 7, 8, 9, or 10 3D objects in parallel.

In some embodiments, the printed 3D object is retrieved soon after terminating the last transformation operation of at least a portion of the powder bed. Soon after terminating may be at most about 1 day, 12 hours, 6 hours, 3 hours, 2 hours, 1 hour, 30 minutes, 15 minutes, 5 minutes, 240 seconds (sec), 220 sec, 200 sec, 180 sec, 160 sec, 140 sec, 120 sec, 100 sec, 80 sec, 60 sec, 40 sec, 20 sec, 10 sec, 9 sec, 8 sec, 7 sec, 6 sec, 5 sec, 4 sec, 3 sec, 2 sec, or 1 sec. Soon after terminating may be between any of the afore-mentioned time values (e.g., from about 1 s to about 1 day, from about 1 s to about 1 hour, from about 30 minutes to about 1 day, or from about 20 s to about 240 s).

Ambient refers to a condition to which people are generally accustomed. For example, ambient pressure may be about 1 atmosphere. Ambient temperature may be a typical temperature to which humans are generally accustomed. For example, from about 15° C. to about 30° C., from about −30° C. to about 60° C., from about −20° C. to about 50° C., from 16° C. to about 26° C., from about 20° C. to about 25° C. “Room temperature” may be measured in a confined or in a non-confined space. For example, “room temperature” can be measured in a room, an office, a factory, a vehicle, a container, or outdoors. The vehicle may be a car, a truck, a bus, an airplane, a space shuttle, a spaceship, a ship, a boat, or any other vehicle. Room temperature may represent the small range of temperatures at which the atmosphere feels neither hot nor cold, approximately 24° C. “Room temperature” may denote 20° C., 25° C., or any value from about 20° C. to about 25° C.

In some embodiments, a time lapse between the end of printing in a first powder bed, and the beginning of printing in a second powder bed is at most about 60 minutes (min), 40 min, 30 min, 20 min, 15 min, 10 min, or 5 min. The time lapse between the end of printing in a first powder bed, and the beginning of printing in a second powder bed may be between any of the afore-mentioned times (e.g., from about 60 min to about 5 min, from about 60 min to about 30 min, from about 30 min to about 5 min, from about 20 min to about 5 min, from about 20 min to about 10 min, or from about 15 min to about 5 min). The speed during which the 3D printing process proceeds is disclosed in Patent Application serial number PCT/US15/36802 that is incorporated herein in its entirety.

In some embodiments, at least one (e.g., each) energy source of the 3D printing system is able to transform (e.g., print) at a throughput of at least about 6 cubic centimeters of material per hour (cc/hr), 12 cc/hr, 35 cc/hr, 50 cc/hr, 120 cc/hr, 480 cc/hr, 600 cc/hr, 1000 cc/hr, or 2000 cc/hr. The at least one energy source may print at any rate within a range of the aforementioned values (e.g., from about 6 cc/hr to about 2000 cc/hr, from about 6 cc/hr to about 120 cc/hr, or from about 120 cc/hr to about 2000 cc/hr). At times, the 3D printing increases in efficiency when a plurality of energy beams (e.g., at least two energy beams) is used for the 3D printing. In some embodiments, the plurality of energy beams incident on a target surface may increase (i) the (e.g., total) processing field available for printing (e.g., in a X-Y plane) and/or (ii) the rate of 3D printing completion for a given print cycle (as compared to using a single energy beam). For example, the plurality of energy beams may be useful in providing a relatively larger processing area (e.g., build platform and/or powder bed) in which one or more 3D objects (e.g., larger 3D object) may be generated. The processing field may be larger in relation to a 3D printing system that comprises (e.g., only) a single energy beam, which processing area is limited to the areal extent (e.g., the processing field) of the single energy beam (e.g., as guided by an optical system), which is not arbitrarily sized. For example, the time for 3D printing may be shortened when at least two of the plurality of energy beams operate simultaneously at least in part (e.g., in parallel). For example, the time for 3D printing may be shortened by at least about 25%, 50%, 75% or 95% when at least two of the plurality of energy beams operate simultaneously at least in part. The time for 3D printing may be shortened by any value of the afore-mentioned values (e.g., by from about 25% to about 95%, about 25% to about 50%, or about 50% to about 95%) when at least two of the plurality of energy beams operate simultaneously at least in part. A shortened time may be relative to a 3D printing system that does not use a plurality of energy beams (e.g., uses only a single energy beam). Examples of 3D printing systems, apparatuses, devices, components, controllers, software, and 3D printing processes (e.g., speed of printing, throughput of printing processes) can be found in International Patent Application Serial No. PCT/US15/36802, and in International Patent Application Serial No. PCT/US19/226364, filed on May 16, 2019, each of which is incorporated herein by reference in its entirety.

In some embodiments, the at least one 3D object is removed from the powder bed after the completion of the 3D printing process. For example, the 3D object(s) may be removed from the powder bed when the transformed material that formed the 3D object hardens. For example, the 3D object may be removed from the powder bed when the transformed material that formed the 3D object is no longer susceptible to deformation under standard handling operation (e.g., human and/or machine handling).

In some examples, the generated 3D object adheres (e.g., substantially) to a requested model of the 3D object. Substantially may be with relation to the intended purpose of the 3D object. The 3D object (e.g., solidified material) that is generated can be formed with high fidelity, e.g., having a high fidelity (e.g., high accuracy) of one or more characteristics (e.g., dimensions) of the generated 3D object when compared to a model or simulation of the intended 3D object. For example, have an average deviation percentage from intended dimensions that are at most about 5%, 2%, 1%, 0.5%, 0.25%, 0.1%, 0.05%, or less. For example, the 3D object that is generated can have an average deviation value from the intended dimensions (e.g., of a requested 3D object) of at most about 0.5 microns (μm), 1 μm, 3 μm, 10 μm, 30 μm, 100 μm, 300 μm or less from a requested model of the 3D object. The deviation can be any value between the afore-mentioned values. The average deviation can be from about 0.5 μm to about 300 μm, from about 10 μm to about 50 μm, from about 15 μm to about 85 μm, from about 5 μm to about 45 μm, or from about 15 μm to about 35 μm. The 3D object can have a deviation from the intended dimensions in a specific direction, according to the formula Dᵥ+L/K_{dv}, wherein Dᵥ is a deviation value, L is the length of the 3D object in a specific direction, and K_{dv} is a constant. Dᵥ can have a value of at most about 300 μm, 200 μm, 100 μm, 50 μm, 40 μm, 30 μm, 20 μm, 10 μm, 5 μm, 1 μm, or 0.5 μm. Dᵥ can have a value of at least about 0.5 μm, 1 μm, 3 μm, 5 μm, 10 μm, 20 μm, 30 μm, 50 μm, 70 μm, 100 μm, 300 μm or less. Dᵥ can have any value between the afore-mentioned values. For example, Dᵥ can have a value that is from about 0.5 μm to about 300 μm, from about 10 μm to about 50 μm, from about 15 μm to about 85 μm, from about 5 μm to about 45 μm, or from about 15 μm to about 35 μm. K_{dv} can have a value of at most about 3000, 2500, 2000, 1500, 1000, or 500. K_{dv} can have a value of at least about 500, 1000, 1500, 2000, 2500, or 3000. K_{dv} can have any value between the afore-mentioned values. For example, K_{dv} can have a value that is from about 3000 to about 500, from about 1000 to about 2500, from about 500 to about 2000, from about 1000 to about 3000, or from about 1000 to about 2500.

At times, the generated 3D object (i.e., the printed 3D object) does not require further processing following its generation (e.g., retrieval) by a method described herein. The printed 3D object may require reduced amount of processing after its generation by a method described herein. For example, the printed 3D object may not require removal of auxiliary support (e.g., since the printed 3D object was generated as a 3D object devoid of auxiliary support) and/or removal of transformed material. The printed 3D object may not require smoothing, flattening, polishing (e.g., sanding), leveling, trimming, annealing, or curing. The printed 3D object may not require further machining. In some examples, the printed 3D object may require one or more treatment operations following its generation (e.g., post generation treatment, or post printing treatment). The further treatment step(s) may comprise surface scraping, machining, polishing, grinding, blasting (e.g., sand blasting, bead blasting, shot blasting, or dry ice blasting), annealing, or chemical treatment. Examples of 3D printing systems, apparatuses, devices, components, controllers, software, and 3D printing processes (e.g., post-processing, post-generation treatment, and post-printing treatment) can be found in U.S. patent application Ser. No. 17/835,023, filed on Jun. 8, 2022, and U.S. Provisional Patent Application Ser. No. 63/289,787, filed Dec. 15, 2021, each of which are entirely incorporated herein by reference.

In some embodiments, the 3D printer comprises a chamber having an interior space. The chamber may be referred to herein as a “processing chamber.” The processing chamber may facilitate ingress of at least one energy beam into the processing chamber. The energy beam(s) may be directed towards a target surface, e.g., an exposed surface of a powder bed. The 3D printer may comprise one or more modules, e.g., build modules. At times, at least one build module may be situated in the enclosure and coupled with the processing chamber. At times, at least one build module may reversibly engage with (e.g., couple to) the processing chamber to expand an interior volume of the processing chamber, e.g., to form at least a portion of the chamber.

In some embodiments, the 3D printing system comprises a build module. The build module may be mobile or stationary. The build module may comprise an elevation mechanism, e.g., comprising a build platform assembly. The build module may comprise the build platform (e.g., base) that may be coupled with the build platform assembly. The build platform may be disposed within the build module. The build platform may reside adjacent to the substrate, e.g., above the substrate relative to a gravitational center of the environment (e.g., Earth). The elevation mechanism may be reversibly connected to (and disconnected from) at least a portion of the build platform. The elevation mechanism may comprise a portion that vertically translates the build platform with respect to a gravitational center (e.g., a gravitational center of the Earth). The build platform may be disposed on the substrate. The build platform and the substrate may operatively couple (e.g., physically connect). The powder bed may be disposed above build platform. The build platform may support the powder bed. The build platform may comprise, or be configured to operatively couple to, an engagement mechanism. The substrate may comprise, or be configured to operatively couple to, an engagement mechanism. The engagement mechanism may facilitate engagement and/or dis-engagement between a base (e.g., of the build platform) and the substrate. The build platform may be configured to support one or more layers of powder (e.g., as part of the powder bed). The build platform may be configured to support at least a portion of the 3D object (e.g., during forming of the 3D object). The substrate and/or the base (e.g., build platform) may be removable or non-removable (e.g., from the 3D printing system and/or relative to each other). The substrate and/or base may be fastened (I) to the build module and/or (II) to each other. The build platform and/or substrate may be translatable, e.g., before, during, and/or after printing one or more 3D objects in a print cycle. The translation of the build platform may be effectuated (e.g., controlled and/or regulated) by the build platform assembly and/or an actuator (e.g., by at least one controller and/or by a control system). The build platform assembly may be configured to provide a high precision platform for building one or more 3D objects in a printing cycle with high fidelity. The translation of the substrate may be controlled and/or regulated by at least one controller (e.g., by a control system). The build platform and/or substrate may be translatable horizontally, vertically, or at an angle (e.g., planar or compound angle). The translation may be in both directions (e.g., back and forth such as up and down relative to a gravitational vector). The control system may be any control system disclosed herein, e.g., a control system of the 3D printer such as the one controlling an energy beam. The substrate may comprise a piston. At times, the 3D printing system may comprise more than one substrate. At times, the 3D printing system may comprise more than one piston. The disclosure herein relating to the substrate may apply to the substrates.

In some embodiments, the build module, processing chamber, and/or enclosure comprises one or more seals. The seal may be a sliding seal or a stationary (e.g., top) seal. For example, the build module and/or processing chamber may comprise a sliding seal that meets with the exterior of the build module upon engagement of the build module with the processing chamber. During at least a portion of the 3D printing process, the atmospheres of the build module and processing chamber may be separate. For example, the processing chamber may comprise a top seal that faces the build module and is pushed upon engagement of the processing chamber with the build module. For example, the build module may comprise a top seal that faces the processing chamber and is pushed upon engagement of the processing chamber with the build module. The seal may be a face seal, or compression seal. The seal may comprise an O-ring. For example, the build module and the processing chamber may be separated by a load lock. The seal may be impermeable or substantially impermeable to at least one gas. The seal may be permeable to at least one gas. The seal may be impermeable to a solid material (e.g., the pre-transformed material and/or the transformed material). The seal may be flexible. The seal may be clastic. The seal may be bendable. The seal may be compressible. The seal may include a material comprising rubber (e.g., latex), Teflon, plastic, or silicon. The seal may comprise a mesh, membrane, sieve, paper (e.g., filter paper), cloth such as felt (e.g., Aramid felt, or another high temperature felt or fiber), or a brush. The mesh, membrane, paper and/or cloth may comprise randomly or non-randomly arranged fibers. The paper may comprise a HEPA filter.

In some embodiments, the substrate is separated from the base (e.g., build platform) assembly by a seal. The base and/or the substrate may be separated from the internal surface (e.g., side walls) of the build module by one or more seals. The seal may be attached to the moving build platform and/or substrate (e.g., while the walls of the build module are devoid of a seal). The seal may be attached to the (e.g., vertical) walls of the build module (e.g., while the build platform and/or substrate is devoid of a seal). In some embodiments, both the build platform and/or substrate and the walls of the build module comprise a seal. The seal may be placed laterally (e.g., horizontally) between one or more walls (e.g., side walls) of the build module. The seal may be connected to a bottom plane of the build platform and/or substrate. The seal may be connected to a side (e.g., circumference) of the build platform and/or substrate.

The seal may be permeable to at least one gas. The seal may be impermeable or substantially impermeable to at least one gas. The seal may be impermeable to a solid material (e.g., the pre-transformed material and/or the transformed material). The seal may be impermeable to particulate material (e.g., powder). The seal may not allow permeation of particulate material into the build platform assembly and/or piston assembly. The build platform assembly may comprise a piston and a build platform. The piston assembly may comprise a piston. The seal may be flexible. The seal may be elastic. The seal may be bendable. The seal may be compressible. The seal may include a material comprising a polymeric material (e.g., nylon, polyurethane), Teflon, plastic, rubber (e.g., latex), or silicon. The seal may comprise a mesh, membrane, sieve, paper (e.g., filter paper), cloth (e.g., felt, or wool), or brush. The mesh, membrane, paper and/or cloth may comprise randomly and/or non-randomly arranged fibers. The paper may comprise a HEPA filter.

In some embodiments, the 3D printing system comprises a build module, e.g., as disclosed herein. The build module may accommodate a powder bed having at least one (e.g., two or more) FLS (e.g., diameter, width, and/or height) of at most about 200 mm, 250 mm, 300 mm, 350 mm, 400 mm, 450 mm, 500 mm, 550 mm, 600 mm, 650 mm, 700 mm, 800 mm, 900 mm, 1000 mm, 1200 mm, 1500 mm, 2000 mm, 2500 mm, 3000 mm, 3500 mm, 4000 mm, or 4500 mm. The FLS of the powder bed accommodated by the build module may have a FLS value between any of the aforementioned values (e.g., from about 100 mm to about 4500 mm, from about 100 mm to about 2000 mm, from about 100 mm to about 700 mm, or from about 300 mm to about 4000 mm). In addition to the powder bed, the build module may be configured to accommodate a base (e.g., build platform) and at least one substrate (e.g., piston). The build module may accommodate a build platform having an FLS (e.g., diameter or width) of at least about 100 millimeters (mm), 200 mm, 300 mm, 400 mm, 500 mm, 600 mm, 700 mm, 800 mm, 900 mm, 1000 mm, 1500 mm, or 2000 mm, 2500 mm, 3000 mm, 3500 mm, or 4000 mm. The build module may accommodate a build platform having at least one FLS (e.g., diameter, height and/or width), the FLS being of at most about 200 mm, 250 mm, 300 mm, 350 mm, 400 mm, 450 mm, 500 mm, 550 mm, 600 mm, 650 mm, 700 mm, 800 mm, 900 mm, 1000 mm, 1200 mm, 1500 mm, 2000 mm, 4000 mm, or 4500 mm. The FLS of the build platform accommodated by the build module may have a FLS value between any of the aforementioned values (e.g., from about 100 mm to about 4500 mm, from about 100 mm to about 1200 mm, from about 100 mm to about 1500 mm, or from about 300 mm to about 2000 mm). The build platform assembly may be able to translate in a continuous and/or discrete manner. The build platform assembly may be able to translate in discrete increments of at most about 5 micrometers (μm), 20 μm, 30 μm, 40 μm, 50 μm, 60 μm, 70 μm, or 80 μm. The build platform assembly may be able to translate in discrete increments having a value between any of the aforementioned values (e.g., from about 5 μm to about 80 μm, from about 10 μm to about 60 μm, or from about 40 μm to about 80 μm). The build platform assembly may have a precision (e.g., error+/−) of at most about 0.25 μm, 0.5 μm, 1 μm, 1.5 μm, 2 μm, 2.5 μm, 3 μm, 4 μm, or 5 μm. The build platform assembly may have a precision value between any of the aforementioned precision value (e.g., from about 0.25 μm to about 5 μm, from about 0.25 μm to about 2.5 μm, or from about 1.5 μm to about 5 μm). The build platform assembly may have a precision (e.g., error+/−) of at most about 0.5%, 1%, 2%, 3%, 4%, 5%, 6%, 8% or 10% of its incremental movement. The build platform assembly may have a precision value between any of the aforementioned precision value relative to its incremental movement (e.g., from about 0.5% to about 10%, from about 0.5% to about 5%, or from about 1% to about 10%). The weight of the powder bed (e.g., including any printed 3D object therein) may be at least about 300 Kilograms (Kg), 500 Kg, 800 Kg, 1000 Kg, 1200 Kg, 1500 Kg, 1800 Kg, 2000 Kg, 2500 Kg, or 3000 Kg. The weight of the powder bed (e.g., including any printed 3D object therein) may be between any of the aforementioned values (e.g., from about 300 Kg to about 3000 Kg, from about 300 Kg to about 1500 Kg, or from about 1000 Kg to about 3000 Kg). The build platform assembly may be configured to translate the build module at a speed of at most 3 millimeters per second (mm/sec), 5 mm/sec, 10 mm/sec, 20 mm/sec, 30 mm/sec, or 50 mm/sec. The build platform assembly may be configured to translate the build module at a speed of at least 1 mm/sec, 3 mm/sec, 5 mm/sec, 10 mm/sec, 20 mm/sec, 30 mm/sec, or 40 mm/sec. The build platform assembly may be configured to translate the build module at a speed between any of the aforementioned speeds (e.g., from about 1 mm/sec to about 50 mm/sec, from about 1 mm/sec to about 20 mm/sec, or from about 5 mm/sec to about 50 mm/sec). The build platform assembly may be configured to translate the build module at a speed of at most 1 millimeter per second squared (mm/sec²), 2.5 mm/sec², 5 mm/sec², 7.5 mm/sec², 10 mm/sec², or 20 mm/sec². The build platform assembly may be configured to translate the build module at an acceleration of at least 0.5 mm/sec², 1 mm/sec², 2 mm/sec², 3 mm/sec², 5 mm/sec², 10 mm/sec², or 15 mm/sec². The build platform assembly may be configured to translate the build module at a speed between any of the aforementioned speeds (e.g., from about 0.5 mm/sec² to about 20 mm/sec², from about 0.5 mm/sec² to about 10 mm/sec², or from about 4 mm/sec² to about 20 mm/sec²). The build platform assembly may be configured such that a time to complete a translation of a first portion of the build platform assembly relative to a second portion of the build platform assembly (e.g., to perform a block movement) is at most about 120 seconds (sec), 60 sec, 50 sec, 45 sec, 40 sec, 35 sec, 30 sec, 25 sec, 20 sec, 15 sec, or less. The build platform assembly may be configured such that a time to complete a translation of a first portion of the build platform assembly relative to a second portion of the build platform assembly is any value between the aforementioned values, for example, from about 120 sec to 40 sec, from about 60 sec to 25 sec, or from about 35 sec to 15 sec.

In some embodiments, the powder (e.g., starting material for the 3D printing) is deposited in an enclosure to form a powder bed. The powder may be layered on a target surface, e.g., on an exposed surface of a material or on a surface of the build platform. The deposited layer of powder may be substantially planar. For example, the deposited layer may have a central tendency of planarity (e.g., a surface roughness Ra) that is from about 15% to about 65% of a second central tendency of thickness of the deposited layer. The second central tendency of thickness of the deposited layer may be about equal to a discrete increment of vertical translation of the platform. The second central tendency of thickness of the deposited layer may be about equal to any discrete increment of vertical translation of the build platform assembly, e.g., as disclosed herein.

In some embodiments, the 3D printer comprises an energy source that generates an energy beam. The energy beam may project energy to the powder bed. The apparatuses, systems, and/or methods described herein can comprise at least one energy beam. In some cases, the 3D printing system can comprise at least two, three, four, five, eight, twelve, sixteen, twenty-four, thirty-two, or more energy beams. The energy beam may include radiation comprising electromagnetic, electron, positron, proton, plasma, or ionic radiation. The electromagnetic beam may comprise microwave, infrared, ultraviolet or visible radiation. The ion beam may include a cation or an anion. The electromagnetic beam may comprise a laser beam. The energy beam may derive from a laser source. In some embodiments, the energy source is an energy beam source. The energy source may be a laser source. The laser may comprise a fiber laser, a solid-state laser or a diode laser (e.g., diode pumped fiber laser).

In some embodiments, the energy source is a laser source. The laser source may comprise a Nd: YAG, Neodymium (e.g., neodymium-glass), or an Ytterbium laser. The laser beam may comprise a corona (e.g., ring or doughnut) laser beam, e.g., a laser beam having a footprint similar to a doughnut shape. The laser may comprise a carbon dioxide laser (CO₂ laser). The laser may be a fiber laser. The laser may be a solid-state laser. The laser can be a diode laser. The energy source may comprise a diode array. The energy source may comprise a diode array laser. The laser may be a laser used for micro laser sintering. Examples of 3D printing systems, apparatuses, devices, components (e.g., energy beams), controllers, software, and 3D printing processes can be found in International Patent Application Serial No. PCT/US17/60035, filed Nov. 3, 2017; and in International Patent Application Serial No. PCT/US22/16550, filed Feb. 26, 2022; each of which is entirely incorporated herein by reference.

In some embodiments, the energy beam (e.g., transforming energy beam) comprises a Gaussian energy beam. The energy beam may have any cross-sectional shape comprising an ellipse (e.g., circle), or a polygon (e.g., as disclosed herein). The energy beam may be continuous or non-continuous (e.g., pulsing). The energy beam may be modulated before and/or during the formation of a transformed material as part of the 3D object. The energy beam may be modulated before and/or during the 3D printing process. In some embodiments, the energy beam (e.g., laser) has a power of at least about 150 Watt (W), 200 W, 250 W, 350 W, 500 W, 750 W, 1000 W, or 1500 W. The energy source may have a power between any of the afore-mentioned energy beam power values (e.g., from about from about 150 W to about 1000 W, or from about 1000 W to about 1500 W). The energy beam may derive from an electron gun.

In some embodiments, the 3D printer includes a plurality of energy beam, e.g., laser beams. The 3D printer may comprise at least 2, 4, 6, 8, 10, 12, 16, 20, 24, 32, 36, 64, or more energy beams. Each of the energy beam may be coupled with its own optical window. At times, at least two energy beams may shine through the same optical window. At times, at least two energy beams may shine through different optical windows.

In some embodiments, the energy beam (e.g., transforming energy beam) comprises a Gaussian energy beam. The energy beam may have any cross-sectional shape comprising an ellipse (e.g., circle), or a polygon (e.g., as disclosed herein). The energy beam may be continuous or non-continuous (e.g., pulsing). The energy beam may be modulated before and/or during the formation of a transformed material as part of the 3D object. The energy beam may be modulated before and/or during the 3D printing process.

In some embodiments, the beam profile of the energy beam is altered, e.g., during printing. Any of the 3D printing methodologies disclosed herein can include altering the beam profile. Alteration of the beam profile can be using a physical component and/or a computational scheme (e.g., algorithm). Alteration of the beam profile can comprise manual and/or automatic methods. The automatic methods may comprise usage of at least one controller directing the beam profile alteration. The beam profile may be altered during the 3D printing, e.g., during printing of a layer of transformed material that forms at least a portion of the 3D object. Alteration of the beam profile can comprise alteration of a type of an energy profile utilized. The type of the beam profile comprises: a gaussian beam profile, a top hat beam profile, or a ring (e.g., corona or doughnut) beam profile. For example, the energy beam may print a first portion of the 3D object using a gaussian beam profile, and then print a second portion of the 3D object using a ring shaped beam profile.

In some embodiments, the beam profile of the energy beam is altered, e.g., during printing. Any of the 3D printing methodologies disclosed herein can include altering the beam profile. Alteration of the beam profile can be using a physical component and/or a computational scheme (e.g., algorithm). Alteration of the beam profile can comprise manual and/or automatic methods. The automatic methods may comprise usage of at least one controller directing the beam profile alteration. The beam profile may be altered during the 3D printing, e.g., during printing of a layer of transformed material that forms at least a portion of the 3D object. Alteration of the beam profile can comprise alteration of a type of an energy profile utilized. The type of the beam profile comprises: a gaussian beam profile, a top hat beam profile, or a doughnut (e.g., corona) beam profile. For example, the energy beam may print a first portion of the 3D object using a gaussian beam profile, and then print a second portion of the 3D object using a doughnut shaped beam profile.

In some embodiments, the energy beam(s) is/are utilized for the 3D printing. The energy beam(s) can translate vertically, horizontally, or in an angle (e.g., planar or compound angle). The energy beam(s) can be modulated. The energy beam(s) emitted by the energy source(s) can be modulated.

In some embodiments, at least one of the energy beams is moveable with respect to a powder bed and/or 3D printing system. Movable can be relative to the processing chamber, the build module, the target surface, or any combination thereof. The energy beam can be moveable such that it can translate relative to the powder bed (e.g., across the top surface of the powder bed), e.g., during the printing. The energy beam can be moved by an optical system (e.g., comprising a scanner). The movement of the energy beam can comprise utilization of a scanner e.g., optical scanner to move the energy beam, or mechanical stage type scanner to move the target surface on which the energy beam impinges. The energy beams can be translated independently of each other. In some cases, at least two energy beams can be translated at different rates, and/or along different paths. For example, the movement of a first energy beam may be faster (e.g., at a greater rate) as compared to the movement of a second energy beam. At times, the energy beam(s) are modulated. The energy (e.g., beam) emitted by the energy source can be modulated. The modulator can comprise an amplitude modulator, a phase modulator, or polarization modulator. The modulation may alter the intensity of the energy beam. The modulation may alter the shape (e.g., footprint) of the energy beam. The modulation may alter the current supplied to the energy source (e.g., direct modulation). The modulation may affect (e.g., alter) the energy beam, e.g., external modulation such as external light modulator. The modulator can comprise an acousto-optic modulator or an electro-optic modulator. The modulator can comprise an absorptive modulator or a refractive modulator. The modulation may alter the absorption coefficient of the material that is used to modulate the energy beam. The modulator may alter the refractive index of the material that is used to modulate the energy beam. The energy beam, and/or the platform can be moved by at least one scanner, e.g., optical scanner can move the energy beam, or mechanical stage type scanner to move the target surface on which the energy beam impinges such as moving a powder bed having an exposed. The scanner can be included in an optical system that is configured to direct energy beam from the energy source to a predetermined position on the (target) surface, e.g., an exposed surface of the powder bed. At least two scanners may be operably coupled with a single energy source and/or energy beam. In some embodiments, at least two energy beams are moved by the same scanner. At least two (e.g., each) energy sources and/or beams may have a separate scanner. In some embodiments, at least two energy beams are moved with different scanners, e.g., are each moved with a different scanner. The scanner may comprise one or more optical elements, e.g., mirrors. The scanner may comprise a galvanometer scanner (e.g., a two-axis galvanometer scanner), a polygon, a mechanical-stage (e.g., X-Y-stage), a piezoelectric device, gimbal, or any combination thereof. The galvanometer scanner may comprise a mirror. The scanner may comprise a modulator. The scanner may comprise a polygonal mirror. The systems and/or apparatuses disclosed herein may comprise one or more shutters (e.g., safety shutters). The energy source(s) can project energy using a DLP modulator, a one-dimensional scanner, a two-dimensional scanner, or any combination thereof.

In some embodiments, the energy source is used to generate the energy beam. The energy source can be stationary. In some embodiments, the energy beam (e.g., laser beam) impinges onto an exposed surface of a powder bed to generate at least a portion of a 3D object. The energy beam may be a focused beam. The energy beam may be a dispersed beam. The energy beam may be an aligned beam. The apparatus and/or systems described herein may comprise a focusing coil, a deflection coil, or an energy beam power supply. The optical system may be configured to direct at least one energy beam from the at least one energy source to a position on a target surface such as an exposed surface of the powder bed within the enclosure, e.g., to a predetermined position on the target surface. The 3D printing system may comprise a processor (e.g., a central processing unit). The processor can be programmed to control a trajectory of the at least one energy beam and/or energy source e.g., with the aid of the optical system and/or optical actuator(s). The systems and/or the apparatus described herein can comprise a control system in communication with the energy source(s) and/or energy beam(s). The control system can regulate a supply of energy from the energy source(s) to the material (e.g., to the powder), e.g., to form the transformed material. The control system may control the various components of the optical system. The various components of the optical system may include optical components comprising a mirror(s), a lens (e.g., concave or convex), a fiber, a beam guide, a rotating polygon, or a prism. The optical system may be enclosed in an optical system enclosure, e.g., of the system of optical assemblies. Examples of 3D printing systems, apparatuses, devices, and components (e.g., optical housing and optical system), controllers, software, and 3D printing processes can be found Patent Application serial number PCT/US17/64474, filed Dec. 4, 2017, in International Patent Application serial number PCT/US18/12250, filed Jan. 3, 2018, in International Patent Application Serial No. PCT/US19/226364, filed on May 16, 2019, or in U.S. Provisional Patent Application 63/348,901 filed on Jun. 3, 2022, each of which is incorporated herein by reference in its entirety.

In some embodiments, the 3D printer comprises a power supply. The power supply to any of the components described herein can be supplied by a grid, generator, local, or any combination thereof. The power supply can be from renewable or non-renewable sources. The renewable sources may comprise solar, wind, hydroelectric, or biofuel. The power supply can comprise rechargeable batteries.

In some embodiments, the 3D printing system can comprise two, three, four, five, eight, ten, sixteen, eighteen, twenty, twenty-four, thirty-two, thirty-six, or more energy sources that each generates an energy beam (e.g., laser beam). An energy source can be a source configured to deliver energy to an area (e.g., a confined area). The energy can be in the form of an energy beam such as a laser beam or an electron beam. An energy source can deliver energy to the confined area through radiative heat transfer. The energy source may comprise a laser source or an electron beam source.

In some embodiments, the 3D printing system can comprise at least one (e.g., a plurality of) optical windows. The optical window(s) may be arranged on a roof of the processing chamber. The optical window(s) may be arranged on a side wall of the processing chamber. The optical window(s) may be arranged with respect to the processing chamber to allow transmittance of energy beam(s) directed by the array of optical assemblies into the processing chamber. The optical window(s) may be arranged with respect to the processing chamber to allow transmittance of energy beam(s) directed by the array of optical assemblies into the processing chamber and incident on the target surface supported by the build platform. During the 3D printing, a ventilator and/or gas flow may deter (e.g., measurably and/or substantially prevent) debris from accumulating on the surface of optical window(s) that are disposed within the enclosure (e.g., within the processing chamber). The debris may comprise soot, spatter, or splatter. The optical window may be supported by (or supportive of) a nozzle that directs debris away from the optical window, e.g., at towards the powder bed. The processing cone may assume a shape of a truncated cone within the processing chamber.

In some embodiments, the 3D printing system comprises one or more sensors. The one or more sensor may be at least about 500, 600, 900, or 1000 sensors. At least two of the sensors may be of the same type. At least two of the sensors may be of different type. The 3D printing system includes at least one enclosure. In some embodiments, the 3D printing system (e.g., its enclosure) comprises one or more sensors (alternatively referred to herein as one or more sensors). The enclosure described herein may comprise at least one sensor. The enclosure may comprise, or be operatively coupled with, the build module, the filtering mechanism, gas recycling system, the processing chamber, or the ancillary chamber. The sensor may be connected and/or controlled by the control system (e.g., computer control system, or controller(s)). The control system may be able to receive signals from the at least one sensor. The control system, e.g., through a control scheme, may act upon at least one signal received from the at least one sensor. The control scheme may comprise a feedback and/or feed forward control scheme, e.g., that has been pre-programmed. The feedback and/or feed forward control may rely on input from at least one sensor that is connected to the controller(s).

In some embodiments, the 3D printing system comprises one or more sensors. The one or more sensors can comprise a pressure sensor, a temperature sensor, a gas flow sensor, or an optical density sensor. The pressure sensor may measure the pressure of the chamber (e.g., pressure of the chamber atmosphere). The pressure sensor can be coupled with the control system. The pressure can be electronically and/or manually controlled. The controller may regulate the pressure (e.g., with the aid of one or more vacuum pumps) according to input from at least one pressure sensor. The sensor may comprise light sensor, image sensor, acoustic sensor, vibration sensor, chemical sensor, electrical sensor, magnetic sensor, fluidity sensor, movement sensor, speed sensor, position sensor, pressure sensor, force sensor, density sensor, metrology sensor, sonic sensor (e.g., ultrasonic sensor), or proximity sensor. The metrology sensor may comprise measurement sensor (e.g., height, length, width, depth, angle, and/or volume). The metrology sensor may comprise a magnetic, acceleration, orientation, or optical sensor. The sensor may comprise a material level sensor such as a powder level sensor. The sensor (e.g., material level sensor) may comprise a guided wave radar. The optical sensor may comprise a camera. The metrology sensor may measure the gap. The metrology sensor may measure at least a portion of the layer of powder (e.g., pre-transformed, transformed, and/or hardened). The layer of material may be a pre-transformed material (e.g., powder), transformed material, or hardened material. The metrology sensor may measure at least a portion of the 3D object. The sensor may comprise a temperature sensor, weight sensor, powder level sensor, gas sensor, or humidity sensor. The gas sensor may sense any gas enumerated herein. The temperature sensor may measure the temperature without contacting the powder bed (e.g., non-contact measurements). The weight of the enclosure (e.g., container), or any components within the enclosure can be monitored by at least one weight sensor in or adjacent to the material. One or more position sensors (e.g., height sensors) can measure the height of the powder bed relative to the substrate. The position sensors can be optical sensors. The position sensors can determine a distance between one or more energy sources and a surface of the powder bed. The exposed surface of the powder bed can be the upper surface of the powder bed relative to a gravitational center of the environment. Examples of 3D printing systems, apparatuses, devices, powder beds, and components (e.g., sensors), controllers, software, and 3D printing processes can be found in International Patent Application Serial No. PCT/US17/60035, filed Nov. 3, 2017; and in International Patent Application Serial No. PCT/US22/16550, filed Feb. 26, 2022; each of which is entirely incorporated herein by reference.

In some embodiments, the 3D printer comprises one or more valves. The methods, systems and/or the apparatus described herein may comprise at least one valve. The valve may be shut or opened based at least in part on an input from the at least one sensor (e.g., automatically), or manually. The degree of valve opening or shutting may be regulated by the control system, for example, according to at least one input from at least one sensor. The systems and/or the apparatus described herein can include one or more valves, such as throttle valves or butterfly valves. The valve may or may not comprise a sensor sensing the open/shut position of the valve. The valve may be a component of a gas conveyance system, e.g., operable to control a flow of gas of the gas conveyance system. A valve may be a component of the gas conveyance system, e.g., operable to control a flow of gas in the gas conveyance system. The valve(s) may comprise a proportional valve or a discrete valve.

In some embodiments, the 3D printer comprises one or more actuators such as motors. The motor may be controlled by the controller(s) (e.g., by the control system) and/or manually. The motor may alter (e.g., the position of) the substrate and/or the base. The motor may alter (e.g., the position of) the build platform assembly. The actuator may facilitate translation (e.g., propagation) of the layer dispenser, e.g., the actuator may facilitate reversible translation of the layer dispenser. The motor may alter an opening of the enclosure (e.g., its opening or closure). The motor may be a step motor or a servomotor. The actuator (e.g., motor) may alter (e.g., a position of) one or more optical components, e.g., mirrors, lenses, prisms, and the like. The servomotors may comprise actuated linear lead screw drive motors. The motors may comprise belt drive motors. The motors may comprise rotary encoders. The encoder may comprise an absolute encoder. The encoder may comprise an incremental encoder. The apparatuses and/or systems may comprise switches. The switches may comprise homing or limit switches. The motors may comprise actuators. The motors may comprise linear actuators. The motors may comprise belt driven actuators. The motors may comprise lead screw driven actuators. The actuators may comprise linear actuators.

In some embodiments, the 3D printer (e.g., its components) comprises one or more nozzles. The systems and/or the apparatus described herein may comprise at least one nozzle. For example, the material remover may comprise a nozzle. The nozzle may be regulated according to at least one input from at least one sensor. The nozzle may be controlled automatically or manually. The controller(s) may control the nozzle. The controller(s) may any controller(s) disclosed herein, e.g., as part of the control system of the 3D printer. The nozzle may include jet (e.g., gas jet) nozzle, high velocity nozzle, propelling nozzle, magnetic nozzle, spray nozzle, vacuum nozzle, or shaping nozzle (e.g., a die). The nozzle can be a convergent or a divergent nozzle. The spray nozzle may comprise an atomizer nozzle, an air-aspirating nozzle, or a swirl nozzle. The material dispenser can comprise a nozzle, e.g., through which material is removed from the powder bed. The gas flow system may comprise a nozzle, e.g., that facilitates adjustment to the gas flow. The optical window may be supported by a nozzle that directs debris away from the optical window, e.g., at towards the powder bed. The nozzle may comprise a venturi nozzle.

In some embodiments, the 3D printer comprises one or more pumps. The systems and/or the apparatus described herein may comprise at least one pump. The pump may be regulated according to at least one input from at least one sensor. The pump may be controlled automatically or manually. The controller may control the pump. The one or more pumps may comprise a positive displacement pump. The positive displacement pump may comprise rotary-type positive displacement pump, reciprocating-type positive displacement pump, or linear-type positive displacement pump.

In some embodiments, the 3D printer comprises at least one filter. The filter may comprise a ventilation filter. The ventilation filter may capture debris and/or other gas-borne material (e.g., fine powder) from the 3D printing system. The filter may comprise a paper filter such as a high-efficiency particulate air (HEPA) filter (a.k.a., high-efficiency particulate arresting filter). The ventilation filter may capture debris comprising soot, splatter, spatter, gas borne powder, or gas borne transformed material. The debris may result from the 3D printing process. The filter and/or gas flow may direct the debris in a requested direction (e.g., by using positive and/or negative gas pressure). For example, the filter and/or gas flow may use vacuum, overpressure, and/or gas pulsing. For example, the ventilator may use gas flow.

At times, it may be advantageous to allow for easy installation and/or component maneuvering of the 3D printing system. For example, it may be advantageous if one or more components of the 3D printing system are easily maneuvered, e.g., insertable and/or removed. Easy maneuvering (e.g., removal and/or insertion) may include actions of a user facing the 3D printing system, and maneuvering (e.g., pulling and/or pushing) the one or more components to facilitate their maneuver, e.g., removal and/or insertion, respectively. For example, easy maneuvering (e.g., removal and/or insertion) may include actions of a personnel facing a front, a back, a side, a top, or a bottom of the 3D system, and maneuvering (e.g., pulling and/or pushing) the one or more components to facilitate their maneuver (e.g., removal and/or insertion, respectively). The one or more components may comprise: an optical system (e.g., including an array of optical assemblies, a laser generator), a detection system, an optical system enclosure, a side cover, or a door. The front of the 3D printing system can include a door to the processing chamber. The top of the 3D printing system can face the platform, e.g., through the optical window(s). The one or more components can be reversibly secured to and release from the rest of the 3D printing system using a (e.g., flexible) fastener. The flexible fastener may facilitate reversible maneuvering of a component (e.g., retraction and insertion of the component into a designated location in the 3D printing system. The fastener may comprise any material disclosed herein, e.g., an elemental metal, a metal alloy, or a polymer. The fastener may comprise a lock assembly. The fastener may comprise a snap (e.g., snap fit) assembly, or a latch assembly. The fastener may comprise interlocking portions that engage and/or disengage using human exerted force. The fastener may comprise a cantilever, torsional or annular. The fastener may be devoid of loose parts. The fastener may or may not comprise a spring. In some embodiments, a component may be configured to (e.g., reversibly) snap into and/or out of a cavity in the 3D printing system, e.g., without any fastener, and rather due to the geometric configuration of the cavity edge and component edge that fit together. The fastener may comprise a screw, a peg, or a pin. The component (e.g., energy source) may be disposed on a rack (e.g., an electronic rack). The component may be engaged with a sliding mechanism (e.g., similar to a drawer). For example, the component may comprise at least one wheel (e.g., wheels) configured to couple to at least one rail (e.g., two rails) disposed in 3D printing system cavity. For example, the component may comprise at least one rail (e.g., two rails) configured to couple to the 3D printing system cavity (e.g., wheel(s) configured to engage with the at least one rail. The component and/or 3D printing system cavity may comprise bracket(s) as part of the engagement mechanism between the 3D printing system cavity and the component. The engagement mechanism may comprise a rail, a wheel, or a bracket. The engagement mechanism may facilitate linear and/or tilting sliding of the component with respect to the 3D printing system. Any parts of the components may remain stable (e.g., configured to remain stable) during the maneuvering. For example, one or more parts (e.g., all parts) of the optical system may be stable during extraction of the optical system and/or one or more components of the optical system (e.g., an optical assembly of the array of optical assemblies) from the 3D printing system and/or insertion of the optical system into the 3D printing system. Such (e.g., reversible) maneuvering methodology may allow easy assembly, and/or maintenance of the 3D printing system (e.g., of the component thereof).

At times, maneuvering the optical system with respect to the 3D printing system causes no, or minimum (e.g., non-material), alternation of the optical system(s) disposed in the optical system enclosure. For example, one or more parts (e.g., all parts) of the optical system, optical assembly/ies, or of the optical system enclosure may be stable during extraction of the optical system, optical assembly/ies, (or optical system enclosure comprising the optical system) from the 3D printing system and/or insertion of the optical system or optical assembly/ies into the 3D printing system. Such (e.g., reversible) maneuvering methodology may allow easy assembly, and/or maintenance of the 3D printing system (e.g., of the component thereof).

At times, the energy beam follows a path. The path of the energy beam may be a vector. The path of the energy beam may comprise a raster, a vector, or any combination thereof. The path of the energy beam may comprise an oscillating pattern. The path of the energy beam may comprise a zigzag, wave (e.g., curved, triangular, or square), or curve pattern. The curved wave may comprise a sine or cosine wave. The path of the energy beam may comprise a sub-pattern. The path of the energy beam may comprise an oscillating (e.g., zigzag), wave (e.g., curved, triangular, or square), and/or curved sub-pattern. The curved wave may comprise a sine or cosine wave.

The path of the energy beam may comprise a sub-pattern. The sub-pattern of the energy beam may comprise a wave (e.g., sine or cosine wave) pattern. The sub-pattern may be a small path that forms the large path. The sub-pattern may be a component (e.g., a portion) of the large path. The path that the energy beam follows may be a predetermined path. A model may predetermine the path by utilizing a controller or an individual (e.g., human). The controller may comprise a processor. The processor may comprise a computer, computer program, drawing or drawing data, statue or statue data, or any combination thereof. The hatch lines or paths may be straight or curved. The hatch lines or paths may be winding. At times, the path comprises successive lines. The successive lines may touch each other. The successive lines may overlap each other in at least one point. The successive lines may substantially overlap each other. The successive lines may be spaced by a first distance (e.g., hatch spacing). Examples of 3D printing systems, apparatuses, devices, and any component thereof; controllers, software, and 3D printing processes (e.g., hatch spacings) can be found in International Patent Application Serial No PCT/US16/34857 filed on May 27, 2016, titled “THREE-DIMENSIONAL PRINTING AND THREE-DIMENSIONAL OBJECTS FORMED USING THE SAME” that is entirely incorporated herein by reference.

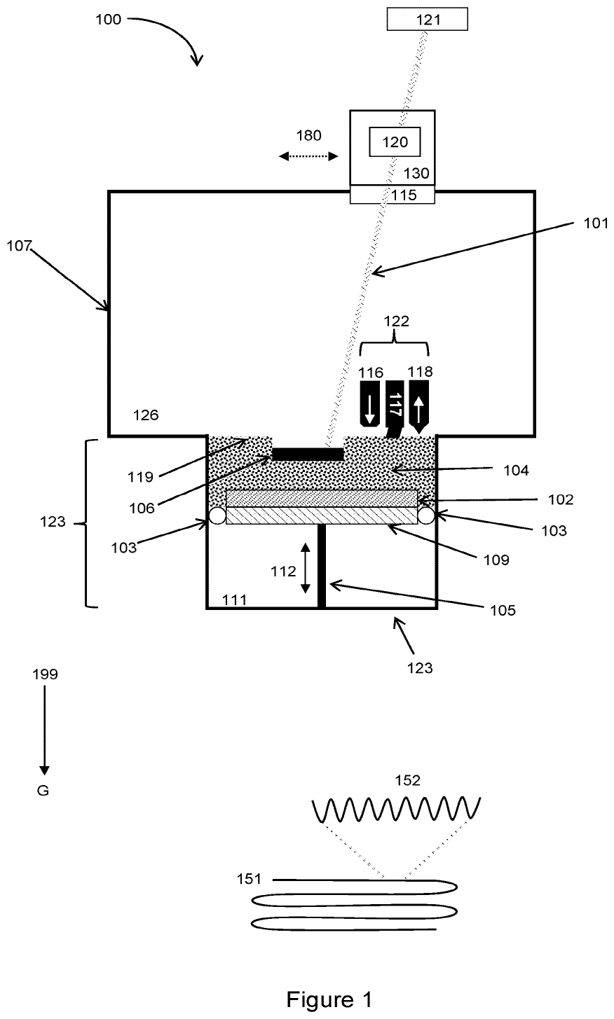

FIG. 1 shows an example of a 3D printing system 100 having a processing chamber 107 coupled with a build module 123. The build module comprises an elevation mechanism 105 (e.g., as part of a build platform assembly) that vertically translate a substrate 109 (e.g., piston) along arrow 112. A build platform 102 is disposed on substrate 109 (e.g., piston). Powder bed 104 is disposed above build platform 102 (e.g., also referred herein as “base”, or “build plate”). The 3D printing system 100 comprises an optical system 120 (e.g., a guidance system) for energy beam 101 (e.g., a galvanometer scanner). The optical system 120 is disposed in optical system enclosure 130 coupled with optical window 115. Optical system 120 can optionally be translatable along axis 180, e.g., translatable along an axis perpendicular to gravitational vector 199. Energy source (e.g., laser source) 121 generates energy beam 101 that traverses through the optical system 120 (e.g., comprising a guidance system such as a scanner) and through an optical window 115 into processing chamber 107 enclosing interior space 126 that can include an atmosphere. The optical window 115 is configured to allow the energy beam to pass through with minimal energetic loss, e.g., without (e.g., substantial) energetic loss. Processing chamber 107 can include an optional temperature adjustment device (e.g., cooling plate), not shown. Seal 103 encircles the substrate and/or base, e.g., to deter (e.g., prevent) migration of material of the powder bed from reaching elevation mechanism 105. Energy beam 101 impinges upon an exposed surface 119 of powder bed 104, to form at least a portion of a 3D object 106. FIG. 1 shows an example of a build module 123. Build module 123 contains the pre-transformed powder (e.g., starting) material in a powder bed 104. The pre-transformed material is the material before it has been transformed by the energy beam to a transformed material. As depicted in FIG. 1, the 3D printer comprises a layer dispensing mechanism 122. The layer dispensing mechanism 122 includes a material dispenser 116 and a powder removal mechanism 118 to form a layer of pre-transformed material (e.g., starting material) within the enclosure. Layer dispensing mechanism 122 includes an optional leveler 117. The material may be layered (e.g., spread) in the enclosure such as by using the layer dispensing mechanism 122. Build module 123 is configured to enclose a substrate 109 (e.g., piston) and arranged adjacent to a floor 111 at the bottom of build module 123. Floor 111 is defined relative to the gravitational field along gravitational vector 199 pointing towards gravitational center G, and/or relative to the position of the footprint of the energy beam 101 on the layer of pre-transformed material as part of a powder bed 104. Build module 123 comprises build platform 102. The substrate is coupled with one or more seals 103 that enclose the material in a selected area within the build module to form powder bed 104. One or more components of 3D printing system 100 are controlled by a control system (not shown in FIG. 1). The energy beam 101 can travel along a path such as path 151. FIG. 1 shows an example of a path of an energy beam path 151 comprising a zigzag sub-pattern. Sub-pattern 152 is an expansion (e.g., blow-up) of a portion of path 151.

In some embodiments, the formation of the 3D object includes transforming (e.g., fusing, binding and/or connecting) the pre-transformed material (e.g., 3D printing starting material such as a powder) using an energy beam. The energy beam may be projected on to the starting material (e.g., disposed in the powder bed), thus causing the pre-transformed material to transform (e.g., fuse). The pre-transformed or transformed material can absorb the energy from the energy source (e.g., energy beam, diffused energy, and/or dispersed energy), and as a result, a localized region of that pre-transformed or transformed material can increase in temperature (e.g., and at least partially transform). The energy beam may cause at least a portion of the pre-transformed (e.g., powder) material to transform from its present state of matter to a different state of matter. For example, the pre-transformed material may transform at least in part (e.g., completely) from a solid to a liquid state. The energy beam may cause at least a portion of the pre-transformed material to chemically transform. For example, the energy beam may cause chemical bonds to form or break. The chemical transformation may be an isomeric transformation. The transformation may comprise a magnetic transformation or an electronic transformation. The transformation may comprise coagulation of the material, cohesion of the material, or accumulation of the material. Transformation of the material may comprise connecting disconnected starting materials. For example, connecting various powder particles. The connection may comprise phase transfer, or chemical bonding. The connection may comprise fusing the starting material, e.g., sintering or melting the starting material.

In some embodiments, the methods described herein comprise repeating the operations of material deposition and material transformation operations to produce (e.g., print) a 3D object (or a portion thereof) by at least one 3D printing (e.g., additive manufacturing) method. For example, the methods described herein may comprise repeating the operations of depositing a layer of powder and transforming at least a portion of the powder to connect to the previously formed 3D object portion (e.g., repeating the 3D printing cycle), thus forming at least a portion of a 3D object. The transforming operation may comprise utilizing energy beam(s) to transform the material. In some instances, the energy beam is utilized to transform at least a portion of the powder bed.

In some embodiments, the term “auxiliary support,” as used herein, generally refers to at least one feature that is a part of a printed 3D object, but not part of the requested, intended, designed, ordered, and/or final 3D object. Auxiliary support may provide structural support during and/or after the formation of the 3D object. The auxiliary support may be anchored to the enclosure. For example, an auxiliary support may be anchored to the build platform (e.g., build platform such as a build plate), to the side walls of the powder bed, to a wall of the enclosure, to an object (e.g., stationary or semi-stationary) within the enclosure, or any combination thereof. The auxiliary support may be the build platform or the bottom of the enclosure. The auxiliary support may enable the removal of energy from the 3D object (e.g., or a portion thereof) that is being formed. The removal of energy (e.g., heat) may be during and/or after the formation of the 3D object. Examples of auxiliary support comprise a fin (e.g., heat fin), anchor, handle, pillar, column, frame, footing, wall, build platform, or another stabilization feature. In some instances, the auxiliary support may be mounted, clamped, or situated on the build platform. The auxiliary support can be anchored to the build platform, to the sides (e.g., walls) of the build platform, to the enclosure, to an object (stationary or semi-stationary) within the enclosure, or any combination thereof. Sometimes, the generated 3D object may comprise one or more auxiliary supports. The auxiliary support may be suspended in the powder. The auxiliary support may provide weight or stabilizer. The auxiliary support can be suspended in the powder bed such as within the layer of powder in which the 3D object (or a portion thereof) has been formed. The auxiliary support may touch the build platform. The auxiliary support may be suspended in the powder bed and not touch (e.g., contact) the build platform. The auxiliary support may be anchored to the build platform.

In some examples, the generated 3D object(s) can be printed without auxiliary support in a powder bed in which it/they are formed. In some examples, low overhanging feature and/or hollow cavities of the generated 3D object can be printed without (e.g., without any) auxiliary support. The low overhanging features may be shallow overhanging features with respect to an exposed surface of the powder bed. The low overhanging features may form an angle of at most about 40 degrees (°), 35°, or 25° with the exposed surface of the powder bed (or a plane parallel thereto). The printed 3D object can be devoid of auxiliary supports. The printed 3D object may be suspended (e.g., float anchorlessly) in the powder bed (e.g., powder bed). The term “anchorlessly,” as used herein, generally refers to without, or in the absence of, an auxiliary anchor. In some examples, an object is suspended in a powder bed anchorlessly without attachment to a support. For example, the object floats in the powder bed. A portion of the printed 3D object can be devoid of auxiliary supports. The portion of the 3D object may be suspended over a volume of the powder bed. For example, a portion of the object defines an enclosed cavity which may be temporarily filled with powder during a build process. The generated 3D object may be suspended in the layer of powder. The powder can offer support to the printed 3D object (or the object during its generation).

In some examples, the at least 3D object may be generated above a build platform, which at least one 3D object comprises auxiliary supports. In some examples, the auxiliary support(s) adhere (e.g., connect) to the build platform, e.g., the upper surface of the build platform). In some examples, the auxiliary supports of the printed 3D object may touch the build platform (e.g., the bottom of the enclosure, the substrate, or the base. In some embodiments, the auxiliary supports are an integral part of the build platform. At times, auxiliary support(s) of the printed 3D object, do not touch the build platform. In any of the methods described herein, the printed 3D object may be supported only by the powder within the powder bed. Any auxiliary support(s) of the printed 3D object, if present, may be suspended adjacent to the build platform. Occasionally, the build platform may have a pre-hardened (e.g., pre-solidified) amount of material. Such pre-solidified material may provide support to the printed 3D object. At times, the build platform may provide adherence to the material. At times, the build platform does not provide adherence to the material. The build platform may comprise elemental metal, metal alloy, elemental carbon, or ceramic. The build platform may comprise a composite material (e.g., as disclosed herein). The build platform may comprise glass, stone, zeolite, or a polymeric material. The polymeric material may include a hydrocarbon or fluorocarbon. The build platform (e.g., base) may include Teflon. The build platform may include compartments for printing small objects. Small may be relative to the size of the enclosure. The compartments may form a smaller compartment within the enclosure, which may accommodate a layer of powder.

In some examples, when the energy source is in operation, the powder bed reaches a certain (e.g., average) temperature. The average temperature of the powder bed can be an ambient temperature or “room temperature.” The average temperature of the powder bed can have an average temperature during the operation of the energy (e.g., beam(s)). The average temperature of the powder bed can be an average temperature during the formation of the transformed material, the formation of the hardened material, or the generation of the 3D object. The average temperature can be below or just below the transforming temperature of the material. Just below can refer to a temperature that is by at most about 1° C., 2° C., 3° C., 4° C., 5° C., 6° C., 7° C., 8° C., 9° C., 10 C, 15° C., or 20° C. below the transforming temperature. The average temperature of the powder bed (e.g., powder) can be by at most about 25° C. (degrees Celsius), 50° C., 100° C., 150° C., 200° C., 250° C., 300° C., 400° C., 500° C., 600° C., 700° C., 800° C., 900° C., 1000° C., 1200° C., 1400° C., 1600° C., 1800° C., or 2000° C. The average temperature of the powder bed (e.g., powder) can be at least about 20° C., 25° C., 50° C., 100° C., 150° C., 200° C., 250° C., 300° C., 400° C., 500° C., 600° C., 700° C., 800° C., 900° C., 1000° C., 1200° C., 1400° C., 1600° C., or 1800° C. The average temperature of the powder bed (e.g., of the powder therein) can be any temperature between the afore-mentioned material average temperatures. The temperature of the powder bed can be conditioned (e.g., heated or cooled) before, during, or after forming (e.g., printing) the 3D object (e.g., hardened material). The powder bed temperature can be controlled (e.g., substantially maintained) at a predetermined value. The temperature of the powder bed can be monitored. The material temperature can be controlled manually and/or by a control system (e.g., such as any control system disclosed herein).

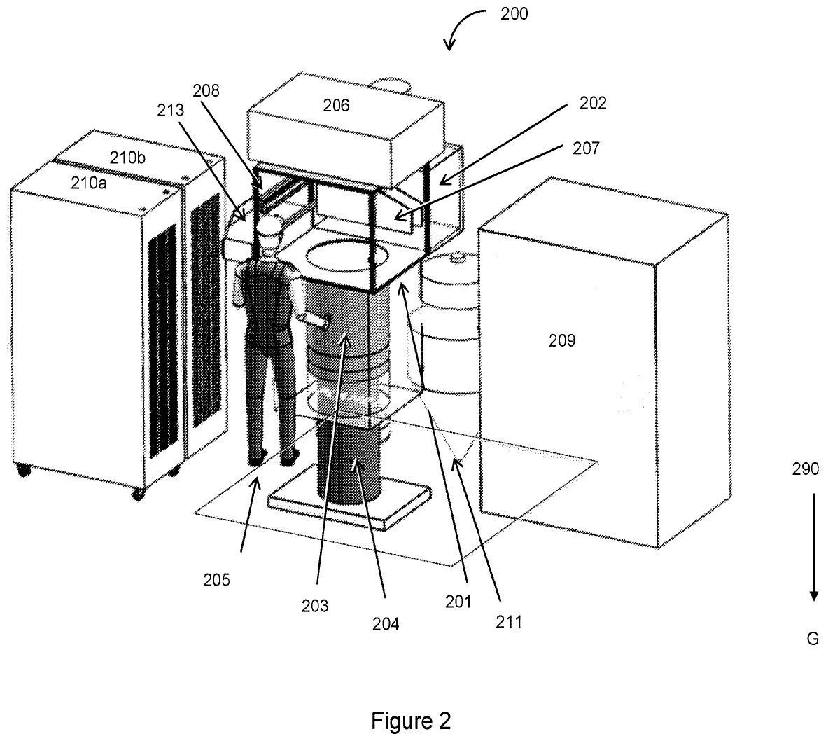

FIG. 2 shows an example of a 3D printing system 200 disposed in relation to gravitational vector 290 directed towards gravitational center G. The 3D printing system comprises processing chamber 201 coupled with an ancillary chamber (e.g., garage) 202 configured to accommodate a layer dispensing mechanism (e.g., recoater), e.g., in its resting (e.g., idle) position. The processing chamber is coupled with a build module 203 that extends 204 under a plane (e.g., floor) at which user 205 stands on (e.g., can extend under-grounds). The processing chamber may comprise a door (not shown) facing user 205. 3D printing system 200 comprises optical system enclosure 206 that can comprise an energy beam alignment system, e.g., comprising at least one optical array comprising at least one guidance system (e.g., scanner) . . . . A layer dispensing mechanism (not shown) may be coupled with framing 207 as part of a movement system that facilitate movement of the layer dispensing mechanism along the powder bed and garage, e.g., in a reversible back-and-forth movement. The movement system comprises a translation inducer system, e.g., comprising a belt or a chain 208. 3D printing system 200 comprises a filter unit 209, heat exchangers 210a and 210b, pre-transformed material (e.g., powder) reservoir 211, and gas conveyance system (e.g., comprising gas inlets and gas inlet portions) disposed in enclosure 213. The filtering system may filter gas and/or pre-transformed material. The filtering system may be configured to filter debris, e.g., comprising byproduct(s) of the 3D printing.

In some embodiments, 3D printing system comprises a powder conveyance system. The powder conveyance system may be coupled with a processing chamber having a layer dispensing mechanism (e.g., recoater). Powder from a reservoir (e.g., hopper) can be introduced into the layer dispensing mechanism disposed in the processing chamber. Once the layer dispensing mechanism dispenses a planar layer of powder to layerwise form a powder bed utilized for the three-dimensional printing, excess powder may be attracted away from the powder bed. In this process, excess powder may be attracted away from the powder bed using layer dispensing mechanism (e.g., by the powder remover component thereof), and introduced into separator (e.g., cyclone), and optionally to an overflow separator (e.g., cyclone). The powder may undergo separation (e.g., cyclonic separation) in separator(s), and may be introduced into sieve(s), followed by gravitational flow into a lower reservoir (e.g., hopper). The separated and sieved powder can be then delivered into separator(s), and into a reservoir that can deliver the powder back into the layer dispensing mechanism. The separator may be coupled with sieve(s) instead of to the reservoir. The powder conveyance system may comprise pumps (e.g., displacement pump and/or compressor pumps), and a temperature regulator (e.g., heater or radiator such as a radiant plane). The powder conveyance system may comprise a venturi nozzle, for example, to facilitate suction of the powder from the reservoir into separator(s). The powder conveyance system can include a condensed gas source (e.g., a blower or a cylinder of condensed gas). The powder conveyance system may include a heat exchanger. The powder conveyance system may include one or more filters. The powder conveyance system may operate at a positive pressure above ambient pressure external to the powder conveyance system (e.g., above about one atmosphere). The gas conveyance system may be configured to circulate (e.g., recirculate) gas also in the processing chamber. The gas conveyance system may sweep debris (e.g., soot) away from the process area in which the 3D object is being printed. At times, a pressure differential is required to convey powder from one compartment of the 3D printer to another. The pressure differential may be established via pressurizing or vacuuming one or more compartments. For example, powder from the layer dispensing system to the recycling system (e.g., including the separator(s), sieve(s), and/or reservoirs) may be conveyed using (a) induced pressure differential among components, (b) pressure isolation of the components, and (c) induced pressure equilibration of components.

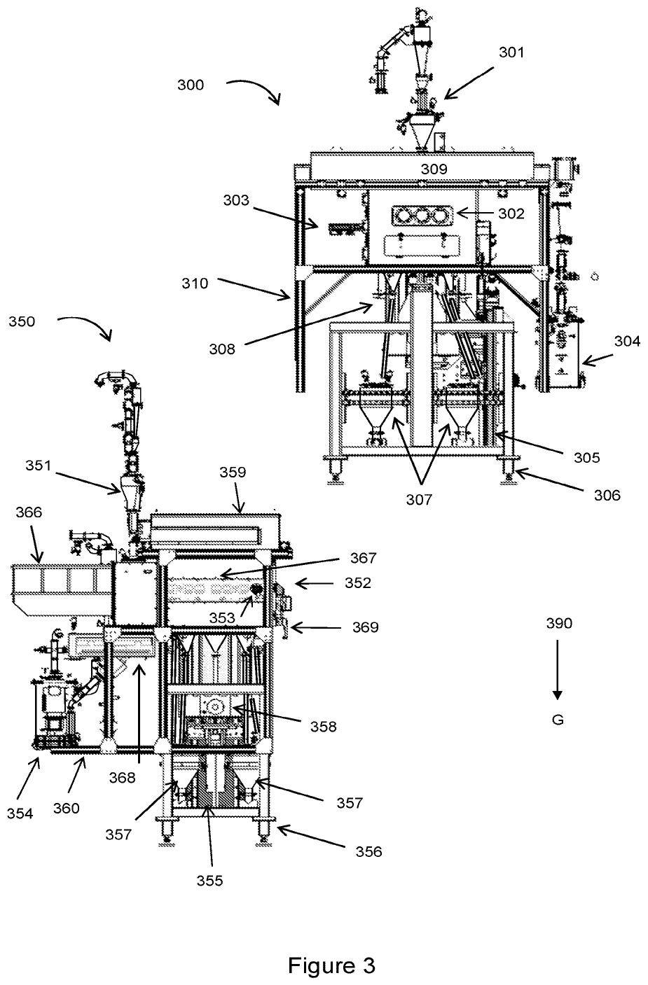

FIG. 3 shows in example 300 a front side example of a portion of a 3D printing system comprising a material reservoir 301 configured to feed powder to a layer dispensing mechanism, and an optical system enclosure 309 configured to enclose, e.g., one or more optical system including scanner(s) and/or director(s) of at least one energy beam (e.g., laser beam) configured to transform the powder into a transformed material to print one or more 3D object in a printing cycle. Example 300 of FIG. 3 shows processing chamber 302 having a primary door with three circular viewing windows and a secondary door, e.g., having a glove box type arrangement. Example 300 show a material reservoir 304 configured to accumulate a remainder powder. The remainder may be from the layer dispensing mechanism, post 305 as part of a build platform assembly of build module 308, two material reservoirs 307 for accumulating a remainder of the powder bed that did not form the 3D object, and actuator 303 configured to translate the layer dispensing mechanism to dispense a layer of powder as part of a powder bed. Supports 306 are planarly stationed in a first horizontal plane, which supports 306 and associated framing support one section of the 3D printing system portion 300 and framing 310 is disposed on a second horizontal plane higher than the first horizontal plane. FIG. 3 shows in 350 an example side view example of a portion of the 3D printing system shown in example 300, which side view comprises a material reservoir 351 configured to feed powder to a layer dispensing mechanism (not shown), an enclosure 359 enclosing an optical system (e.g., including scanners and/or directors) of at least one energy beam (e.g., laser beam) configured to transform the powder into a transformed material to print one or more 3D object in a printing cycle. Example 350 of FIG. 3 shows an example of a processing chamber 352 having a door comprising handle 369 (as part of a handle assembly). 3D printing system portion 350 shows a material reservoir 354 configured to accumulate recycled remainder from the layer dispensing process to form a powder bed and/or a remainder of the powder bed that did not form one or more 3D objects during a printing cycle, and a portion of the material conveyance system 368 configured to convey the material to reservoir 354. The remainder material conveyed to reservoir 354 may be separated (e.g., sieved) before reaching reservoir 354. The example shown in 350 shows post 355 as part of a build platform assembly of build module 358, two material reservoirs 357 for accumulating a remainder of the powder bed that did not form the 3D object, and actuator 353 configured to translate the layer dispensing mechanism to dispense a layer of powder as part of a powder bed, e.g., along railing 367 in processing chamber and into garage 366 in a reversible (e.g., back and forth) movement. Supports 356 are planarly stationed in a first horizontal plane, which supports 356 and associated framing support one section of the 3D printing system portion 350 and framing 360 is disposed on a second horizontal plane higher than the first horizontal plane. In the example shown in FIG. 3, the 3D printing system components is aligned with respect to gravitational vector 390 pointing towards gravitational center G.

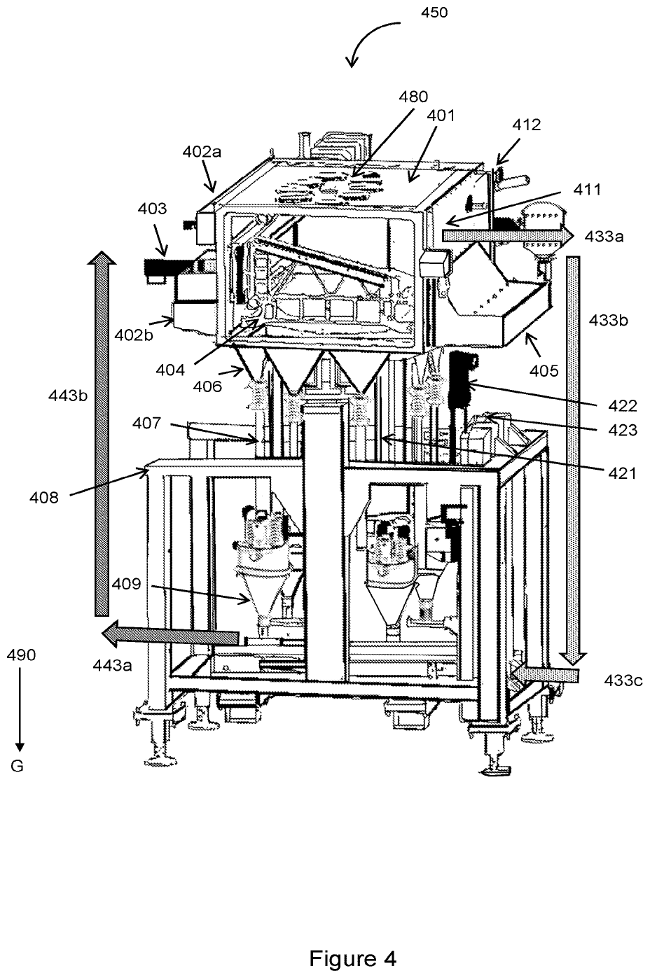

FIG. 4 shows a perspective view example of a portion of a 3D printing system including a processing chamber having a roof 401 in which eight optical windows 480 are disposed to each facilitate penetration of each of eight energy beam respectively into the interior space of processing chamber having side wall 411 comprising a gas exit port covering 405 coupled thereto. The processing chamber has two gas entrance port coverings 402a and 402b coupled with a wall opposing side wall 411. The opposing wall to wall 411 is coupled with actuator 403 configured to facilitate translation of a layer dispensing mechanism mounted on framing 404 above a base disposed adjacent to a floor of the processing chamber (e.g., the base can be flush with the floor), which framing is configured to translate reversibly back and forth in the processing chamber along railings. The processing chamber floor has slots through which remainder material can flow downwards towards gravitational center G along gravitational vector 490. The slots are coupled with funnels such as 406, which are connected by channels (e.g., pipes) such as 407 to material reservoir such as 409. The processing chamber is coupled with a build module 421 that comprises a substrate to which the base is attached, which substrate is configured to vertically translate with the aid of actuator 422 coupled with an elevator motion stage (e.g., supporting plate) 423 via a bent arm. The elevator motion stage 423 and its coupled components are supported by framing 408. An atmosphere (e.g., content and/or pressure) may be equilibrated between the material reservoirs 409 and the processing chamber via schematic channel (e.g., pipe) portions 433a-c. Remainder material in the material reservoirs may be conveyed via schematic channels (e.g., pipes) 443a-b to a material recycling system, e.g., at least in part for future use in printing and/or debris removal. The components of the 3D printing system are disposed relative to gravitational vector 490 pointing to gravitational center G.

At times, the methods described herein are performed in an enclosure (e.g., container, processing chamber, and/or build module). One or more 3D objects can be formed (e.g., generated, and/or printed) in the enclosure (e.g., simultaneously, and/or sequentially). The enclosure may have a predetermined and/or controlled (e.g., maintained) pressure. The enclosure may have a predetermined and/or controlled atmosphere, e.g., during the 3D printing. The control may be manual or via a control system. The atmosphere may comprise at least one gas.

In some embodiments, the enclosure comprises an atmosphere having an ambient pressure (e.g., 1 atmosphere), or positive pressure above ambient pressure in an ambient environment external to the enclosure. The atmosphere may have a negative pressure (i.e., vacuum). Different (e.g., compartmentalized) portions of the enclosure may have different atmospheres. The different atmospheres may comprise different gas compositions. The different atmospheres may comprise different atmosphere temperatures. The different atmospheres may comprise ambient pressure (e.g., 1 atmosphere), negative pressure (i.e., vacuum) or positive pressure. The different portions of the enclosure may comprise the processing chamber, build module, or enclosure volume excluding the processing chamber and/or build module. The vacuum may comprise pressure below 1 bar, below 1 atmosphere, or below ambient pressure in the ambient environment. The positively pressurized environment may comprise pressure above 1 bar, above 1 atmosphere, or above the ambient pressure. In some cases, the chamber pressure can be (e.g., substantially) standard atmospheric pressure. The pressure may be measured at an ambient temperature, e.g., room temperature such as 20° C., or 25° C.

In some embodiments, the enclosure comprises an atmosphere. The atmosphere within the enclosure may comprise a positive pressure above ambient pressure in an ambient environment external to the enclosure. The atmosphere within the enclosure may be different than an atmosphere outside the enclosure. At times, a differential atmosphere (e.g., a difference in atmospheres between the inside of the enclosure and the outside of the enclosure) depends in part on a processing condition of the three-dimensional printing. Processing conditions can include, for example, (i) a composition of the powder, (ii) an internal temperature of the powder bed during the three-dimensional processing, (iii) a number of energy beams (e.g., an average number of energy beams) transforming (e.g., incident on) the target surface during the three-dimensional processing, (iv) an amount of contamination by debris during the three-dimensional processing, (v) temperature in the powder bed during 3D printing, (vi) temperature in the processing chamber during the printing, (vii) amount of energy supplied by the energy beams to the powder bed, or (vii) any combination thereof. For example, a differential atmosphere between the interior of the enclosure (e.g., within the processing chamber) and an ambient environment external to the enclosure may depend at least in part on an average number of energy beams utilized during the three-dimensional process.

In some embodiments, the enclosure includes an atmosphere that is greater than (e.g., at a positive pressure with respect to) an ambient atmosphere external to the enclosure. The atmosphere within the enclosure may comprise a positive pressure of at least about 20 Kilo Pascal (KPa), 18 KPa, 16 KPa, 14 KPa, 12 KPa, 10 KPa, or 5 KPa above ambient atmospheric pressure, e.g., above 101 KPa. The pressure in the enclosure can be at a range between any of the afore-mentioned pressure values above atmospheric pressure, e.g., from about 5 KPa to about 20 KPa, the values representing a pressure difference above atmospheric pressure, e.g., above 101 KPa. The pressure can be measured by a pressure gauge. The pressure can be measured at ambient temperature (e.g., room temperature (R.T.)). In some cases, the chamber pressure can be standard atmospheric pressure. The pressure may be measured at an ambient temperature (e.g., room temperature such as about 20° C., or about 25° C.). The composition of the atmosphere within the enclosure may comprise any one or more of the gases described herein, for example, clean dry air (CDA), argon, and/or nitrogen. The gas may comprise a reactive agent (e.g., comprising oxygen or humidity). The atmosphere may comprise a v/v percent of the reactive agent (gas) of at most about 0.05%, 0.1%, 0.2%, 0.3%, 0.4%, 0.5%, 0.6%, 0.7%, 0.8%, 0.9%, 1%, 2%, 3%, 4%, or 5%, at ambient pressure (e.g., and ambient temperature). The atmosphere may comprise any percent of the reactive agent (gas) between the aforementioned percentages of hydrogen gas. The enclosure may comprise a gas flow, e.g., before, after, and/or during three-dimensional printing. The gas flow within the enclosure may comprise at least about 150 liters per minute (LPM), 200 LPM, 250 LPM, 300 LPM, 350 LPM, 400 LPM, 450 LPM, 500 LPM, 550 LPM, 600 LPM, 650 LPM, 700 LPM, 750 LPM, 800 LPM, 900 LPM, 1000 LPM, or 1200 LPM. The gas flow within the enclosure may comprise any value between the aforementioned values, for example, from about 150 LPM to about 500 LPM, from about 450 LPM to about 750 LPM, or from about 700 LPM to about 1200 LPM.

In some embodiments, the enclosure includes an atmosphere. The enclosure may comprise a (e.g., substantially) inert atmosphere. The atmosphere in the enclosure may be (e.g., substantially) depleted by one or more gases present in the ambient atmosphere. The atmosphere in the enclosure may include a reduced level of one or more gases relative to the ambient atmosphere. For example, the atmosphere may be substantially depleted, or have reduced levels of water (i.e., humidity), oxygen, nitrogen, carbon dioxide, hydrogen sulfide, or any combination thereof. The level of the depleted or reduced level gas may be at most about 0.1 parts per million (ppm), 1 ppm, 3 ppm, 10 ppm, 50 ppm, 100 ppm, 500 ppm, 1000 ppm, 3000 ppm, or 5000 ppm volume by volume (v/v). The level of the depleted or reduced level gas may be at least about 1 ppm, 10 ppm, 50 ppm, 100 ppm, 500 ppm, 1000 ppm, or 5000 ppm (v/v). The level of the oxygen gas may be at most about 1 ppm, 10 ppm, 50 ppm, 100 ppm, 500 ppm, 1000 ppm, or 2000 ppm (v/v). The level of the water vapor may be at most about 1 ppm, 10 ppm, 50 ppm, 100 ppm, 500 ppm, 700 ppm, 800 ppm, 900 ppm, or 1000 ppm (v/v). The level of the gas (e.g., depleted or reduced level gas, oxygen, or water) may be between any of the afore-mentioned levels of gas. The atmosphere may comprise air. The atmosphere may be inert. The atmosphere in the enclosure (e.g., processing chamber) may have reduced reactivity (e.g., be non-reactive) as compared to the ambient atmosphere external to the processing chamber and/or external to the printing system. The atmosphere may have reduced reactivity with the material (e.g., the powder deposited in the layer of material (e.g., powder) or with the material comprising the 3D object), which reduced reactivity is compared to the reactivity of the ambient atmosphere. The atmosphere may hinder (e.g., prevent) oxidation of the generated 3D object, e.g., as compared to the oxidation by an ambient atmosphere external to the 3D printer and/or processing chamber. The atmosphere may hinder (e.g., prevent) oxidation of the powder within the layer of powder before its transformation, during its transformation, after its transformation, before its hardening, after its hardening, or any combination thereof. The atmosphere may comprise an inert gas. For example, the atmosphere may comprise argon or nitrogen gas. The atmosphere may comprise a Nobel gas. The atmosphere can comprise a gas selected from the group consisting of argon, nitrogen, helium, neon, krypton, xenon, hydrogen, carbon monoxide, and carbon dioxide. The atmosphere may comprise hydrogen gas. The atmosphere may comprise a safe amount of hydrogen gas. The atmosphere may comprise a v/v percent of hydrogen gas of at least about 0.05%, 0.1%, 0.2%, 0.3%, 0.4%, 0.5%, 0.6%, 0.7%, 0.8%, 0.9%, 1%, 2%, 3%, 4%, or 5%, at ambient pressure (e.g., and ambient temperature). The atmosphere may comprise a v/v percent of hydrogen gas of at most about 0.05%, 0.1%, 0.2%, 0.3%, 0.4%, 0.5%, 0.6%, 0.7%, 0.8%, 0.9%, 1%, 2%, 3%, 4%, or 5%, at ambient pressure (e.g., and ambient temperature). The atmosphere may comprise any percent of hydrogen between the afore-mentioned percentages of hydrogen gas. The atmosphere may comprise a v/v hydrogen gas percent that is at least able to react with the material (e.g., at ambient temperature and/or at ambient pressure), and at most adhere to the prevalent work-safety standards in the jurisdiction (e.g., hydrogen codes and standards). The material may be the material within the layer of powder, the transformed material, the hardened material, or the material within the 3D object. Ambient refers to a condition to which people are generally accustomed. For example, ambient pressure may be about one (1) atmosphere.

In some embodiments, material utilized in the 3D printing undergoes passivation, e.g., using a passivation system. A passivation system may comprise (A) an in-situ passivation system (e.g., to passivate filtered debris and/or any other gas borne material before their disposal), (B) an ex-situ passivation system, or (C) a combination thereof. The passivation system may control a level of the oxidizing agent below a threshold. The oxidizing agent in the oxidizing mixture (e.g., oxygen) may be kept below a threshold (e.g., below 2000 ppm), e.g., by using one or more controllers such as the control system disclosed herein.

In some embodiments, the gas in the gas conveyance system and/or enclosure comprises a robust gas. The robust gas may comprise an inert gas, e.g., enriched with reactive agent(s). The robust gas may comprise argon or nitrogen. At least one reactive agent in the robust gas may be in a concentration below that present in the ambient atmosphere external to the gas conveyance system and/or enclosure. The reactive agent(s) may comprise water or oxygen. The robust gas (e.g., gas mixture) may be more inert than the gas present in the ambient atmosphere. The robust gas may be less reactive than the gas present in the ambient atmosphere. Less reactive may be with debris, and/or powder, e.g., during and/or after the printing. In some embodiments, humidity levels and/or oxygen levels in at least a portion of the enclosure (e.g., processing chamber, ancillary chamber, and/or build module) can be regulated such that an oxygenation and/or humidification of powder in the powder conveyance system is controlled. Oxygenation and/or humidification levels of recycled powder (e.g., recycled powder) can be about 5 parts per million (ppm) to about 1500 ppm. The gas composition of the chamber can contain a level of oxygen that is at most about 4000 parts per million (ppm), 3000 ppm, 2000 ppm, 1500 ppm, 1000 ppm, 500 ppm, 400 ppm, 100 ppm, 50 ppm, 10 ppm, or 5 ppm. The gas composition of the chamber can contain an oxygen level between any of the afore-mentioned values (e.g., from about 4000 ppm to about 5 ppm, from about 2000 ppm to about 500 ppm, from about 1500 ppm to about 500 ppm, or from 500 ppm to about 50 ppm). Oxygenation and/or humidification levels of powder can be about zero ppm. For example, oxygen content in powder can be about 0 weight percent (wt %), 0.1 wt %, 0.25 wt %, 0.3 wt %, 0.5 wt %, 0.75 wt %, 1.0 wt %, or more. At times, atmospheric conditions can, in part, influence the flowability of powder from the layer dispensing mechanism. A dew point of an internal atmosphere of an enclosure (e.g., of the processing chamber) can be (I) below a level in which the powder particles absorb water such that they become reactive under condition of 3D printing process(es) and/or sufficient to cause measurable defects in a 3D object printed from the powder particles and (II) above a level of humidity below which the powder agglomerates, (e.g., electrostatically). In some embodiments, conditions (I) and/or (II) may depend in part on a type of powder and/or on processing condition(s) of the 3D printing process(es). The gas composition of the chamber can contain a level of humidity that corresponds to a dew point of at most about −10° C., −15° C., −20° C., −25° C., −30° C., −35° C., −40° C., −50° C., −60° C., or −70° C. The gas composition of the chamber can contain a level of humidity that correspond to a dew point of between any of the aforementioned values, e.g., from about −70° C. to abokilopascals 60° C. to about −10° C. or from about −30° C. to about −20° C. A dew point of an internal atmosphere of the enclosure (e.g., of the processing chamber) can be from about −80° C. to about −30° C., from about −65° C. to about −40° C., or from about −55° C. to about −45° C., at an atmospheric pressure of at least about 10 kilo-Pascals (kPa), about 12 kPa, about 14 kPa, about 16 kPa, about 18 kPa, about 20 kPa above ambient pressure external to the enclosure. A dew point of an internal atmosphere of the enclosure can be any value within or including the afore-mentioned values. Examples of gas conveyance system and components (including control components), in-situ passivation systems, controlled oxidation methods and systems, 3D printing systems, control systems, software, and related processes, can be found in International Patent Application Serial Nos. PCT/US17/60035 and PCT/US21/35350, each of which is incorporated herein by reference in its entirety.

In some embodiments, a 3D printing system includes, or is operationally coupled with, one or more gas recycling systems. The gas recycling system can be at least a portion of the gas conveyance system. The processing chamber may include gas inlet(s) and gas outlet(s). The gas recycling system can be configured to recirculate the flow of gas from gas outlet(s) back into processing chamber via the gas inlet(s). Gas flow through a channel exiting a gas outlet can include solid and/or gaseous contaminants such as debris (e.g., soot). A filtration system can be configured to filter out at least some of the solid and/or gaseous contaminants, thereby providing a clean gas (e.g., cleaner than gas flow through channel exiting the gas outlet). The filtration system can include one or more filters. The filters may comprise physical filters or chemical filters. The clean gas exiting the filtering mechanism (also herein “filtration system”) can be under lower pressure relative to the incoming gas pressure into the filtering mechanism. The lower pressure and the pressure of the incoming gas pressure may be above ambient pressure external to the 3D printing system. The clean gas can be directed through a pump to regulate (e.g., increase) its relative pressure prior to entry to the processing chamber. Clean gas with a regulated pressure that exits the pump can be directed through one or more sensors. The one or more sensors may comprise a flow meter, which can measure the flow (e.g., pressure) of the pressurized clean gas. The one or more sensors may comprise temperature, humidity, oxygen sensors, or any other sensor disclosed herein. In some cases, the clean gas can have an ambient pressure or higher. The higher pressure may provide a positive pressure within the processing chamber (see example values of positive pressure described herein). A first portion of the clean gas can be directed through at least one inlet of a gas inlet portion of the enclosure, while a second portion of the clean gas can be directed to first and/or second window holders that provide gas purging of optical window areas, as described herein. That is, the gas recycling system can provide clean gas to provide a primary gas flow for the 3D printing system, as well as a secondary gas flow (e.g., window purging). In some embodiments, the pressurized clean gas is further filtered through a filter prior to reaching one or both of the window holders. In some embodiments, the one or more filters (e.g., as part of one or more filters and/or a filtration system) are configured to filter out particles having nanometer-scale (e.g., about 10 nm to about 500 nm) diameters. In some embodiments, the gas recycling system may provide clean gas to a recessed portion of the enclosure. In some embodiments, gas flow from the recessed portion of the enclosure can be directed through the gas recycling system. In some embodiments, gas flow from the recessed portion can be directed through one or more filters of a filtration system. In some embodiments, the gas recycling system provides clean gas directed to first and/or second window holders.

In some embodiments, the 3D printing system has various components. 3D printing system may comprise an enclosure, a gas conveyance system, an optical system, and an energy source. The enclosure may comprise a processing chamber and a build module. The processing chamber may or may not be connected to the build module. In an example, the build module is reversibly connected (e.g., during the printing) and disconnected (e.g., after the printing) from the enclosure. The 3D printing system may comprise the optical system enclosure and the energy source. The optical system enclosure may be operatively coupled with at least one energy source. The optical system enclosure comprises various components including the optical system (e.g., scanner). The optical system can translate the energy beam along a path, which the energy beam travels through the optical windows into the enclosure. The 3D printing system may comprise one or more energy beams and respective optical systems and optical windows. The enclosure (e.g., processing chamber) may comprise one or more (i) gas inlets and (ii) gas outlets. The 3D printing system may comprise the gas conveyance system. The gas conveyance system may be connected to the enclosure. One end of the gas conveyance system may be connected to the gas outlets, and the other end of the gas conveyance system may be connected to (i) the gas inlets, (ii) optical windows, and/or (iii) the optical system. The gas conveyance system may comprise various components comprising filter, gas line, discharge container, pump, gas enriching system, temperature conditioning system, or valve. Each of the components may be singular or plural. Gas egressed (e.g., expelled) from the enclosure (e.g., over pressured gas above a threshold) may be ingressed (e.g., introduced) into the filter. The filter may be configured to facilitate streaming gas with a higher degree of purity, such as a HEPA filter. Debris included in the egressed gas from the enclosure can be removed with the filter. The debris may be collected in the discharge container. The egressed gas stream from the enclosure may split and diverted to (i) the pump in the gas conveyance system and/or (ii) an exhaust location. The egressed gas from the enclosure may be (i) ingressed into the pump and/or (ii) egressed to the exhaust location. The exhaust location can comprise an ambient atmosphere or a reservoir (e.g., pressure reservoir). The pump may pressurize the gas passing through it. In an example, a portion of the filtered gas from the filter is ingressed into the pump and pressurized until the pressure of the gas conveyance system reaches its maximum. The rest of the filtered gas may be egressed to the exhaust location. The gas conveyance system may comprise one or more valves. The one or more valves may comprise valves located (i) upstream of the pump or (ii) upstream of the exhaust location. “Upstream” are based on the direction of the gas flow. The valves may control (i) the gas flow direction (e.g., to the pump and/or to the exhaust location), and/or (ii) the gas flow rate at each direction. In an example, the gas conveyance system may comprise valve(s) (e.g., an outlet valve assembly) located upstream of the exhaust location. The outlet valve assembly may comprise one or more valves, e.g., proportional valve(s) and/or discrete valves. The number of the valves of the outlet valve assembly may depend, e.g., on the pressure difference between the gas conveyance system and the exhaust location. The gas conveyance system comprises a gas enriching system. The gas enriching system may be connected in series or in parallel with the pump. The gas enriching system can enrich the gas with controlled level of a reactive agent. The reactive agent may comprise oxygen or humidity. The gas enriching system can enrich the gas with controlled level of a reactive agent. In an example, the gas enriching system comprises a humidity enriching system, e.g., enriching the gas flow with a controlled level of humidity. In an example, the gas enriching system is configured to enrich the gas flow with oxygen, e.g., with a controlled level of oxygen. One or more valves may be located (i) upstream of the gas enriching system and/or (ii) downstream of the gas enriching system. “Upstream” and “downstream” are based on the gas flow direction. The gas conveyance system may comprise a temperature conditioning system. The temperature conditioning system (e.g., cooler) may control (e.g., drop) the temperature of the gas flow.

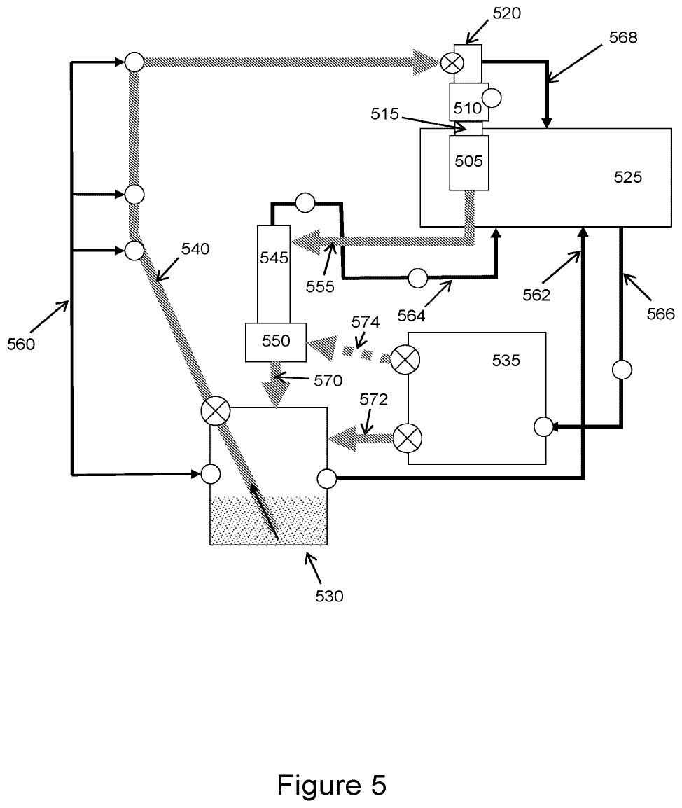

In some embodiments, the 3D printing system comprises a powder conveyance system. The powder conveyance system may be operatively coupled to a processing chamber, a build module, an ancillary chamber, a layer dispensing mechanism and/or a recycling mechanism. The one or more components of the powder conveyance system may be replaceable, exchangeable, and/or modular. FIG. 5 shows an example of a powder conveyance system coupled to a processing chamber (e.g., 525). The powder conveyance system comprises a pressure container (e.g., 530). The pressure container comprises powder. The powder may be conveyed (e.g., directly, or indirectly) into the pressure container from (i) an external material source (e.g., a bulk feed 535) and/or from (ii) a layer dispensing mechanism (e.g., 505). The layer dispensing mechanism (also referred to herein as “layer dispenser”) may be coupled with a bulk reservoir (e.g., 510) via a channel (e.g., 515). The bulk reservoir may be optionally coupled to a secondary separator (e.g., 520). The powder may be conveyed (e.g., in a first loop) from the pressure container to the secondary separator (e.g., 510) via a material conveying channel (e.g., 540). The powder conveyance system may comprise one or more material conveying channels. In some examples, the powder conveyance system may comprise a plurality of material conveying channels (e.g., including 540, 555, 570, 572, and/or 574). At least two of the plurality of material conveying channels may be of the same characteristics. The channel characteristic may comprise a material from which the channel is constructed, cross-section, flow capacity, or internal surface finish. At least two of the plurality of material conveying channels may be different in at least one of the channel characteristic. At least two of the plurality of material conveying channels may be (e.g., substantially) the same in at least one of the channel characteristic. The material conveying channel may convey powder to one or more components of the powder conveyance system. In some examples, the material conveying channel may be coupled to the bulk reservoir and/or the layer dispensing mechanism. The powder may be conveyed (e.g., in a second loop) from the layer dispensing mechanism to the pressure container. The powder conveyance system may comprise at least one separator. The separator may comprise a cyclonic-separator, a sorter, classifier, or a sieve (e.g., filter). The classifier may comprise a gas classifier (e.g., air-classifier). For example, the second loop may comprise a first separator (e.g., 545) and/or a filter (e.g., 550). The filter may sieve powder (e.g., that was not used during the 3D printing, that arrives from the bulk feed (e.g., from a supplier)) prior to conveying it to the pressure container and/or to the processing chamber (e.g., by using the material dispenser). In some examples, the filter may be operatively coupled to the bulk feed (e.g., 535) via a material conveying channel (e.g., 574). The powder from an external material source (e.g., stored in the bulk feed 535) may be filtered, prior to conveying it to the pressure container and/or to the processing chamber. The powder may be conveyed from the layer dispensing mechanism to the first separator via a material conveying channel (e.g., 555). Optionally, the separator may be operatively coupled to a buffer container. The powder may reside in the buffer container while the first loop may be in operation of conveying powder into the secondary separator. On completion of the first loop, the powder from the buffer container into the pressure container. In some examples, the buffer container may convey powder into the pressure container during the first loop. The buffer container may be inserted with powder from the external material source (e.g., a bulk feed 535). The powder conveyance system may comprise a gas conveying channel. In some examples, the powder conveyance system may comprise a plurality of gas conveying channels (e.g., that are fluidly coupled, e.g., to allow flow of the powder). The gas conveying channel may convey gas to one or more components of the powder conveyance system. The gas may comprise a pressure. The gas conveying channel may equilibrate pressure and/or content within one or more components of the powder conveyance system. For example, a gas conveying channel may equilibrate a first atmosphere of a processing chamber with a second atmosphere of the bulk feed, separator, and/or pressure chamber (in certain instances). The first atmosphere and/or second atmosphere may be a (e.g., substantially) inert, oxygen depleted, humidity depleted, organic material depleted, or any combination thereof. The gas conveying channel (e.g., 560, 562, 564, 566, and/or 568) may be operatively coupled to the material conveying channel, pressure container, processing chamber, external material source, separator, bulk reservoir, layer dispenser (e.g., material dispenser), and/or the buffer container. The channel (e.g., shaft channel, gas channel, and/or material conveyance channel may be a tube, hose, tunnel, duct, chute, or conduit). The powder conveyance system may comprise one or more valves. A valve may be coupled to a material conveying channel and/or a gas conveying channel. For example, FIG. 5 shows examples of material conveying channel valves (e.g., denoted by a white circle comprising an X) and gas conveying channel valves (e.g., denoted by a white circle).

In some embodiments, the powder conveyance system conveys the powder against gravity. The powder conveyance can be a gas borne conveyance, also referred to herein as dilute gas conveyance. The powder conveyance can be a dense phase conveyance. The dilute phase conveyance can convey the powder continuously, semi continuously, or intermittently. Semi-continuous conveyance refers to conveyance of (e.g., new) powder when there is a powder loss and/or degradation. Semi continuous conveyance may be referred to in “just in time conveyance.” Semi continuous conveyance may react to real time powder loss in the system, e.g., as the powder loss is detected by the control system, e.g., by the one or more sensors measuring the powder level. The dense phase conveyance can convey the powder intermittently or semi continuously, e.g., as packets or pellets of dense powder pressed forward by pressurized gas. The dilute phase conveyance may use gas at a pressure comprising pressure below ambient pressure, (e.g., substantially) at ambient pressure, or above ambient pressure. In an example, the dilute gas conveyance conveys the powder at a pressure above ambient pressure. The powder conveyance system can convey the powder along pressure differential, e.g., and against gravitational force of the ambient environment. The dense phase conveyance may require less gas to convey a mass of the powder as compared to the dilute phase conveyance. Less gas can be by at least about 1, 2, or 3 orders of magnitude less gas to convey a unit mass of powder. In an example, the dense phase conveyance requires 10 grams of gas (e.g., robust gas such as Argon) to convey 1000 grams of powder (e.g., metallic powder). In an example, the dilute phase conveyance requires between about 3000 grams to about 100 grams of gas to convey the 1000 grams of powder (e.g., metallic powder). In the dense phase conveyance, the mass of powder is pushed by the gas. In the dilute phase conveyance, the mass of powder is carried (e.g., gas borne) by the gas. The powder conveyance system may comprise gravitational conveyance, dense phase conveyance, dilute phase conveyance, or any combination thereof. A first portion of the powder conveyance system may comprise gravitational conveyance. A second portion of the powder conveyance system may comprise dense phase conveyance. A third portion of the powder conveyance system may comprise dilute phase conveyance.

In some examples, the powder conveyance system comprises a (e.g., optional) separator. The powder conveyance system may comprise a plurality of separators. The separator may be exchangeable, replaceable, and/or modular. The separator may separate between a gas and a powder. The separator may separate between various sizes (or size groups) of particulate material. The separator may separate between various types of material. The separator may comprise separation, sorting, and/or reconditioning the powder. The separator may comprise a cyclonic separator, velocity reduction separator (e.g., screen, mesh, and/or baffle), and/or a separation column. The separator may utilize a gravitational force. The separator may utilize an artificially induced force (e.g., pneumatic, electronic, magnetic, hydraulic, and/or electrostatic force). The cyclonic separator may comprise using vortex separation. The cyclonic separator may comprise using centrifugal separation. Examples of separators, 3D printers, related control system, related methods, apparatuses, systems, and program instructions (e.g., software), can be found in U.S. patent application Ser. No. 15/374,318, filed on Dec. 9, 2016, titled “SKILLFUL THREE-DIMENSIONAL PRINTING,” and in international patent application serial number PCT/US16/66000, filed on Dec. 9, 2016, titled “SKILLFUL THREE-DIMENSIONAL PRINTING,” each of which is entirely incorporated herein by reference. The separator may comprise a filter (e.g., sieve, column, and/or membrane). The separation may comprise separating the powder from debris and/or gas. The powder may be sorted as to material type and/or size. The powder may be sorted using a gas classifier that classifies gas-borne material (e.g., liquid, or particulate) material. For example, using an air-classifier. For example, using a powder gas classifier. The reconditioning may comprise removing of an oxide layer forming on the powder. Reconditioning may comprise physical and/or chemical reconditioning. The physical reconditioning may comprise ablation, spattering, blasting, or machining. The chemical reconditioning may comprise reduction. The separator and/or filter may be controlled. The controlling may be done manually and/or automated. Controlling may be performed before, after, and/or during at least a portion of the 3D printing. Controlling may be performed during, before and/or after the operation of the powder conveyance system. The separator may comprise a sensor. The sensor may detect a system state of the separator. The sensor may detect the velocity of the powder and/or gas during operation. In some examples, a plurality of separators may be operatively coupled to each other. A first separator may be connected to a second separator (e.g., in a serial manner). The separator may be optimized to operate with different types of material flow and/or pneumatic flows. For example, the separator may be optimized to operate with a number of powder properties (e.g., particulate material size, material type, FLS of a particulate material, and/or particulate material shape). The separator may be optimized to operate with a number of material (e.g., powder) flow properties (e.g., material density and/or material friction).

In some embodiments, an amount of material recycled by a recycling system (e.g., and by any of its components) is greater than an amount of material that remains in the powder bed. The material that remains in the powder bed may be that which remains following removal of excess material after dispensing the material. The material recycled may be excess material. The excess material may be removed (e.g., following a dispensing operation) to the recycling system by a leveling mechanism (e.g., a blade and/or a vacuum). For example, the amount of material recycled for a given deposited material layer may be greater than the amount of material that forms the given layer (e.g., that remains in the powder bed). For example, the amount of material recycled (e.g., by the recycling system or any of its components) during formation of a 3D object may be greater than the amount of material deposited within a powder bed during the formation of the 3D object. In some embodiments, the amount of material recycled by the recycling system (e.g., and by any of its components) may be a majority of the material dispensed (e.g., by a material dispenser). For example, the amount of material recycled may be at least about 51%, 60%, 70%, 80%, 85%, 90%, 95%, or 98% of the material dispensed by the material dispenser. The amount of material recycled may be any value within a range of the aforementioned values (e.g., from 51% to 98%, from 51% to 70%, or from 70% to 98%). The aforementioned (e.g., percentage) amount of recycled material may refer to a volume of material. The afore-mentioned (e.g., percentage) amount of recycled material may refer to a relative height of material (e.g., on the powder bed). The recycling system may be configured to recycle at least about 50 kilograms (kg), 100 kg, 200 kg, 500 kg, 1000 kg, 5000 kg, or 10000 kg of material during the printing (e.g., during a printing cycle) and/or before the cartridge requires a change, e.g., without exchanging the filter. The recycling system (e.g., and by any of its components) may be configured to support these recycling characteristics.

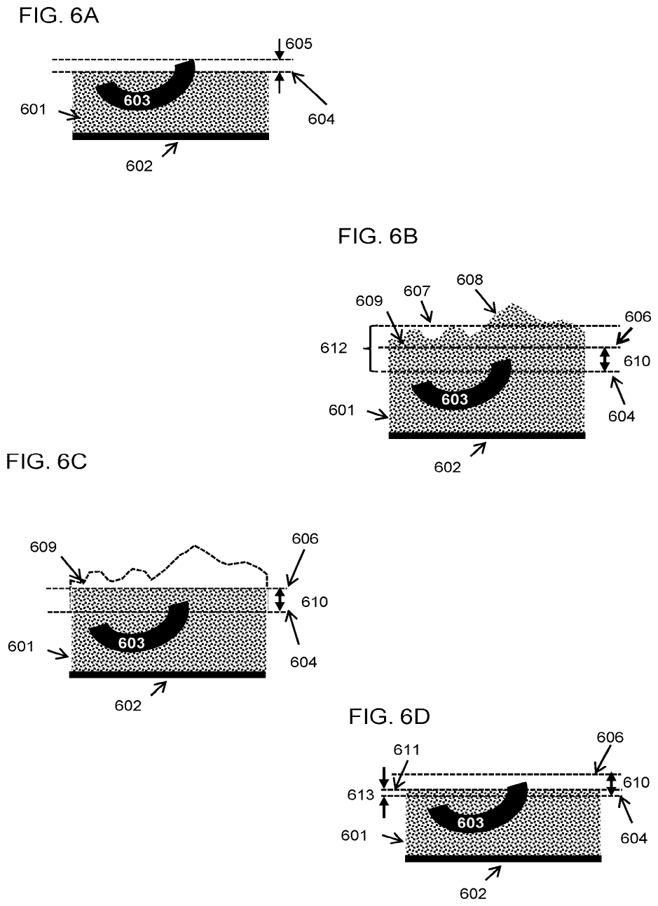

At times, the height of material is with respect to a height over a prior-formed material layer (e.g., having an exposed surface such as in FIG. 6A, 604). For example, material (e.g., FIG. 6B, 608) may be deposited (e.g., by the dispenser) to have an average height of at least about 750 μm, 850 μm, 950 μm or 1000 μm above a prior-formed material layer. FIG. 6B depicts an example of a plane 607 that is situated at the average height 612 of the material that is deposited above the prior-formed material layer plane 604. The material may be deposited to have an average height of any value within a range of the aforementioned values (e.g., from about 750 μm to about 1000 μm, from about 750 μm to about 850 μm, or from 850 μm to about 1000 μm). The material recycling may be such as to have a remaining material height (e.g., FIG. 6D, 613) above the prior-formed layer of at least about 30 μm, 40 μm, 50 μm, 60 μm, 70 μm, or 80 μm. The remaining height above the prior-formed layer may be any value within a range of the aforementioned values (e.g., from about 30 μm to about 80 μm, from about 30 μm to about 50 μm, or from about 50 μm to about 80 μm). In some embodiments, the volume of (e.g., excess) material recycled is at least about a factor of about 5, 8, 10, 15, 20, or 25 times greater than a volume of material that remains in the powder bed (e.g., that forms material layers in the powder bed). The volume of recycled material may be any value within a range of the aforementioned values (e.g., from 5 to 25, from 5 to 15, or from 15 to 25). The recycling system may recycle the material continuously. The recycling system may recycle the material periodically (e.g., at predetermined times).

FIGS. 6A-D show examples of various stages of a layering method described herein. FIG. 6A shows a powder bed 601 in which a (bent) 3D object 603 is suspended in the powder bed and is protruding from the exposed (top) surface of the powder bed by a distance 605. The exposed surface of the powder bed can be leveled (e.g., as shown in FIG. 6A, having a leveled plane 604), or not leveled. FIG. 6B shows a succeeding operation where a layer is deposited in the powder bed (e.g., above the plane 604). The newly deposited layer may not have a planarized (e.g., leveled) top surface (e.g., 608). The non-planar top (e.g., exposed) surface 608 includes a lowest vertical point 609. The plane 606 is a plane that is situated at or below the lowest vertical point of the non-planar surface, and at or above the protruding height 605. The plane 606 is located higher than the top surface 604 by a height 610. FIG. 6C shows a succeeding operation where the layer is leveled to the vertical position of the plane 606 by a leveling mechanism (e.g., FIG. 1, 117). That planarization can comprise shearing of the powder. That planarization may not displace the excess of powder to a different position in the powder bed. FIG. 6D shows a succeeding operation where the planar layer is leveled to a lower vertical plane level that is above 604 and below 606, and is designated as 611. This second planarization operation may be conducted by the powder removal mechanism (e.g., FIG. 1, 118), which may or may not contact the exposed layer of the powder bed. This second planarization operation may or may not expose the protruding object. This second planarization operation may be a higher fidelity planarization operation. The average vertical distance from the first top surface to the second planar surface can be at least about 5 μm, 10 μm, 50 μm, 100 μm, 150 μm, 200 μm, 250 μm, 300 μm, 350 μm, 400 μm, 450 μm, or 500 μm. The average vertical distance from the first top surface to the second planar surface can be at most about 700 μm, 500 μm, 450 μm, 400 μm, 350 μm, 300 μm, 250 μm, 200 μm, 150 μm, 100 μm, 50 μm, 10 μm, or 5 μm. The average vertical distance from the first top surface to the second planar surface can be any of the afore-mentioned average vertical distance values. The average vertical distance from the first top surface to the second planar surface can be from about 5 μm to about 500 μm, from about 10 μm to about 100 μm, from about 20 μm to about 300 μm, or from about 25 μm to about 250 μm. The average vertical distance from the first top surface to the second top surface can be at least about 5 μm, 10 μm, 50 μm, 100 μm, 150 μm, 200 μm, 250 μm, 300 μm, 350 μm, 400 μm, 450 μm, 500 μm, 1000 μm, or 1500 μm. The average vertical distance from the first top surface to the second top surface can be at most about 2000 μm, 1500 μm, 1000 μm, 700 μm, 500 μm, 450 μm, 400 μm, 350 μm, 300 μm, 250 μm, 200 μm, 150 μm, 100 μm, 50 μm, 10 μm, or 5 μm. The average vertical distance from the first top surface to the second top surface can be any of the afore-mentioned average vertical distance values. For example, the average vertical distance from the first top surface to the second top surface can be from about 5 μm to about 2000 μm, from about 50 μm to about 1500 μm, from about 100 μm to about 1000 μm, or from about 200 μm to about 500 μm.

At times, the powder conveyance system comprises a gas that carries material to a (e.g., cyclonic) separator. The separator may separate the gas from a material, e.g., a solid material and/or a particulate material. The material carried by the gas may be transported via a channel (e.g., in a dilute conveyance phase). The material may comprise powder and/or debris e.g., spatter, slag, soot, and/or or fused particles that do not form a 3D object. The cyclonic separator may be configured to separate (e.g., at least a portion of) the material from the gas. For example, a cyclonic separator may be configured to separate (e.g., remove) material having at least a characteristic (e.g., separation) size. In some embodiments, particles of material having at least a characteristic (e.g., separation) FLS are removed from the incoming gas flow within the cyclonic separator. For example, a characteristic separation FLS for a particle of material to be separated from the gas flow within a cyclonic separator may be at least about 10 micron (μm), 15 μm, 20 μm, 50 μm, 100 μm, or 500 μm. The characteristic separation FLS for a cyclonic separator may be any value within a range of the aforementioned values (e.g., from about 10 μm to about 500 μm, from about 10 μm to about 100 μm, or from about 100 μm to about 500 μm). In some embodiments, a plurality of (e.g., cyclone) separators may separate the material from the gas. For example, the first separator may separate bulkier material (having a first maximal or average FLS), and the second separator may separate the final material (having a second maximal or average FLS that is smaller than the first maximal or average FLS respectively).

At times, a gas flow exiting the cyclonic separator comprises remaining material (e.g., that was not removed). For example, soot particles may remain in the gas flow following the (e.g., first) separation of the material from the gas flow. The exiting gas may comprise a remaining material including particles of a fundamental length scale (FLS) of at most about 0.1 μm, 0.5 μm, 1 μm, 2 μm, 5 μm, 8 μm or 10 μm. The remaining material particle FLS may be any value within a range of the aforementioned values (e.g., from about 0.1 μm to about 10 μm, from about 0.1 μm to about 5 μm, or from 5 μm to about 10 μm). The gas exiting the cyclonic separator may undergo a second cyclonic separation. The gas exiting the (e.g., first and/or second) cyclonic separator may be passed through a filter (e.g., scrubbed) to remove any remaining (e.g., fine) material. The filter may be a ventilation filter. The ventilation filter may capture fine particles (e.g., soot and/or powder) from the 3D printing system. The filter may comprise a paper, glass (e.g., fiber), carbon (e.g., fiber), metal (e.g., fiber), High Density Polyethylene, or polyethersulfone (PES) filter. The filter may comprise carbon black, glass, or glass fiber. The filter may be a membrane filter. The filter may comprise a high-efficiency particulate arrestance (HEPA) filter (a.k.a., high-efficiency particulate arresting or high-efficiency particulate air filter). The gas exiting the cyclonic separator may be provided (i) to another portion of the 3D printing system (e.g., to the processing chamber, to a pressure container), and/or (ii) to an unpacking station (e.g., unpacking chamber).

In some embodiments, an operation of the separator comprises a vortex separation (e.g., using a cyclone). For example, the operation of the cyclonic separator can comprise a centrifugal separation (e.g., using a cyclone). In some embodiments, an internal compartment of a separator comprises a cyclone. The operation of the cyclonic separator can comprise gravitational separation. The operation of the cyclonic separator can comprise rotation of the (e.g., powder) material and/or debris (e.g., in the internal compartment of the separator). The separator may be configured to separate gas borne particulates based on their (e.g., average) FLS. In some embodiments, particles of the material having the separation FLS are attracted to and/or thrusted to a wall of the cyclonic separator. The particles attracted to, and/or thrusted to the wall may be removed from the flow of gas that carried the material into the cyclonic separator (e.g., via a removal mechanism). The particles removed from the flow of gas may rest at a position configured to collect the particulate material upon separation, e.g., (i) a depression (e.g., crevice) at a wall of the separator or (ii) the bottom of the internal compartment of the cyclonic separator. Bottom may be towards the gravitational center, and/or towards a target surface. In some embodiments, the removed particles of material may be provided to (e.g., an inlet of) a further separation assembly (e.g., a sieve assembly).

In some embodiments, the flow of gas for carrying the material into the cyclonic separator is generated by a force source, e.g., a vacuum source, a pump, and/or a blower such as a fan. The material carried by the flow of gas may be transported into the internal compartment of the cyclonic separator from: (i) a powder bed (e.g., of the processing chamber), (ii) a pressure container, (iii) an unpacking chamber, and/or (iv) a source of new (e.g., powder) material. The force source may be (e.g., fluidly) coupled with the internal compartment of the cyclonic separator and/or sieve. The gas(es) forced with the carried material into the internal compartment of the cyclonic separator may rotate within at a rotational speed to form a cyclone. The internal compartment may comprise a cone having its long axis perpendicular to the target surface and/or its narrow end pointing towards the target surface. The internal compartment may comprise a cone having its long axis perpendicular to a gravitational field vector and/or its narrow end pointing towards a gravitational field vector. Alternatively, the internal compartment may comprise a cone having its long axis parallel to the target surface and/or the gravitational field vector, and/or its narrow end pointing towards a side wall of the enclosure. The gas may flow in the internal compartment in a helical pattern along the long axis of the cyclone. During an operation of the cyclonic separator, the material moved into the cyclone may concentrate at the walls of the cyclone and gravitate to and accumulate at the depression in the wall of the separator (configured to collect the separating) and/or at the separator's bottom. The accumulated (e.g., powder and/or debris) material may be removed from the collection area. The accumulated material may be provided to a subsequent separator. In some embodiments, the material collecting at the walls travels to a second separator (e.g., a subsequent cyclone or a sieve assembly). In some embodiments, a subsequent separator comprises a sieve assembly. In some examples, the material that enters the internal compartment of the cyclonic separator is of a first velocity, and is attracted towards the force source. On its way to the force source, the material may lose its velocity in the internal compartment and precipitate toward the bottom of the cyclone and/or towards the collection area. In some examples, the gas that enters the internal compartment of the cyclonic separator is of a first velocity, and is attracted towards the force source (e.g., pump). On its way to the connector, the gas may lose its velocity in the internal compartment, for example, due to an expansion of the cross section of the internal compartments. In some embodiments an obstruction may be placed to exacerbate a volume difference between portions of the cyclone that are closer to the exit opening relative to those further from the exit opening.

At times, the separation and subsequent filtration of the material from the gas flow is performed at predetermined times. For example, after one or more operations of planarizing a layer of powder in the powder bed, the cyclone may separate (e.g., powder and/or debris) material from a gas flow. For example, the exiting gas from the cyclonic separator may be filtered (e.g., scrubbed) of any remaining (e.g., soot) particles. Filtration of the exiting gas from the cyclonic separator may occur prior to introduction of the gas into a remaining portion of the 3D printing system (e.g., a processing chamber, an unpacking chamber). In some embodiments, the separation and subsequent filtration of the material from the gas flow is performed (e.g., substantially) continuously (e.g., in real time during at least part of the 3D printing, for example during transformation and/or during operation of the material conveyance system).

At times, the powder conveyance system comprises at least two (e.g., cyclonic) separators. In some embodiments, at least two cyclonic separators may be arranged in parallel. For example, a channel comprising a gas carrying material may be an input for at least two cyclonic separators. In some embodiments, at least two cyclonic separators may be arranged in series. For example, a gas exiting from a first cyclonic separator may comprise an inlet gas for a subsequent cyclonic separator. In some embodiments, the gas is an inert gas. In some embodiments, a filter is disposed between an outlet of the cyclonic separator and an inlet to a (e.g., subsequent) compartment. The subsequent compartment may comprise (i) an internal compartment of a (e.g., subsequent) cyclonic separator, (ii) a processing chamber, (iii) a pressure container, and/or (iv) an unpacking chamber. In some embodiments, a plurality of filters is disposed between the outlet of the cyclonic separator and the inlet of the subsequent compartment. In some embodiments, at least two filters of the plurality of filters are configured to remove particles comprising about the same FLS. In some embodiments, at least two filters of the plurality of filters are configured to remove particles comprising a different FLS (e.g., soot from powder). In some embodiments, one or more force sources are disposed between the filter(s) and the subsequent compartment(s). In some embodiments, one or more force sources are disposed between a compartment comprising the carried material and a cyclonic separator. The force sources may be any force source disclosed herein (e.g., a pump, or a blower).

At times, a 3D printing cycle corresponds with (i) depositing a (planar) layer of powder (e.g., as part of a powder bed) above a platform, and (ii) transforming at least a portion of the powder to form one or more 3D objects above the platform (e.g., in the powder bed). The depositing in (i) and the transforming in (ii) may comprise a print increment. At times, the platform supports a plurality of material (e.g., powder) beds. One or more 3D objects may be printed in a single powder bed during a printing cycle (e.g., print job). The transformation may connect transformed material of a given layer (e.g., printing cycle) to a previously formed 3D object portion (e.g., of a previous printing cycle). The transforming operation may comprise utilizing an energy beam to transform the powder (or the transformed) material. In some instances, the energy beam is utilized to transform at least a portion of the powder bed (e.g., utilizing any of the methods described herein). During a printing cycle, the one or more objects may be printed in the same powder bed, above the same platform, with the same printing system, at the same time span, using the same printing instructions, or any combination thereof. A print cycle may comprise printing the one or more objects layer-wise (e.g., layer-by-layer). A layer may comprise a layer height. A layer height may correspond to a height of (e.g., distance between) an exposed surface of a (e.g., newly) formed layer with respect to a (e.g., top) surface of a prior-formed layer. In some embodiments, the layer height is (e.g., substantially) the same for each layer of a print cycle within a powder bed. In some embodiments, at least two layers of a print cycle within a powder bed have different layer heights. A printing cycle may comprise a collection (e.g., sum) of print increments (e.g., deposition of a layer and transformation of a portion thereof to form at least part of the 3D object). A build cycle may comprise one or more build laps (e.g., the process of forming a printed incremental layer,

At times, (e.g., powder) material is added to the 3D printing system during the 3D printing operation. In some embodiments, the material may be added (e.g., from a bulk reservoir) to the 3D printing system without interruption of at least a portion of the 3D printing. Without interruption may refer to introduction of one or more materials to an environment of the 3D printing system. For example, with minimal introduction of (e.g., ambient air) a reactive agent to an (e.g., any) enclosed portion of the 3D printing system. The reactive agent may be a gas or may be gas borne. The reactive agent may comprise water, hydrogen sulfide, or oxygen. The reactive agent may react with the transformed material (e.g., during and/or after its transformation). Interruption may be regarding at least one process of the 3D printing system (e.g., formation of at least a portion of a 3D object). In some embodiments, the 3D printing system is able to print a plurality of objects without interruption due to a powder addition operation. For example, the 3D printing system is able to print at least 1, 5, 10, 15, 50, 100, 500, or 1000 printing cycles without interruption by a powder addition operation. The 3D printing system may uninterruptedly print any number of printing cycles within a range of the aforementioned number of printing cycles (e.g., from about 1 to about 1000 cycles, from about 1 to about 500 cycles, or from about 500 to about 1000 cycles). For example, the 3D printing system is able to print (e.g., transform) at least a threshold volume of material without interruption from a powder addition operation. In some embodiments, the 3D printing system is able to transform (e.g., print) at a throughput of at least about 6 cubic centimeters of material per hour (cc/hr), 12 cc/hr, 48 cc/hr, 60 cc/hr, 120 cc/hr, 480 cc/hr, or 600 cc/hr. The 3D printing system may print at any rate within a range of the aforementioned values (e.g., from about 6 cc/hr to about 600 cc/hr, from about 6 cc/hr to about 120 cc/hr, or from about 120 cc/hr to about 600 cc/hr). In some embodiments, the 3D printing system can operate (e.g., continuously) without interruption for a period of time of at least about 6 hours (hr), 8 hr, 12 hr, 16 hr, 24 hr, 2 days, 7 days, 15 days, or 1 month. The 3D printing system may operate without interruption for any period of time within a range of the aforementioned values (e.g., from about 6 hr to about 1 month, from about 6 hr to about 15 days, or from 15 days to about 1 month). In some embodiments, at least two powder addition operations may be performed without interruption of the 3D printing system.

In some embodiments, a reservoir containing new powder (e.g., reversibly) couples with a component of the 3D printing system. The reservoir may be a buffer reservoir, a bulk reservoir, or any other reservoir disclosed herein. A (e.g., target) component with which the reservoir couples (e.g., to add powder) may be (i) a pressure container, (ii) a (e.g., cyclonic) separator, (iii) a sieve assembly, or (iv) any combination thereof. The reservoir may engage with the (e.g., target) component by a channel. The channel may facilitate coupling and/or fluidic connection of the reservoir. Fluidic connection may refer to a flow of a material (e.g., in any material phase). The channel may comprise a gas flow. In some embodiments, powder is moved from the reservoir to the target component, e.g., by a dense phase conveyance, gravitational conveyance, or dilute phase conveyance. In some embodiments, powder is moved from the reservoir to the target component in a dilute phase conveyance. In some embodiments, the reservoir is configured to couple with at least two target components. In some embodiments, the reservoir is configured to couple with the at least two target components (e.g., substantially) simultaneously. In some embodiments, the reservoir is configured to couple with the at least two target components at alternating times. The insertion of the powder into the component(s) may be controlled. Control may comprise using one or more valves. The valves may be any valve disclosed herein.

In some embodiments, powder is added (e.g., inserted) to the 3D printing system at a predetermined time. In some embodiments, powder is added to the 3D printing system in response to a determined state (e.g., a low powder level). For example, a low powder level (e.g., within a pressure container) may be determined considering data from one or more sensors disposed adjacent to or within a container. For example, a volume of material (e.g., remaining) in the 3D printing system may be determined considering a volume of powder that has been transformed (e.g., during formation of at least a portion of a 3D object).

In some embodiments, operation of a material removal mechanism comprises separating the powder (e.g., particulate material) from a gas (e.g., in which the powder is carried in). The separation can be with or without the use of one or more filters.

In some embodiments, the methods, systems, and/or the apparatus described herein may comprise at least one valve. The valve may be shut or opened according to an input from the at least one sensor, or manually. The degree of valve opening or shutting may be regulated by the control system, for example, according to at least one input from at least one sensor. The systems and/or the apparatus described herein can include one or more valves, such as throttle valves.

In some embodiments, the methods, systems, and/or the apparatus described herein comprise a motor. The motor may be controlled by the control system and/or manually. The apparatuses and/or systems described herein may include a system providing the material (e.g., powder) to the powder bed. The system for providing the powder may be controlled by the control system, or manually. The motor may connect to a system providing the material (e.g., powder) to the powder bed. The system and/or apparatus of the present invention may comprise a powder reservoir. The powder may travel from the reservoir to the system and/or apparatus disclosed herein. The powder may travel from the reservoir to the system for providing the powder to the powder bed. The motor may alter (e.g., the position of) the substrate and/or to the base. The motor may alter (e.g., the position of) the elevator. The motor may alter an opening of the enclosure (e.g., its opening or closure). The motor may be a step motor or a servomotor. The methods, systems and/or the apparatus described herein may comprise a piston. The piston may be a trunk, crosshead, slipper, or deflector piston.

In some examples, the systems and/or the apparatus described herein comprise at least one nozzle. The nozzle may be regulated according to at least one input from at least one sensor. The nozzle may be controlled automatically or manually. The controller may control the nozzle. The nozzle may include jet (e.g., gas jet) nozzle, high velocity nozzle, propelling nozzle, magnetic nozzle, spray nozzle, vacuum nozzle, or shaping nozzle (e.g., a die). The nozzle can be a convergent or a divergent nozzle. The spray nozzle may comprise an atomizer nozzle, an air-aspirating nozzle, or a swirl nozzle. The nozzle may comprise a venturi nozzle. The 3D printing system may comprise one, two, or more venturi nozzles.

In some examples, the systems and/or the apparatus described herein comprise at least one pump. The pump may be regulated according to at least one input from at least one sensor. The pump may be controlled automatically or manually. The controller may control the pump. The one or more pumps may comprise a positive displacement pump. The positive displacement pump may comprise rotary-type positive displacement pump, reciprocating-type positive displacement pump, or linear-type positive displacement pump. The positive displacement pump may comprise rotary lobe pump, progressive cavity pump, rotary gear pump, piston pump, diaphragm pump, screw pump, gear pump, hydraulic pump, rotary vane pump, regenerative (peripheral) pump, peristaltic pump, rope pump or flexible impeller. Rotary positive displacement pump may comprise gear pump, screw pump, or rotary vane pump. The reciprocating pump comprises plunger pump, diaphragm pump, piston pumps displacement pumps, or radial piston pump. The pump may comprise a valve-less pump, steam pump, gravity pump, eductor-jet pump, mixed-flow pump, bellow pump, axial-flow pumps, radial-flow pump, velocity pump, hydraulic ram pump, impulse pump, rope pump, compressed-air-powered double-diaphragm pump, triplex-style plunger pump, plunger pump, peristaltic pump, roots-type pumps, progressing cavity pump, screw pump, or gear pump. In some examples, the systems and/or the apparatus described herein include one or more vacuum pumps selected from mechanical pumps, rotary vain pumps, turbomolecular pumps, ion pumps, cryopumps, and diffusion pumps. The one or more vacuum pumps may comprise Rotary vane pump, diaphragm pump, liquid ring pump, piston pump, scroll pump, screw pump, Wankel pump, external vane pump, roots blower, multistage Roots pump, Toepler pump, or Lobe pump. The one or more vacuum pumps may comprise momentum transfer pump, regenerative pump, entrapment pump, Venturi vacuum pump, or team ejector.

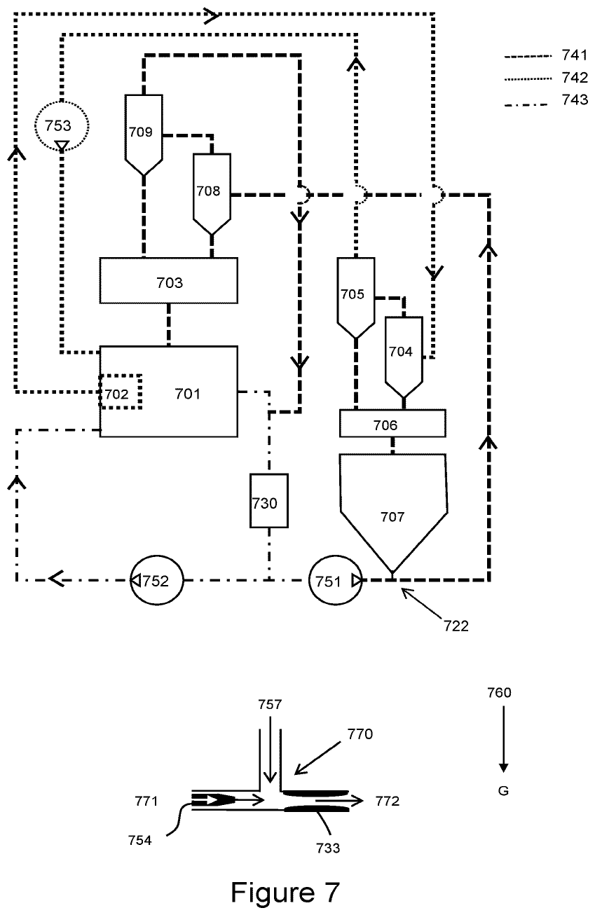

FIG. 7 shows an example of a 3D printing system comprising a powder conveyor system coupled to a processing chamber 701, having a layer dispensing mechanism (e.g., recoater) 702. Powder from a reservoir (e.g., hopper) 703 can be introduced into the layer dispensing mechanism 702. The layer dispensing mechanism is disposed in processing chamber 701. Once the layer dispensing mechanism dispensers a layer of powder to layerwise form a powder bed utilized for the three-dimensional printing. In this process (e.g., as illustrated in FIGS. 6A-D), excess powder is attracted away from the powder bed using layer dispensing mechanism 702 and introduced into separator (e.g., cyclone) 704, and optionally to overflow separator (e.g., cyclone) 702. The powder undergoes separation (e.g., cyclonic separation) in separators 705 and optionally 705, and is introduced into sieve 706, followed by gravitational flow into a lower reservoir (e.g., hopper) 707. The separated and sieved powder is then delivered into separator (e.g., cyclone) 708 and optional separator (e.g., cyclone) 709, and into reservoir 703 that delivers the powder back into layer dispensing mechanism 702. FIG. 7 shows examples of pumps (e.g., displacement pump and/or compressor) 751, 752, 753, and a temperature regulator (e.g., heater or radiator such as a radiant panel). Arrows in FIG. 7 depict direction of flow. In the channels facilitating the flow of the powder, a venturi nozzle is introduced near junction 722 to facilitate suction of the powder from reservoir 707 into separator 708. A magnified view of junction 722 is shown in 770, depicting venturi nozzle 733 that is introduced in a channel opposing a gas inlet 754 and normal to an inlet 757 from which the powder descends gravitationally towards gravitational center G along vector 760. Gas and/or material flows from direction 771 to junction 770, from inlet 757 to junction 770, and from junction 770 to outlet 772. The conveyance system can include a condensed gas source (e.g., a blower or a cylinder of condensed gas) not shown. When the powder descends towards junction 722 from reservoir (e.g., hopper) 707. The powder is conveyed from junction 722 to separator 708. The conveyance system may include a heat exchanger. The conveyance system may include one or more filters. The conveyance system may operate at a positive pressure above ambient pressure external to the conveyance system (e.g., above about one atmosphere). In some embodiments, separator 709 is coupled to sieve 706 instead of to reservoir 703.

FIG. 7 shows an example of at least a portion of a gas circulation system (e.g., also referred to herein as a “gas conveyance system”) including channel marked with dotted line 743, pumps 752 and 751, and filter 730. FIG. 7 shows an example of a first portion of a material conveyance system including channels marked with dotted line 742 that convey material to and from the layer dispensing mechanism 702 (e.g., recoater). FIG. 7 shows an example of a second portion of a material conveyance system including channels marked with dotted line 741 that convey material in other portions of the material conveyance system, other than to and from the layer dispensing mechanism 702. The gas circulating system may be configured to circulate (e.g., and recirculate) gas also in the processing chamber (e.g., 701). The gas circulating system may sweep debris (e.g., soot) away from the process area in which the 3D object is being printed. The debris may collect on a filter (e.g., 730), after which a cleaner gas is sent back (e.g., using a pump) through the channels of the gas circulation system (e.g., marked with dotted line 743) to the processing chamber. In some embodiments, the 3D printer comprises one or more temperature adjusters (e.g., heat exchangers). For example, temperature adjusters operatively coupled to the gas circulation channel between pumps 752 and 701. For example, temperature adjusters operatively coupled to the material conveyance channel between pump 751 and reservoir 707. In some embodiments, the conveyance system of the powder is in positive pressure above ambient pressure outside of the conveyance system and/or outside of the 3D printer. For example, the pressure in the 3D printer may be at least about 3 kilo Pascal (kPa), 5 kPa, 8 kPa, 10 kPa, 12 kPa, 14 kPa, 16 kPa, 18 kPa, or 20 kPa, above ambient pressure external to the 3D printer (e.g., above atmospheric pressure such as above ˜101 KPa). At times, a pressure differential is required to convey powder from one compartment of the 3D printer to another. The pressure differential may be established via pressurizing or vacuuming one or more compartments. For example, powder from the layer dispensing system to the recycling system (e.g., including the separator(s), sieve(s), and/or reservoirs) may be conveyed using (a) induced pressure differential among components, (b) pressure isolation of the components, and (c) induced pressure equilibration of components.

In some embodiments, the layer dispenser comprises a material remover. The layer dispensing mechanism may comprise a material (e.g., powder) removal mechanism that comprises one or more openings. The one or more openings may be included in a nozzle. The nozzle may comprise an adjustable opening (e.g., controlled by a controller). The height of the nozzle opening relative to the exposed surface of the powder bed may be adjustable (e.g., controlled by a controller). The material removal mechanism may comprise a reservoir in which the material may at least temporarily accumulate. The evacuated material may comprise a powder that is evacuated by the material removal mechanism. The evacuated material may comprise a transformed material that did not form the 3D object and/or debris. The debris may be generated during the 3D printing process. The nozzle may comprise an adjustable opening (e.g., controlled by a controller). The height of the nozzle opening relative to the target surface of the powder bed may be adjustable (e.g., controlled by a controller). The material removal mechanism may comprise a reservoir in which the material (that is evacuated by the material removal mechanism) may at least temporarily accumulate. Control may include regulate and/or direct. The adjustment may comprise manual and/or automatic adjustment (e.g., using the controller(s), such as any controller disclosed herein). The FLS of the entrance port (e.g., cross section thereof) of the material removal mechanism (e.g., nozzle diameter) may be at least about 0.1 mm, 0.4 mm, 0.7 mm, 0.9 mm, 1.1 mm, 1.3 mm, 1.5 mm, 2 mm, 2.5 mm, 3 mm, 3.5 mm, 5 mm, 7 mm, or 10 mm. The FLS of the entrance port of the material removal mechanism (e.g., nozzle diameter) may be at most about 0.1 mm, 0.4 mm, 0.7 mm, 0.9 mm, 1.1 mm, 1.3 mm, 1.5 mm, 2 mm, 2.5 mm, 3 mm, 3.5 mm, 5 mm, 7 mm, or 10 mm. The FLS of the entrance port of the material removal mechanism (e.g., nozzle diameter) may be of any value between the afore-mentioned values (e.g., from about 0.1 mm to about 7 mm, from about 0.1 mm to about 0.6 mm, from about 0.6 mm to about 0.9 mm, from about 0.9 mm to about 3 mm, or from about 3 mm to about 10 mm).

In some embodiments, the nozzle is separated from the exposed surface of the powder bed by a gap. The nozzle may comprise a nozzle of the material remover or a nozzle of the material dispenser. The gap may comprise a gas. The gap may be an atmospheric gap. The extent of the gap and/or the FLS of the entrance port (e.g., diameter) of the nozzle may be changeable (e.g., before, after, and/or during the 3D printing). For example, that change in the nozzle opening port may occur during the operation of the material removal mechanism. For example, that change may occur before the initiation of the 3D printing. For example, that change may occur during the formation of the 3D object. For example, that change may occur during the formation of a layer of hardened material. For example, that change may occur after transforming a portion of a layer of powder. For example, that change may occur before deposition a subsequent layer of powder. For example, that change may occur during the progression of the layer dispensing mechanism (e.g., of which the material removal mechanism is a part of) along the exposed surface of the powder bed. The progression may be parallel to the exposed surface of the powder bed. The progression may be a lateral progression (e.g., from one side of the powder bed to the opposite side of the powder bed). In some embodiments, the extent of the gap and/or the FLS of the entrance port (e.g., diameter) of the nozzle may be unchanged before, after, and/or during the formation of: the 3D object, layer of hardened material, transformed material, or any combination thereof. The extent of the gap and/or the FLS of the entrance port (e.g., diameter) of the nozzle may be unchanged during the formation of: the 3D object, layer of hardened material, transformed material, or any combination thereof. The vertical distance of the gap from the exposed surface of the target surface to the entrance port of the nozzle (e.g., 3312) may be at least about 0.05 mm, 0.1 mm, 0.25 mm, 0.5 mm, 1 mm, 2 mm, 3 mm, 4 mm, 5 mm, 6 mm, 7 mm, 8 mm, 9 mm, or 10 mm. The vertical distance of the gap from the exposed surface of the powder bed may be at most about 0.05 mm, 0.1 mm, 0.25 mm, 0.5 mm, 1 mm, 2 mm, 3 mm, 4 mm, 5 mm, 6 mm, 7 mm, 8 mm, 9 mm, 10 mm, or 20 mm. The vertical distance of the gap from the exposed surface of the powder bed may be any value between the afore-mentioned values (e.g., from about 0.05 mm to about 20 mm, from about 0.05 mm to about 0.5 mm, from about 0.2 mm to about 3 mm, from about 0.1 mm to about 10 mm, or from about 3 mm to about 20 mm).

At times, a temperature of the material attracted by the recoater from the powder bed changes during a material removal operation, e.g., as the material removal mechanism translates along the powder bed and removes excess of material (e.g., powder) to facilitate a (e.g., substantially) planar exposed surface of the powder bed, e.g., for usage in a 3D printing process. At times, various portions of the exposed surface of a powder bed have different temperatures. The material attracted, or to be attracted, by the material removal mechanism may be susceptible to temperature changes. The material attracted, or to be attracted, by the material removal mechanism may be susceptible to a level of humidity. For example, the material may exhibit tacky properties that are temperature and/or humidity dependent. The tacky properties may comprise the material clamping up, or aggregating. For example, when the material comprises particulate matter (e.g., powder), the powder may aggregate at certain temperature and/or humidity conditions, for example, high temperature and/or low humidity. Without wishing to be bound to theory, the aggregation in low humidity conditions may be due to static electricity. At times, using the same attractive force causes various amounts of material (of the same type) to be attracted (e.g., vacuumed) by the material removal mechanism. Without wishing to be bound to theory, this may be due to temperature dependency of tackiness (e.g., agglomeration and/or adhesion) of the material. For example, there may be a tendency to attract (e.g., vacuum) a different amount of material (e.g., powder) over hotter portion of the powder bed as compared to over a cooler portion of the powder bed, while using the same degree of attractive force. The different amount may be larger or smaller. Examples of nozzles, material removal mechanism, layer dispensers, material dispensers, flows above the powder bed, 3D printing systems, 3D printing processes, control systems, and software can be found in U.S. patent application Ser. No. 17/731,447 and international patent application serial number PCT/US16/66000, each of which is incorporated herein by reference in its entirety.

In some embodiments, the layer dispensing mechanism comprises a material remover. The material remover may comprise an entrance port configured to attract the material away from the powder bed, a cavity (e.g., internal reservoir), and an exit opening coupled to an attractive force source configured to attract the powder away from the material bed. The force source can comprise vacuum, electrostatic force, or magnetic force. The entrance opening may be an entrance opening of a nozzle coupled with the cavity. The material remover may be coupled to a mount coupled with a carriage configured to carry the material remover and translate it laterally in a back and forth movement with respect to a target surface, e.g., an exposed surface of the powder bed. The mount may be configured to couple with the layer dispensing mechanism. The mount may be configured to couple with a leveler and/or with a material dispenser.

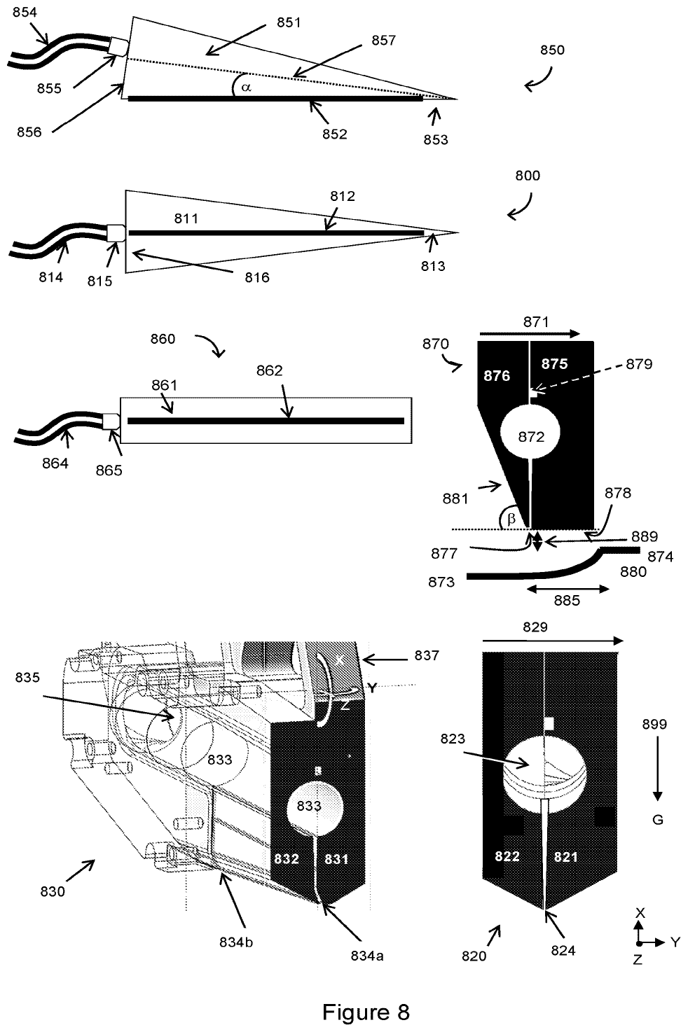

FIG. 8 schematically depict bottom views of various mechanisms for removing the powder as part of the material removal mechanism. Example 800 schematically depicts a bottom view of a material removal mechanism having an elongated material entrance port 812 and an internal compartment (e.g., cavity) having a triangular horizontal cross section 811 of the body of the material removal mechanism. Example 860 schematically depicts a bottom view of a material removal mechanism body 861 having an elongated material entrance opening port 862, the material removal mechanism being connected 865 with channel 864 through which the powder leaves the material removal mechanism. The nozzle may be a long nozzle (e.g., vacuum nozzle) in the horizontal direction, e.g., having an elongated horizontal opening. The long nozzle may be referred herein as an elongated nozzle. Example 860 shows an example of an elongated nozzle in the horizontal direction, having a horizontally elongated material entry port 862, the material remover being coupled to a channel 864 (hose) through coupler 865, e.g., connector. The channel may be connected to an attractive force (e.g., vacuum). In some examples, the nozzle spans at least a portion of the width or length of the powder bed. In some examples, the nozzle spans less than the width or length of the powder bed. The nozzle may be symmetric or asymmetric. The symmetry axis may be horizontal and/or vertical (e.g., (e.g., substantially) parallel to the platform). A cross section of the material removal member entrance port (e.g., nozzle entrance opening) may be rectangular (e.g., 862) or elliptical. A cross section of the material removal member opening port (e.g., nozzle entrance) may comprise a curvature (e.g., curved edge) or a straight line (e.g., straight edge). The FLS (e.g., width to length) of the opening port cross section may have an aspect ratio of at least 1:2, 1:10, 1:100, 1:1000, 1:1000, or 1:10000. The material removal member may comprise a connector. The connector may be to a power source, e.g., an attractive power source. The connector may be to a reservoir. The connector may be to a reservoir and to the power source. The channel may be connected to an attractive force, e.g., vacuum. The power source may be a source of gas flow (e.g., compressed gas, or vacuum), electrostatic force, and/or magnetic force. The connector may facilitate fluid connection, e.g., such that the powder may flow through the channel. The connector may allow powder, debris to flow through the channel and towards the attractive force source. The connector may allow gas to flow through. The connector may comprise connection to a channel (e.g., 864). The channel (e.g., tube) may be flexible or non-flexible. Examples of connectors are shown in 865 and 815. Examples of channels are shown in 814 and 864. In some examples, the material removal member comprises an internal compartment. The internal compartment may be a powder collection compartment. For example, the internal compartment may be a powder collection compartment, or a liquid collection compartment. The internal compartment may connect (e.g., fluidly connect) to the power source (e.g., through the connector and the channel). The internal compartment may comprise the connector. FIG. 8, 860 shows an example of a connector 865. The internal compartment may connect (e.g., fluidly) to the one or more nozzles. The internal compartment may connect (e.g., fluidly) to the one or more nozzles and to the power source and/or reservoir. The internal compartment may be symmetric or asymmetric. The symmetry or asymmetry may be in the horizontal and/or vertical direction. The internal compartment may comprise the shape of a cylinder, cone, box, ellipsoid, egg, or a spiral. The cross section (e.g., horizontal and/or vertical) may comprise the shape of a triangle (e.g., 811, and 851), ellipse, rectangle (e.g., 861), parallelogram, trapezoid, egg cross section, spiral cross section, star, sickle, or crescent. The cross section (e.g., horizontal and/or vertical) may comprise a concave shape or a convex shape. During operation, the long axis of the internal compartment may be (e.g., substantially) parallel to the platform. During operation, the long axis of the internal compartment may be disposed at an angle relative to the platform. The angle may be at most about 50°, 40°, 30°, 20°, 10°, or 5°. The angle may be between any of the aforementioned angles. The angle may be configured to allow expansion of the cavity to facilitate homogenous attraction of the powder from the powder bed into the nozzle. During operation, a short axis of the internal compartment may be (e.g., substantially) perpendicular to the platform. The internal compartment may comprise a curvature. The internal compartment may comprise a curved plane. The internal compartment may comprise a planar (e.g., non-curved, or flat) plane. A horizontal cross section of the internal compartment may be symmetric (e.g., a rectangle) or asymmetric (e.g., a triangle). The internal compartment may be wider (e.g., 816) towards the connector (e.g., 815). The internal compartment may be narrower (e.g., 813) away from the connector. The shape of the internal compartment may allow substantial uniform removal (e.g., suction) of the powder by the nozzle(s) of the material removal member along its horizontal span. The internal shape of the internal compartment may narrow towards a distant position from the connector. The narrowing may be gradual or non-gradual. The narrowing may be linear, logarithmic, or exponential. The internal compartment of the material removal member may have a shape that allows movement of the powder within the compartment. The movement of the powder within the compartment may comprise laminar or curved movement. The curved movement may comprise a spiraling movement. The curved movement may comprise a helical movement. The internal compartment may have an internal shape of a helix, spiral, or screw. The screw may be a narrowing screw, a cylindrical screw, or any combination thereof (e.g., a household type screw, or an Archimedean screw). Viewed from below, the opening port of the nozzle may horizontally overlap the internal compartment (e.g., centered below as shown for example in FIG. 8, 860), or not overlap. In some embodiments, the opening port of the nozzle is horizontally separated from the internal compartment by a gap. The power source, reservoir, and/or internal compartment may be stationary or translational with respect to the powder bed. The material removal mechanism (or any of its components) may translate relative to the powder bed. For example, the material removal mechanism may be stationary, and the powder bed may be translating. For example, the material removal mechanism may translate, and the powder bed may be stationary. For example, both the material removal mechanism and the powder bed may be translating (e.g., in the same direction, in opposite directions and/or at different speeds).

FIG. 8 shows in example 850 a schematic vertical cross section of a material remover having an internal compartment (e.g., cavity) having a triangular vertical cross section 851 of the body of the material removal mechanism, an entrance port 852, a coupler 855, and a channel 854. Body 851 has an internal compartment (e.g., cavity) having a long axis 857 that is tilted by angle alpha (α) relative to the entrance opening that is horizontal, e.g., during operation.

In some embodiments, the material removal mechanism comprises an elongated material entrance channel, and an internal compartment having a tapered internal cavity, e.g., having diminished volume along the elongated material entrance port. The material removal mechanism may be configured to attract (e.g., vacuum) a remainder of material (e.g., powder) dispensed to form a powder bed. The material removal mechanism may be mounted to a mount. The mount may comprise triangular supports. The material removal mechanism may be a part of a layer dispensing mechanism (e.g., a recoater). The cavity may have an exit opening (e.g., exit port) (e.g., a hole) through which attracted material exits the cavity. The exit port) may be on a side of the cavity, or along the long axis of the cavity. The cavity may have a long axis having a first end and an opposing second end. The exit port may be close, or at, the first end of the cavity. The tapered cavity can be linearly or non-linearly tapered. The tapered cavity can be evenly or non-evenly tapered. In some embodiments, the material removal mechanism is configured to case of manufacture, assembly, and/or functional optimization. The material removal mechanism may be formed from one integral portion, two integral portion, three integral portion, or more integral portion. Each integral portion may be a single piece of material (e.g., comprising elemental metal, metal alloy, ceramic, or an allotrope of elemental carbon). The integral piece may be molded, machined, or 3D printed. The integral portion may facilitate one or more functionalities of the material removal mechanism. For example, the integral portion may comprise a portion of an internal cavity and a portion of a nozzle. For example, the integral portion may comprise a portion of an internal cavity, a portion of a nozzle, and at least a portion of a mounting piece (e.g., a mount). A sealant may be disposed in at least one of the integral portions to facilitate tight connection and/or hinder spillage of material attracted through the material removal mechanism (e.g., through the nozzle, cavity, and material exit port). The seal may comprise a flexible material. The seal may comprise a solid-to-solid tight seal. At least two of the portions of the material removal mechanism may be coupled using one or more fasteners (e.g., screws or clips).

FIG. 8 shows in a vertical cross-sectional example and internal view of a material removal mechanism 820 having a nozzle looking into cavity 823 to its far second side. In the example shown material removal mechanism 820, two side 821 and 822 of the nozzle of the material removal system form a material entrance channel ending in tip 824 that includes the entrance port, which material entrance channel has a straight vertical cross section (e.g., is devoid of a curvature or an angle). Side 821 is a tailing edge of the nozzle, and 822 is a leading edge of the nozzle, with respect to the direction of movement 829 of the material removal mechanism.

FIG. 8 shows a perspective and vertical cross-sectional example of a material removal mechanism 830 including a nozzle having a first side 831 and a second side 832. The material removal mechanism has a cavity 833 configured to accommodate any material (e.g., powder) attracted to the cavity through the nozzle opening ending at tip 834a, nozzle opening extends along the tip of the material removal mechanism, e.g., from 834a towards the opposing end, including position 834b. Cavity 833 has an exit port (e.g., exit opening) 835 through which attracted material (e.g., from a powder bed) is removed from cavity 833. Opening 835 can be operatively coupled (e.g., using a channel such as a hose) to a force generator (e.g., a vacuum pump, a magnetic force, or an electrostatic force generator). In the example shown in material removal mechanism 830, two side 831 and 832 of the nozzle of the material removal system form a material entrance channel ending in tip 834a-834b, which material entrance channel has a bent vertical cross section. The material removal mechanism in example 830 shows the mount portion 837 above one nozzle portion 831. In the example of FIG. 8, portion 831 of the mount and portion (e.g., half nozzle) 832 of the nozzle form one integral piece. Other examples of material removal mechanisms can be found in Patent Application Serial No. PCT/US15/36802 which are fully incorporated herein by reference in its entirety. Material removal mechanism 820 depicts another view of material removal mechanism similar to material removal mechanism 820. In material removal mechanism 830 the nozzle 834a has a bent channel, and in material removal mechanism 820, the nozzle has a straight channel. Material removal mechanisms 830 and 820 are disposed in relation to gravitational vector 899 directed towards gravitational center G.

FIG. 8 shows in example 870 a vertical cross-sectional example of a of nozzle of the material removal mechanism looking into cavity 872 to its far second side, disposed with respect to gravitational vector 899 pointing towards the environmental gravitational center. In the example shown in 870, two sides of the nozzle—a first side 875 and a second side 876—form a material entrance opening channel extending from internal cavity 872 to tip 877. The channel in example 870 has a straight vertical cross section (e.g., is devoid of a curvature or an angle), and is overall (e.g., substantially) normal to the first/second exposed surface and slightly expands from the tip to the internal cavity, e.g., symmetrically along its long axis (e.g., to form a triangular vertical cross section). Side 876 can be a tailing side of the nozzle, and side 875 can be a leading side of the nozzle, e.g., with respect to the direction of movement 871 of the material removal mechanism such as during the removal operation. Side 876 is curved at its bottom most tip, whereas side 875 has a (e.g., substantially) flat bottom side facing the first/second exposed surface of powder bed 880. The material removal mechanism is configured to attract material from a first exposed surface 874 of powder bed 880 to generate a second exposed surface 873 as it translates laterally along the exposed surface in direction 871, e.g., when the material removal mechanism is connected to an operating attractive force source. Tip 877 of the nozzle is disposed at a gap 889 distanced from the first exposed surface 874. The first side 875 has a first external surface 878 facing the first/second exposed surface of powder bed 880, which first external surface 878 is of the flat bottom side. The first surface 878 is disposed (e.g., substantially) parallel with the first/second exposed surface of powder bed 880. The second side 876 has a second external surface 881 facing the first/second exposed surface of powder bed 880, which second external exposed surface 881 that forms an angle beta (B) with the first/second exposed surface of powder bed 880. An optional O-ring may be disposed in location 879 representing an optional O-ring groove. In the example shown in 870, first external surface 878 has (i) a smaller vertical cross section and (ii) occupies a smaller area, as those of the second external surface 881 respectively. The two opposing sides 876 and 875 are asymmetric, e.g., with respect to the channel, with respect to the direction of suction of the material from the exposed surface into the internal compartment of the nozzle during operation of the nozzle, and/or with respect to gravitational vector 899. A slope is formed between the first exposed surface 874 and the second exposed surface 873, having lateral length 885.

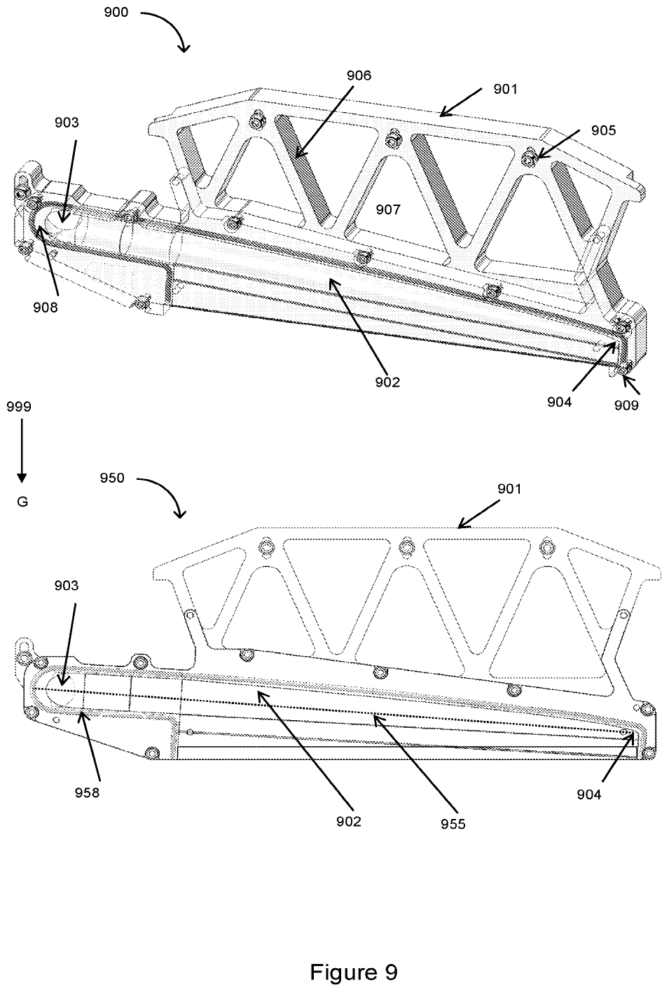

FIG. 9 depicts in 900 a perspective vertical cross-sectional view of a cavity 902 of a material removal mechanism, which cavity 902 is tapered towards a first end 904. The cavity has a second opposing end 908 and an exit port 903 close to the second opposing end. Exit port 903 is disposed along a long axis of the cavity. The material removal mechanism having cavity 902, is mounted to mount 901 using fasteners (screws) such as 905. The mount comprises supporting beams such as 906 arranged as sides of triangles forming triangular open spaces such as 907. FIG. 9 depicts in 950 a side vertical cross-sectional view of cavity 902 showing exit port 903 and first end 904 of tapered cavity 902 having long axis 955. In some embodiments, the mount is part of, or is operatively coupled to, at least one portion of the cavity of the material removal mechanism. In some embodiments, the material removal mechanism comprises three portions: a mount, a first half of a cavity and nozzle portion, and a second half of a cavity and nozzle portion. FIG. 9 shown in 900 and in 900 a mount coupled with fasteners (e.g., screws) to one half of the cavity and nozzle portion. In some embodiments, half of the cavity and half of the nozzle form one integral piece. The two halves of the integrated half-cavity and half-nozzle can be coupled together using fasteners (e.g., screws such as 909). A sealant (e.g., flexible material) is disposed at one of the halves of the integral half-cavity and half-nozzle, e.g., to hinder any leakage of material attracted through the cavity. FIG. 9 shows an example of a sealant in 958. The material removal mechanisms in examples 900 and 950 are depicted in relation to gravitational vector 999 directed towards gravitational center G.

In some configurations, the 3D printer comprises a bulk reservoir (e.g., a tank, a pool, a tub, hopper, or a basin). The bulk reservoir may comprise powder, e.g., starting material for a 3D printing process. The bulk reservoir may comprise a mechanism configured to deliver the powder from the bulk reservoir to at least one component (e.g., material dispenser) of the layer dispensing mechanism. The bulk reservoir can be connected or disconnected from the layer dispensing mechanism (e.g., from the material dispenser). The disconnected powder dispenser can be located above, below or to the side of the powder bed. The disconnected powder dispenser can be located above the powder bed, for example above the material exit port to the material dispenser within the layer dispensing mechanism. Above may be in a position away from the gravitational center. The bulk reservoir may be connected to the material dispensing mechanism (e.g., layer dispenser) that can be a component of (or be coupled to) the layer dispensing mechanism. The bulk reservoir may be located above, below or to the side of the layer dispensing mechanism. The layer dispensing mechanism and/or the bulk reservoir have at least one opening port (e.g., for the powder to move to and/or from). Powder can be stored in the bulk reservoir. The bulk reservoir may hold at least an amount of material sufficient for one layer, several layers, or sufficient to build the entire 3D object. The bulk reservoir may hold at least about 200 grams (gr), 400 gr, 500 gr, 600 gr, 800 gr, 1 Kilogram (Kg), or 1.5 Kg of powder. The bulk reservoir may hold at most 200 gr, 400 gr, 500 gr, 600 gr, 800 gr, 1 Kg, or 1.5 Kg of powder. The bulk reservoir may hold an amount of material between any of the afore-mentioned amounts of bulk reservoir material (e.g., from about 200 gr to about 1.5 Kg, from about 200 gr to about 800 gr, or from about 700 gr to about 1.5 kg). Material from the bulk reservoir can travel to the layer dispensing mechanism via a force. The force can be natural (e.g., gravity), or artificial (e.g., using an actuator such as, for example, a pump). The force may comprise friction. The bulk reservoir may be any bulk reservoir disclosed in Patent Application Serial Number PCT/US15/36802 that is incorporated herein by reference in its entirety.

In some embodiments, the reservoir of the powder dispenser resides within the material dispensing mechanism. The powder dispenser may hold at least an amount of powder sufficient for dispensing at least about one, two, three, four or five layers. The material sufficient to dispense about a layer may be more than the material dispensed for the formation of the layer. For example, the material may be sufficient to dispense the layer and retain an angle of repose to control dispersion of a requested amount of material. The powder dispenser (e.g., an internal reservoir) may hold at least an amount of powder sufficient for at most one, two, three, four or five layers. The powder dispenser reservoir may hold an amount of material between any of the afore-mentioned amounts of material (e.g., sufficient to a number of layers from about one layer to about five layers). The powder dispenser reservoir may hold at least about 20 grams (gr), 40 gr, 50 gr, 60 gr, 80 gr, 100 gr, 200 gr, 400 gr, 500 gr, or 600 gr of powder. The powder reservoir may hold at most about 20 gr, 40 gr, 50 gr, 60 gr, 80 gr, 100 gr, 200 gr, 400 gr, 500 gr, or 600 gr of powder. The powder dispenser reservoir may hold an amount of material between any of the afore-mentioned amounts of powder dispenser reservoir material (e.g., from about 20 gr to about 600 gr, from about 20 gr to about 300 gr, or from about 200 gr to about 600 gr). Powder may be transferred from the bulk reservoir to the material dispenser by any analogous method described herein for exiting of powder from the material dispenser. Transfer of the starting material from the bulk reservoir to the material dispenser may take place in the ancillary chamber, e.g., in the garage.

At times, the powder in the bulk reservoir and/or in the material dispensing mechanism is temperature adjusted, e.g., is preheated, cooled, is at an ambient temperature or maintained at a predetermined temperature.

In some embodiments, the layer dispensing mechanism includes components comprising a material dispensing mechanism, material leveling mechanism, material removal mechanism, or any combination or permutation thereof. In some configurations, the material dispensing mechanism comprises a material dispenser and a material remover. The material dispenser may be operatively coupled to an agitator that causes at least a portion of the powder within the material dispenser to vibrate. Vibrate may comprise pulsate, throb, resonate, shiver, tremble, flutter or shake. For example, the agitator may cause one or more portions of the material dispenser body to vibrate, e.g., with ultrasonic vibrations. The one or more portions of the material dispenser may comprise a side, or a panel (e.g., a gate), of the internal reservoir of the material dispenser. For example, the agitator (e.g., vibration mechanism) may cause at least a portion of the exit port of the material dispenser to vibrate. For example, the agitator may cause one or more components of the material dispenser to vibrate. The one or more components may be a panel, or at least one portion of the panel. For example, the agitator may cause the material dispenser to vibrate. The agitator may cause the starting material disposed in the material dispenser to vibrate, e.g., without (e.g. substantially) vibrating the body of the material dispenser. The agitator may be any agitator described herein. The material dispenser may comprise a container (e.g., an internal reservoir of powder).

At times, the material dispenser comprises an agitation component. The agitation component (e.g., vibrator, actuator, or the like) can be located adjacent to and/or in contact with one or more surfaces of the material dispenser. For example, the agitation component may be in contact with an inner surface of a body of the material dispenser. For example, the agitation component may be in contact with an outer surface of a body of the material dispenser. For example, the agitation component may separate (e.g., isolated) from the surfaces of a body of the dispenser and disposed in the dispenser. For example, the agitator may comprise a wave guide that is inserted into an internal reservoir of the material dispenser, e.g., into the container of the material dispenser.

At times, the agitator is controlled, e.g., automatically by at least one controller such as the one disclosed herein. The vibratory motion may be performed continuously or intermittently. The vibrations may be homogenous during a deposition cycle. The vibrations may vary during a deposition cycle. The vibratory motion may be performed during the deposition of a planar layer of powder, or a portion thereof. The vibratory motion may be performed during (e.g., as part of) a printing cycle of at least one 3D object. The vibratory movement of the material dispenser may be controlled statically. The vibrating movement of the material dispenser may be controlled dynamically (e.g., during deposition of at least a portion of a planar layer of material), e.g., in real time. The vibrating movement of agitation component can be utilized to control fluidization of powder disposed in the material dispenser during one or more processes of the 3D printing, e.g., to dispense material onto a target surface to form, or extend, a powder bed. For example, vibrating movement of the agitation component can induce a flow of powder (e.g., an “ON” state) from a material dispenser of a layer dispensing mechanism, where no vibrating movement of the agitation component can reduce (e.g., stop) a flow of powder (e.g., an “OFF” state) from the material dispenser.

In some embodiments, the actuator is operatively coupled to at least one controller (herein collectively “controller”). The controller may be coupled to at least one sensor (e.g., positional, optical, or weight). The controller may control the starting of an actuator's operation. The controller may control the stopping of the actuator's operation. The controller may detect a position of the layer dispensing mechanism. The position may be an absolute position nor a relative position, e.g., relative to the build plate or to the piston. The controller may dynamically (e.g., in real-time during the 3D printing) control the actuator, e.g., to adjust the position of the layer dispensing mechanism. The controller may control the amount of movable distance of the layer dispenser. The controller may detect the need to perform dispensing and/or planarization operation on a target surface. The controller may activate the actuator to move the layer dispensing mechanism to a position adjacent to the platform. The controller may be coupled to an agitator and control operation of the agitator, e.g., to dispense starting material onto a target surface. The controller may detect the completion of dispensing a layer adjacent to the platform (e.g., comprising a base-build plate FIG. 1, 102 and a substrate—piston FIG. 1, 109). The controller may activate an actuator to move the shaft to retract the layer dispensing mechanism into the ancillary chamber.

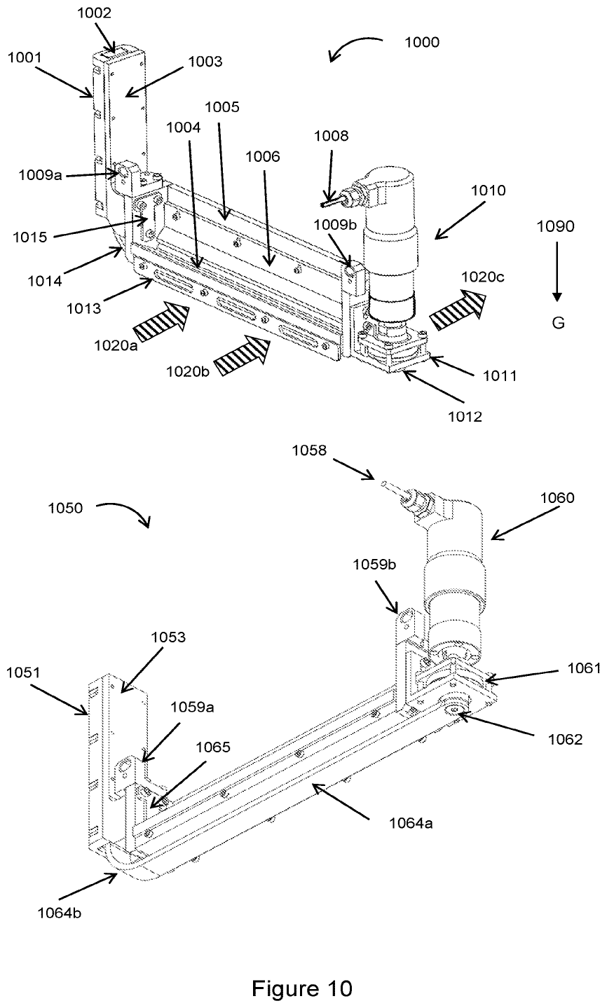

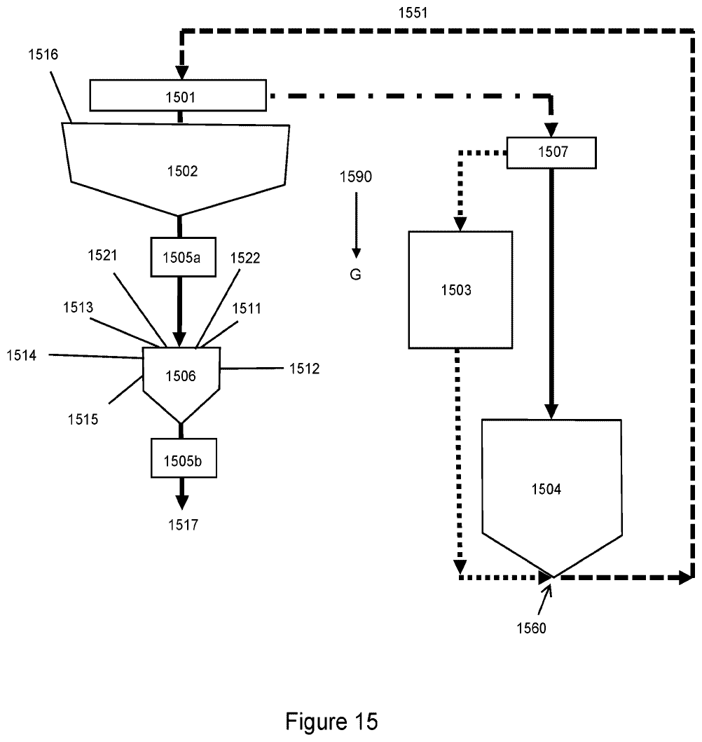

FIG. 10 depicts a top perspective view example of a material dispensing mechanism comprising a panel having a first portion disposed (e.g., substantially) horizontally and a second portion disposed (e.g., substantially) vertically, the first portion begin coupled with the second portion by a third portion 1014 that is bent. The second portion is disposed in a housing having a first housing portion 1001 coupled with a second housing portion 1003. The housing comprises an insert 1002 pressed onto the second portion having a diminishing width, e.g., to generate an agitation black hole (e.g., an acoustic black hole). The housing is coupled with a body of the material dispenser at least in part by using coupler 1015. Material dispensing mechanism 1000 includes a first reservoir 1005 optionally configured to direct powder (now shown) through a volume of the reservoir 1005 to the exit port 1004 of material dispensing mechanism 1000. The powder can be a particulate material. Material dispensing mechanism 1000 includes second reservoir 1006 optionally configured to direct powder (not shown) through a volume of the reservoir 1006 to the exit port 1004 of material dispensing mechanism 1000. The first portion of the panel (not shown) can be oriented with respect to the exit port 1004 such that a planar portion of surface of panel 1014 may face exit port 1004 such that during use it is aligned perpendicularly along gravitational vector 1090 pointing towards the gravitational center of the ambient environment. Material dispenser 1000 comprises, or is coupled with, an agitation transducer 1010 configured to induce agitation (e.g., vibrations such as ultrasound vibrations) in the panel, e.g., in an end of the panel. Agitation generator (e.g., transducer) 1010 is coupled by coupler 1008 (e.g., wiring) to a power source (e.g., electrical source). Agitation transducer 1010 is secured and/or aligned by harness 1011 to the body of material dispenser 1000. The body of material dispenser 1000 comprises couplers 1009a and 1009b configured to couple to a mount (not shown). The mount may be configured to facilitate translation of material dispenser 1000 along a lateral direction 1020a-c. The mount may be similar to carriage 1501 of FIG. 15. The mount may be configured to facilitate translation of material dispenser at least in part by being coupled with a carriage and/or an actuator. The lateral translation may be a reversible back and forth lateral translation. Agitation transducer 1010 is coupled to the first portion of the panel at coupling location 1012. Material dispenser 1000 comprises optional bumper 1013 configured to hinder lateral agitation of the first portion of the panel.

FIG. 10 depicts a bottom perspective view example of a material dispensing mechanism comprising a panel having a first portion 1064a disposed (e.g., substantially) horizontally and a second portion disposed (e.g., substantially) vertically, the first portion 1064a begin coupled to the second portion by a third portion 1064b that is bent. The second portion is disposed in a housing having a first housing portion 1051 coupled with a second housing portion 1053. The housing is coupled with a body of the material dispenser at least in part by using coupler 1065. Material dispensing mechanism 1050 includes reservoir(s) configured to guide the powder to an exit port aligned with the first portion of the panel. Material dispenser 1050 comprises, or is coupled with, an agitation transducer 1060 configured to induce agitation (e.g., vibrations such as ultrasound vibrations) in the panel, e.g., in an end of the panel. Agitation transducer 1060 is coupled by coupler 1058 (e.g., wiring) to a power source (e.g., electrical source). Agitation transducer 1060 is secured and/or aligned by harness 1061 to the body of material dispenser 1050. The body of material dispenser 1050 comprises couplers 1059a and 1059b configured to couple to a mount (not shown). The mount may be configured to facilitate translation of material dispenser 1050 along a lateral direction. The mount may be configured to facilitate translation of material dispenser at least in part by being coupled with a carriage and/or an actuator. The lateral translation may be a reversible back and forth lateral translation. Agitation transducer 1060 is coupled to the first portion 1064a of the panel at coupling location 1062. Material dispenser 1050 is devoid of the optional bumper configured to hinder lateral agitation of the first portion of the panel.

In some embodiments, the material dispenser may be configured to affect a reservoir of the starting material. The material dispenser may be configured to press onto a valve to (e.g., reversibly) alter a position of the valve, e.g., from one position not another position. For example, from a closed position to an open position, or vice versa. The material dispenser may have a lever that toggles a valve. The lever may affect inflow of the starting material into the material dispenser from a reservoir, e.g., a hopper. The material dispenser (e.g., recoater) can be configured to push open a (e.g., gate) valve. The material dispenser may comprise or more reservoir configured to receive starting material to be dispensed by the material dispenser through the exit port, e.g., to be supported by a build plate. The material dispenser may have a first optional reservoir and a second optional reservoir. At least one of the first and second reservoirs may allow flow of the material to the exit opening of the material dispenser. e.g., to dispense the material towards a build plate. During a dispense operation, the powder starting material flows towards the exit opening from at least one of the first and second reservoirs of the material dispenser. The first and second reservoir may be separated by a partition, the partition may comprise, or be operatively coupled with, the lever. At least one of the reservoir occupies (I) an empty space ready to accept the starting material, (II) an insert that prevents a starting material from coming in. The insert may be solid or hollow. For example, the insert may comprise a hollow cavity. At least one of the reservoirs may be configured to catch material straying from the intended path into the exit channel and through the exit port (e.g., exit opening) of the material dispenser. The material dispenser may be configured to receive incoming starting material from its top and/or from its side, e.g., top side corner. The starting material may flow into the exit channel ending with the exit port, the flow of material may be directly or through a reservoir of the material dispenser. The reservoir may have a slanted side wall(s), or may have non-slanted side wall(s). In an example, the side wall(s) of the reservoir may be (e.g., substantially) parallel to the side wall(s) of the exit channel.

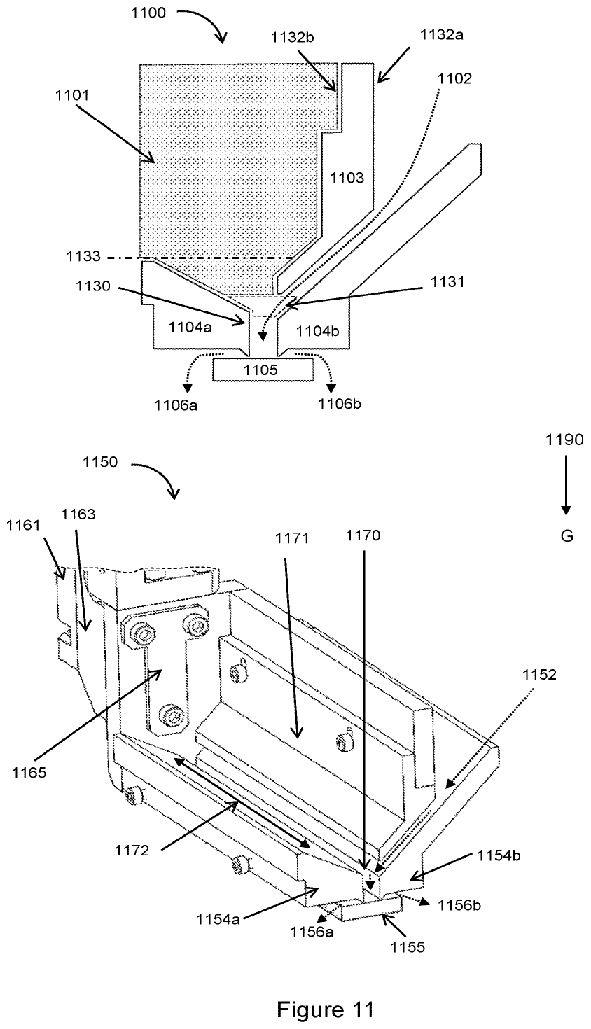

FIG. 11 depicts vertical cross sectional example of a material dispensing mechanism portion comprising panel 1105. Material dispensing mechanism 1100 includes a first reservoir 1101 optionally configured to direct powder (now shown) through a volume of reservoir 1101 to channel 1130 ending by an exit port. The powder can be a particulate material. Material dispensing mechanism 1100 includes a second reservoir optionally configured to direct powder (not shown) through a volume of the second reservoir along dotted line 1102 towards exit channel 1130 ending by the exit port. First reservoir 1101 and second reservoir 1102 are separated by partition (e.g., separator) 1103. The separator may comprise a lever that can affect status of a valve (e.g., toggle the valve) when contacting any of its sides 1132a and/or 1132b on translating the material dispenser to the requisite position. The requisite position affecting the valve may be in an ancillary chamber (e.g., FIG. 10, 1054). The ancillary chamber may be separate from the processing chamber, e.g., by a partition such as a door. Material dispensing mechanism 1100 comprises a first body side 1104a and a second body side 1104b separated by a (horizontal) gap from first body side 1104a to form the channel 1130 ending at the exit port. Material entering channel 1130 exist through an exit portion of channel 1130 and onto a panel 1105 that is aligned with the exit port, e.g., the alignment being (e.g., substantially) along the environmental gravitational vector 1190 pointing towards the gravitational center of the ambient environment. During operation, material exiting channel 1130 is spilled from panel 1105, e.g., along directions 1106a and 1106b. Spillage of the material from panel 1105 may be induced by agitating (e.g., vibrating) panel portion 1105. Panel 1105 is separated from each of first sides 1104a and 1104b by a (vertical) gap. Material dispenser 1100 is configured to trap straying starting material from spilling out of the material dispenser. For example, volume having cross section 1131 can facilitate trapping any stray starting material that did not follow path 1102 to the exit opening. The volume 1131 can extend further and include, e.g., the volume up to about line 1133.

FIG. 11 depicts a top perspective view example of a material dispensing mechanism comprising a panel having a first portion 1155 disposed (e.g., substantially) horizontally and a second portion disposed (e.g., substantially) vertically. The second portion is disposed in a housing having a first housing portion 1161 coupled with a second housing portion 1163. The housing is coupled with a body of the material dispenser at least in part by using coupler 1165. Material dispensing mechanism 1150 includes a first reservoir 1171 optionally configured to direct powder (now shown) through a volume of the reservoir 1171 to channel 3470 ending by an exit port. The powder can be a particulate material. Material dispensing mechanism 1150 includes a second reservoir optionally configured to direct powder (not shown) through a volume of the second reservoir along dotted line 1152 towards exit channel 1170 ending by an exit port. Material dispensing machines 1150 comprises a first body side 1154a and a second body side 1154b separated by a (horizontal) gap from first body side 1154a to form channel 1170 ending in an exit port, the channel being elongated along direction 1172 that is (e.g., substantially) perpendicular to the direction of movement of material dispenser 1150 during its material dispensing operation. Material entering channel 1170, exists through an exit portion of channel 1170 and onto a first portion 1155 of the panel that is separated from the exit opening by a (vertical) gap. The panel is aligned with the exit port, e.g., the alignment being (e.g., substantially) along the environmental gravitational vector 1190 pointing towards the gravitational center of the ambient environment. During operation, material exiting channel 1170 is spilled from panel portion 1155, e.g., along directions 1156a and 1156b. Spillage of the material from panel portion 1155 may be induced by agitating (e.g., vibrating) panel portion 1155. Panel portion 1155 is separated from each of first sides 1154a and 1154b by a (vertical) gap.

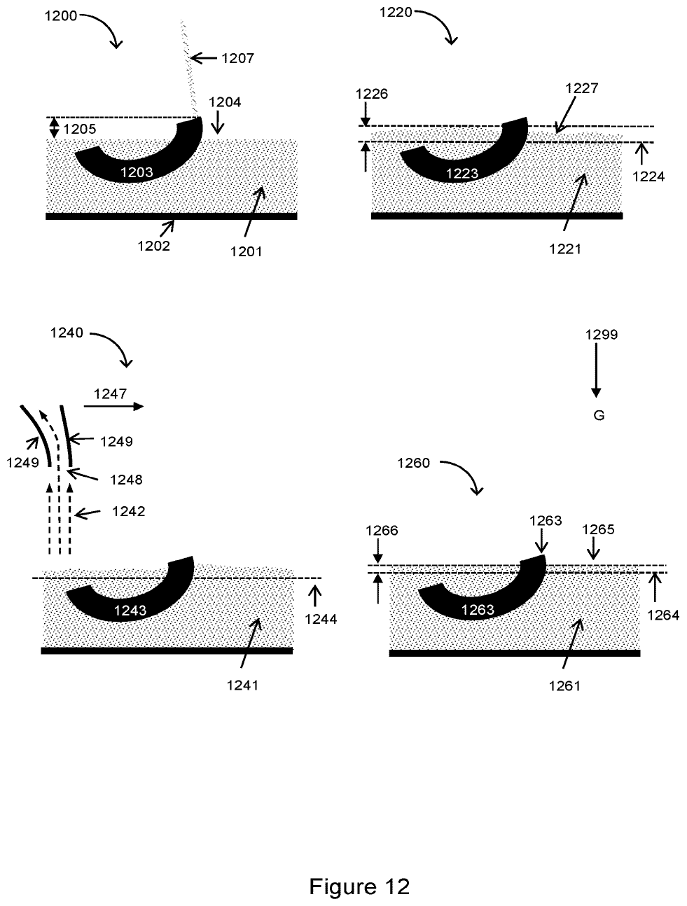

FIG. 12 shows examples of various stages of a layering method described herein. FIG. 12 shows an example 1200 of a powder bed 1201 in which a 3D object 1203 is suspended in the powder bed (e.g., comprising a powder (e.g., particulate material)) between layering procedures of a 3D printing operation. FIG. 12 shows an example of energy beam 1207 projected onto the powder bed to print 3D object 1203 that protrudes by vertical height 1205 from the exposed surface 1204 of powder bed 1201 disposed on a base or on a platform 1202. The protrusion may be caused by deformation, e.g., warping caused upon hardening the 3D object 1203. Examples 1200, 1240, 1220, and 1260 are depicted in relation to gravitational vector 1299 directed towards gravitational center G. One or more energy beams can be used to transform at least a portion of the powder bed (e.g., a layer (e.g., first layer) of powder) to form at least a portion of the 3D object. The energy beam(s) can be directed to a target surface, e.g., surfaces of the powder, exposed surface of the powder bed, and/or a surface of the 3D object. Before and/or after the energy beam(s) is applied, an exposed (e.g., top) surface (e.g., 1204) of the powder bed can optionally have a (e.g., substantially) planar surface. Any suitable leveling technique can be used. In some embodiments, a material removal mechanism is used, e.g., as described herein. In some cases, the leveling involves agitating the powder to facilitate its deposition, e.g., using vibrations. The energy beam(s) can impinge on the exposed surface of the powder bed to transform a portion (e.g., a portion of a layer) of powder to form a portion (e.g., corresponding layer) of transformed (e.g., hardened) material as part of the 3D object. Sometimes, the transformation process can cause debris to form on and/or within the powder bed and/or the 3D object. For example, an energy of the energy beam(s) may be sufficiently energetic to eject powder, transformed, and/or transforming material from the target surface and land (splatters) on surrounding regions of the powder bed and/or 3D object. The debris can correspond to transformed (e.g., hardened) material, partially transformed (e.g., partially hardened) material, contaminants (e.g., soot), or any combination thereof. The debris can correspond to agglomerated, sintered and/or fused powder particles (e.g., particulate). The debris particles can have any suitable shape and size. The debris particles can have regular and/or irregular (non-symmetric) shapes. For example, the debris particles can have globular (e.g., spherical, or non-spherical) shapes. The debris particles can be smaller (e.g., have smaller FLS) than the 3D object. The debris may have a FLS that is smaller and/or larger than the average FLS of the powder (e.g., in case of a particulate material). For example, the debris particles can be larger (e.g., have larger FLS) than the powder particles, as described herein. Larger can be by at least two times the FLS of the powder particles. The debris particles can be smaller (e.g., have smaller cross-sections (e.g., diameters)) than a height of a layer (e.g., first layer) of powder, as described herein. In some cases, the debris particles have an average FLS (e.g., cross-section widths (e.g., diameters) (e.g., median cross-section widths)) of at least about 50 μm, 80 μm, 100 μm, 110 μm, 120 μm, 130 μm, 140 μm, 150 μm, 200 μm, 250 μm, 300 μm, 400 μm, 500 μm, 800 μm, 1000 μm, or 2000 μm. The debris particles can have a FLS ranging between any of those listed above (e.g., from about 50 μm to about 2000 μm, from about 50 μm to about 250 μm, or from about 250 μm to about 2000 μm). Sometimes, the debris interferes with subsequent formation of the 3D object. For example, the debris may cause defects (e.g., voids, inconsistencies, and/or surface roughness) in a subsequently formed portion (e.g., subsequent layer(s)) of the 3D object.

FIG. 12 shows an example 1220 of a succeeding operation to 1200, where a layer having a first thickness (e.g., height) 1226 (also referred to as an additional layer, new layer or a second layer) is deposited on an exposed surface 1224 of the powder bed 1221, e.g., above the planar surface 1204 corresponding to the previous exposed surface of the powder bed. Any suitable material deposition process can be used. In some embodiments, a material dispensing mechanism (e.g., material dispenser), as described herein, is used. The material dispensing mechanism can utilize gravitational force and/or gas flow (e.g., airflow) that also displaces (e.g., partially levels) the newly added material. The additional layer can be deposited such that a least a portion of the 3D object 1223 is exposed. In some embodiments, the additional layer does not have a leveled top surface, has a lower level of planarity as compared to a requested level of planarity, or has a higher level of roughness as compared to a requested level of roughness.

FIG. 12 shows an example 1240 of a succeeding material removal operation to 1220 where a portion of the additional layer is being removed from exposed surface 1244 of the powder bed 1241. As depicted in the example shown in FIG. 12, the material remover 1249 does not contact the additional layer, rather, it hovers above the additional layer. The material remover portions 1249 forming entrance port 1248 provides an attractive force by an attractive force source, e.g., a vacuum source (not shown). The attractive force causes flow along broken lines such as line 1242. Portions 1249 designate two wall portions of a vertical cross section of a dispenser body or a nozzle, leading to entrance port 1248. The attractive force creates an attractive flow along flow lines such as 1242 (e.g., comprising a vertical flow component) within the powder bed 1241 and/or surrounding gas proximate to the material remover portion 1249. The attractive flow causes a portion of the material to be removed from the powder bed 1241 and into the material remover 1249 (e.g., nozzle) as the material remover having portion 1249 translates along direction 1247, e.g., laterally about the XY plane. The material remover can translate in an opposite direction to direction 1247. Material remover reduces a first thickness 1226 of the deposited layer to a second thickness 1266 smaller than the first thickness. The removed material can be recycled using a recycling system, e.g., as described herein. For example, the material removal mechanism can be operationally coupled to the recycling system. The removed material can be directed to the recycling system via the material removal mechanism. The attractive force can be any suitable type of attractive force, e.g., as described herein. The debris can become entrained within the attractive flow and into the material removal mechanism, thereby removing at least a portion of the debris from the powder bed (e.g., from the exposed surface thereof). This removal of at least a portion of the debris can reduce an occurrence of defects in and/or on the 3D object (e.g., final 3D object). The at least a portion of the debris may comprise at least about 70%, 80%, 90% of the debris deposited on the powder bed. In some cases where the removed material is recycled by a recycling system. The recycling system can filter out at least some of the debris (e.g., using one or more filters, e.g., sieves) such that the recycled material can (e.g., substantially) include powder (e.g., and used in subsequent layer forming operations).

During the layer deposition and/or 3D printing, the powder bed may comprise a flowable material, and/or non-compressible material. During the 3D printing, the powder bed may be (e.g., substantially) devoid of pressure gradients.

In some embodiments, a material removal mechanism removes material to form an exposed surface having a lower roughness, or a higher level of planarity, as compared to the one generated by the material dispensing mechanism. FIG. 12 shows an example 1260 of the additional layer after the material removal process. The additional layer having a second thickness (e.g., height) 1266 disposed on the exposed surface 1264 of the powder bed 1261 can have a central tendency of thickness that is less than a maximal height (e.g., a vertical height) of protrusion 1263 of the 3D object 1263 such that a protrusion 1263 extends above the new exposed surface 1265 of the additional layer of thickness (e.g., height) 1266. The layer having first thickness 1226 has an exposed surface 1227 that is rougher than exposed surface 1265 of the layer having the second thickness 1266. The exposed surface 1227 having the first planarity (or first roughness) is generated by the dispenser, and the exposed surface 1265 having the second planarity (or second roughness) is generated by the remover. In some embodiments, the material removal mechanism can remove at least about 70%, 80%, 90%, 95%, 97%, 98%, 99%, 99.5%, 99.8% or 99.9% of the deposited material (e.g., the material deposited in example 1200) the percentages may designate weight percentages or volume percentages. In some embodiments, the percentages are calculated volume per volume. The new exposed surface can be (e.g., substantially) planar. The material removal operation may or may not expose a portion (e.g., a protruding portion such as 1261) of the 3D object. The thickness of the additional layer after the material removal (e.g., prior to a subsequent transformation operation) can vary depending on process requirements and/or system limitations. In some embodiments, a (e.g., average) thickness of the additional layer can be at least about 5 μm, 10 μm, 50 μm, 100 μm, 150 μm, 200 μm, 250 μm, 300 μm, 350 μm, 400 μm, 450 μm, or 500 μm. The average thickness of the leveled additional layer can be at most about 700 μm, 500 μm, 450 μm, 400 μm, 350 μm, 300 μm, 250 μm, 200 μm, 150 μm, 100 μm, 50 μm, 10 μm, or 5 μm. The (e.g., average) thickness of the leveled additional layer can be between any of the afore-mentioned (e.g., average) thickness values. For example, the (e.g., average) thickness can be from about 5 μm to about 500 μm, from about 10 μm to about 100 μm, from about 20 μm to about 300 μm, or from about 25 μm to about 250 μm. After the additional layer is complete, another transformation operation can be performed (e.g., using an energy beam (e.g., example 1200, energy beam 1207)) to form another layer of the 3D object. The sequences described with respect to the examples of FIG. 12 can be subsequently until the 3D object is complete.

Examples. The following are illustrative and non-limiting examples of methods of the present disclosure.

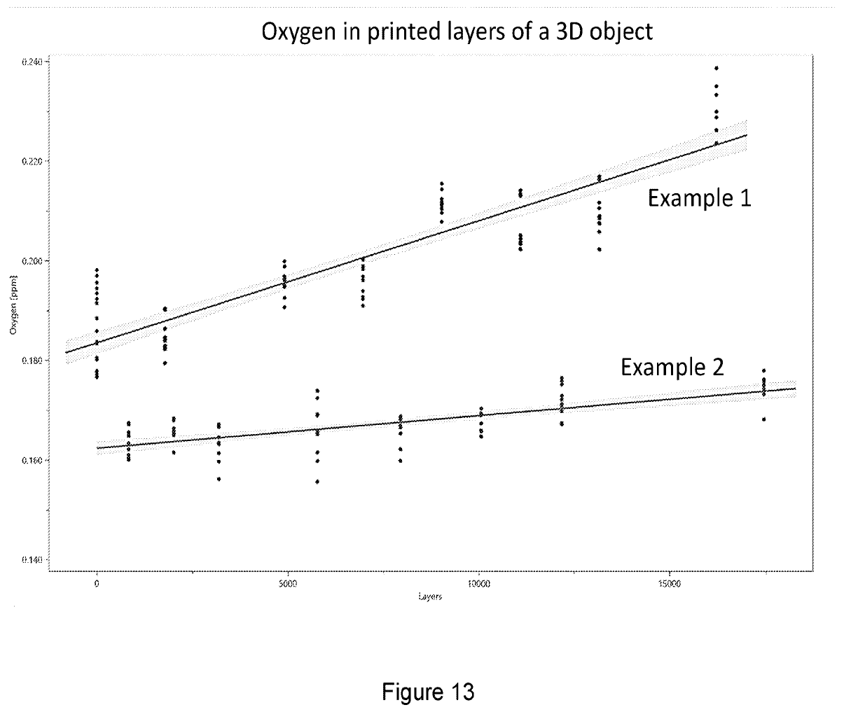

Example 1: In a processing chamber, Titanium powder having an average diameter of 37 micrometers was dispensed by a layer dispensing mechanism (e.g., recoater), the powder being dispensed above a build plate having a diameter of about 315 mm to form a powder bed. A layer dispensing mechanism was used to form a powder bed. When idle, a layer dispensing mechanism is parked in an ancillary chamber (e.g., garage) coupled with the processing chamber in which the build plate was disposed, the ancillary chamber separated from the processing chamber by a door. The layer dispensing mechanism comprised a powder dispenser and a powder remover. The powder remover was configured to attract a portion of the dispensed powder to form a planar exposed surface of the powder bed using vacuum. The attracted powder was conveyed using a material (e.g., powder) conveyance system for recycling and reuse in by the layer dispensing mechanism. The atmosphere in the material conveyance system was similar to the one used in the processing chamber. The processing chamber was under an atmosphere that is less reactive with the powder than the ambient atmosphere external to the processing chamber. The internal processing chamber atmosphere comprised argon, oxygen, and humidity. The oxygen was at a concentration of at most about 1000 ppm, and the humidity had a dew point from about −55° C. to about −15° C. The internal processing chamber atmosphere had a pressure of about 16 KPa above atmospheric pressure (e.g., above about 101 KPa), and was at ambient temperature. The processing chamber was equipped with two optical windows made of sapphire. Each laser beam was guided by an optical setup in an optical system enclosure, the optical system enclosure disposed above the processing chamber, the optical system enclosure comprising a galvanometer scanner. Each of the laser beams originated from a fiber laser and traversed its respective optical window into the processing chamber to impinge on an exposed surface of the powder bed to print layerwise a 3D object. Each of the laser beam had a maximum power of about one (1) Kilo Watt, and a wavelength of about 1060 nanometers. A user was able to view the laser beams during printing using three circular viewing window assemblies similar to FIG. 3, 302. The viewing assembly comprises a reflective coating facing the interior of the processing chamber. The layer dispensing mechanism formed a powder bed by sequential layerwise deposition, the powder bed being disposed in a build module above the build plate. The layer dispensing mechanism (e.g., recoater) included a powder dispensing mechanism (e.g., dispenser) and a powder removal mechanism (e.g., remover). The layer dispensing mechanism was similar to the one disclosed in FIG. 1, 122, having a material remover, material dispenser, and leveler. The layer dispensing operation was similar to the one depicted in FIGS. 6A-6D. The material dispenser vase devoid of an agitation transmitting panel. The build plate was disposed above a piston. The build plate traversed down at increments of about 50 μm at a precision of +/−2 micrometers using an optical encoder. The powder bed was used for layerwise printing a 3D object using the lasers. The removed powder was recycled using a recycling system as part of the powder recycling system that is part of the material conveyance system. The recycled powder was reused by the layer dispensing mechanism, e.g., recoater. The 3D object printed exhibited oxygen pickup (e.g., as the corresponding oxide) pattern as in FIG. 13.

Example 2: In a processing chamber, Titanium powder having an average diameter of 37 micrometers was dispensed by a layer dispensing mechanism (e.g., recoater), the powder being dispensed above a build plate having a diameter of about 315 mm to form a powder bed. A layer dispensing mechanism was used to form a powder bed. When idle, a layer dispensing mechanism is parked in an ancillary chamber (e.g., garage) coupled with the processing chamber in which the build plate was disposed, the ancillary chamber separated from the processing chamber by a door. The layer dispensing mechanism comprised a powder dispenser and a powder remover. The powder remover was configured to attract a portion of the dispensed powder to form a planar exposed surface of the powder bed using vacuum. The attracted powder was conveyed using a material (e.g., powder) conveyance system for recycling and reuse in by the layer dispensing mechanism. The atmosphere in the material conveyance system was similar to the one used in the processing chamber. The processing chamber was under an atmosphere that is less reactive with the powder than the ambient atmosphere external to the processing chamber. The internal processing chamber atmosphere comprised argon, oxygen, and humidity. The oxygen was at a concentration of at most about 1000 ppm, and the humidity had a dew point from about −55° C. to about −15° C. The internal processing chamber atmosphere had a pressure of about 16 KPa above atmospheric pressure (e.g., above about 101 KPa), and was at ambient temperature. The processing chamber was equipped with two optical windows made of sapphire. Each laser beam was guided by an optical setup in an optical system enclosure, the optical system enclosure disposed above the processing chamber, the optical system enclosure comprising a galvanometer scanner. Each of the laser beams originated from a fiber laser and traversed its respective optical window into the processing chamber to impinge on an exposed surface of the powder bed to print layerwise a 3D object. Each of the laser beam had a maximum power of about one (1) Kilo Watt, and a wavelength of about 1060 nanometers. A user was able to view the laser beams during printing using three circular viewing window assemblies similar to FIG. 3, 302. The viewing assembly comprises a reflective coating facing the interior of the processing chamber. The layer dispensing mechanism formed a powder bed by sequential layerwise deposition, the powder bed being disposed in a build module above the build plate. The layer dispensing mechanism (e.g., recoater) included a powder dispensing mechanism (e.g., dispenser) and a powder removal mechanism (e.g., remover). The layer dispensing operation was similar to the one depicted in FIG. 12. The powder removal mechanism was similar to the one disclosed in FIG. 8, 870; and FIG. 9. The powder dispenser mechanism was similar to the one disclosed in FIGS. 10-11, lacking the optional bumper 1013. The layer dispensing operation included (1) using the powder dispensing mechanism to dispense a planar layer having an average height of about 250 micrometers, followed by (2) using the powder removal mechanism to remove about 200 micrometers from the deposited layer, resulting in a layer having an average height of about 50 micrometers. In the powder dispensing operation, powder flowed in the direction 1102 towards the exit opening of the dispenser, with the portion 1101 being empty. The vibration generator generated ultrasound waves at a frequency of about 40 kilohertz continuously during layer dispensing. The layer dispenser dispensed a planar layer of the powder in about 10 seconds. The layer dispenser dispensed layers at a rate of 2 milliliters per second (mL/s). The average planarity of the layer had an error of at most about 20% from the thickness of the layer. The planarity of the layer had a Sa value of at most 50 micrometers for a 250 micrometer thick layer. The arithmetical mean height (Sa) is a roughness parameter defined as the mean of the absolute value of the height of points within the defined area. The layer dispenser dispensed planar layers of powder at a rate of about 2 milliliters of powder per second (mL/s). In the powder removal operation, the powder was removed using a vacuum source connected to exit port similar to 1103, the powder entering nozzle similar to the one depicted in example 870, into cavity similar to 1102 and out of the powder removal mechanism (e.g., cavity thereof). The build plate was disposed above a piston. The build plate traversed down at increments of about 50 μm at a precision of +/−2 micrometers using an optical encoder. The powder bed was used for layerwise printing a 3D object using the lasers. The removed powder was recycled using a recycling system as part of the powder recycling system that is part of the material conveyance system. The recycled powder was reused by the layer dispensing mechanism, e.g., recoater. The 3D object printed exhibited oxygen pickup (e.g., as the corresponding oxide) pattern as in FIG. 13.

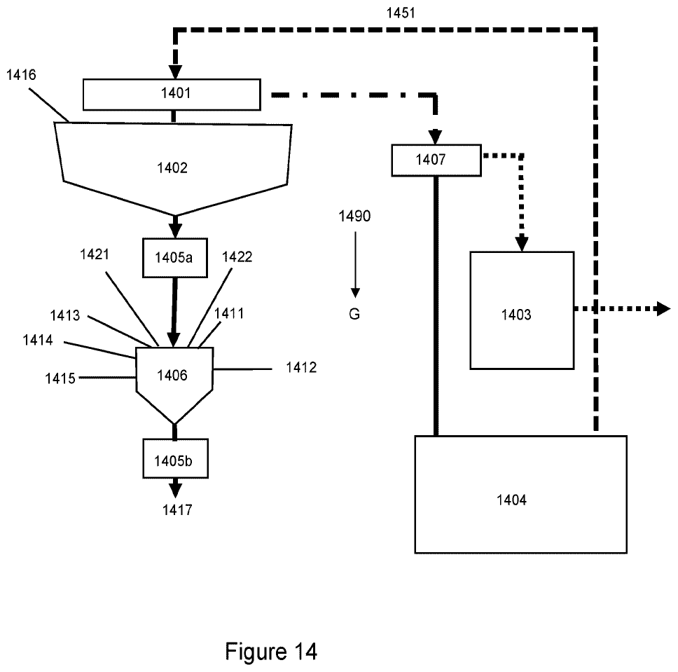

FIG. 14 shows an example of new powder introduction apparatus shown with respect to the environmental gravitational vector 1490. The introduction of the new powder may utilize ambient pressure, positive pressure and/or under pressure (e.g., vacuum), relative to the ambient atmosphere. The introduction of the new powder may be done at least in part manually. Buffer reservoir 1404 comprising new powder is coupled by channel 1451 to inertial separator 1401 (e.g., cyclone or sieve reservoir). Buffer reservoir 1404 can be disposed (e.g., substantially) at a floor level. Transit of the new powder through channel 1451 can be using dilute phase conveyance or dense phase conveyance. The separator can separate the powder into reservoir 1402 equipped with powder level sensor 1416. Excess of the new powder in separator 1401 can be conveyed to filter 1407 at least in part by using compressor 1403 coupled to filter 1407. The filtered new powder from 1407 is directed back into buffer reservoir 1404. The separated new material (and other separated material such as remainder material) can be conveyed (e.g., gravitationally) to dosing hopper 1406. Dosing reservoir 1406 is equipped with exhaust valve 1413, pressure relief valve 1414, powder level sensor(s) 1411, reactive agent (e.g., oxygen and/or humidity) sensor(s) 1412, and reactive agent(s) pressure and/or flow limit valve(s) 1415. Dosing reservoir 1406 is equipped with an inlet for roust gas 1422, and an optional inlet for reactive agent(s) 1421. Dosing reservoir 1406 may coupe to another component of 1417 the powder conveyance system, e.g., a sieve enclosure, a separator (e.g., cyclone), a reservoir, or a material dispensing mechanism. Dosing reservoir 1406 may be configured to allow equilibration of its internal atmosphere to match that of the rest of the powder conveyance system 1417, e.g., at least in part by using first valve 1405a and second valve 1405b. In an example, valve 1405b may be shut when powder (e.g., recycled and new) enters dosing reservoir 1406 from reservoir 1402 through open first valve 1405a. On closure of first valve 1405a (and with second valve 1405b still closed), the atmosphere of dosing reservoir 1406 can be equilibrated, e.g., using the various sensors, valves, and inlets 1411-1415 and 1421-1422. After the atmosphere in dosing reservoir 1406 has been adjusted to the atmosphere in the rest of the powder conveyance system 1417, second valve 1405b can open and allow (gravitational) conveyance of the powder from dosing container 1406 to the rest of the powder conveyance system 1417.

FIG. 15 shows an example of new powder introduction apparatus with respect to the environmental gravitational vector 1590. The introduction of the new powder may utilize ambient pressure, positive pressure and/or under pressure (e.g., vacuum), relative to the ambient atmosphere. The introduction of the new powder may utilize a gas conveyance system, e.g., a closed loop gas recirculation system. The introduction of the new powder may be done at least in part automatically. The introduction of the new powder may be done continuously. Buffer reservoir 1504 comprising new powder is coupled by channel 1551 to inertial separator 1501 (e.g., cyclone or sieve reservoir). Buffer reservoir 1504 can be disposed (e.g., substantially) at a floor level. Transit of the new powder through channel 1551 can be using dilute phase conveyance or dense phase conveyance. The separator can separate the powder into reservoir 1502 equipped with powder level sensor 1516. Excess of the new powder in separator 1501 can be conveyed to filter 1507 at least in part by using compressor 1503 coupled to filter 1507. The filtered new powder from 1507 is directed back into buffer reservoir 1504. The separated new material (and other separated material such as remainder material) can be conveyed (e.g., gravitationally) to dosing hopper 1506. Dosing reservoir 1506 is equipped with exhaust valve 1513, pressure relief valve 1514, powder level sensor(s) 1511, reactive agent (e.g., oxygen and/or humidity) sensor(s) 1512, and reactive agent(s) pressure and/or flow limit valve(s) 1515. Dosing reservoir 1506 is equipped with an inlet for roust gas 1522, and an optional inlet for reactive agent(s) 1521. Dosing reservoir 1506 may coupe to another component of 1517 the powder conveyance system, e.g., a sieve enclosure, a separator (e.g., cyclone), a reservoir, or a material dispensing mechanism. Dosing reservoir 1506 may be configured to allow equilibration of its internal atmosphere to match that of the rest of the powder conveyance system 1517, e.g., at least in part by using first valve 1505a and second valve 1505b. In an example, valve 1505b may be shut when powder (e.g., recycled and new) enters dosing reservoir 1506 from reservoir 1502 through open first valve 1505a. On closure of first valve 1505a (and with second valve 1505b still closed), the atmosphere of dosing reservoir 1506 can be equilibrated, e.g., using the various sensors, valves, and inlets 1511-1515 and 1521-1522. After the atmosphere in dosing reservoir 1506 has been adjusted to the atmosphere in the rest of the powder conveyance system 1517, second valve 1505b can open and allow (gravitational) conveyance of the powder from dosing container 1506 to the rest of the powder conveyance system 1517. Compressor 1503 may push robust gas into a valve 1560 (e.g., venturi valve) that facilitates conveying the new powder from buffer reservoir 1504 into channel 1551.

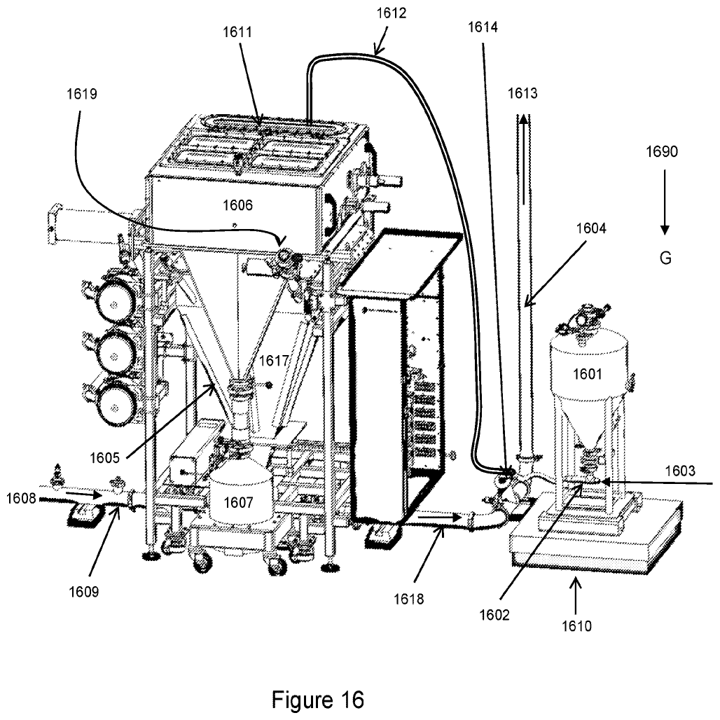

FIG. 16 shows an example of new powder introduction apparatus for introducing new powder to the 3D printing system using at least in part buffer reservoir 1601 that can be (a) coupled with channel 1604 of the gas conveyance system, (b) coupled with the sieve enclosure, or (c) coupled with reservoir 1617 that received sieved powder from the sieve disposed in sieve enclosure 1606. Coupling buffer reservoir 1601 with channel 1604 can be at location 1614. Channel 1604 of the gas conveyance system can direct the new powder (e.g., by dilute phase conveyance) to the layer dispensing mechanism at least in part in direction 1613, e.g., directing it to separator(s) such as cyclone(s) and to the dispenser's reservoir (e.g., doser). The new powder arriving from buffer reservoir 1601 into channel 1604 can mix with recycled and sieved powder arriving from the sieve enclosure 1606 through reservoir 1617 (e.g., hopper) and through transit in channel portion 1618, into channel portion 1604. Coupling buffer reservoir 1601 with sieve enclosure 1606 at least is at least in part by optional channel 1612, e.g., directing the new powder from buffer reservoir 1601 to sieve enclosure 1606, e.g., through being coupled with top opening 1611 of sieve enclosure 1606. The new powder arriving to sieve enclosure 1606 by optional channel 1612 arrive above the sieve, and is mixed with remainder powder in the sieving operation, the mixed remainder powder and new powder that is sieved is then collected in reservoir 1617. The new powder can be provided through connector 1619 into reservoir 1617 that collects the sieved remainder material. The mixing of the new powder with the sieved remainder powder may be by mixed accumulation in reservoir 1617, followed by mixing of the sieved remainder powder and the new powder while being conveyed by dilute phase conveyance in channel portions 1618 and 1604 in the direction towards 1613. Connector 1619 can couple with a channel (not shown) to buffer reservoir 1601, or connect to another buffer reservoir, e.g., a suspended buffer reservoir. The other buffer reservoir can connect directly to connector 1619, or through a dedicated channel. Buffer reservoir 1601 is disposed on weighting system 1610 (e.g., scale such as the one disclosed herein) that can at least in part determine the amount of new powder in the buffer reservoir. The gas can be (a) directed to the gas conveyance channel at least in part by utilization of venturi nozzle 1602 and influx 1603 of robust gas such as Argon, with venturi nozzle 1602 coupled to channel 1604. Chanel 1604 is coupled with reservoir 1605 (e.g., hopper) receiving sieved powder sieved in sieve enclosure 1606. The sieve enclosure is coupled to debris reservoir 1607 configured to enclose debris having FLS larger than that of the powder. Robust gas (e.g., Argon) is flowing in channel portion 1608 in the direction towards channel 1604, e.g., from a pump (not shown). Channel portion 1608 and 1604 can be coupled to reservoir 1605 through a second venturi nozzle in a configuration similar to the one depicted in FIGS. 7, 722 and 770. The components shown in FIG. 16 are depicted relative to the gravitational vector 1690 pointing towards the gravitational center G of the ambient environment external to the components.

In some embodiments, the amount of new powder in the buffer reservoir is monitored, e.g., using one or more sensors. The sensor may comprise a weight sensor, e.g., of a weighing system. The weight can be monitored by at least one weight sensor. For example, a weight sensor can be situated at the bottom of the buffer reservoir. The weight sensor(s) can be part of a weighing system (also herein “weight assembly,” “weight system assembly,” or “scale”). The weight sensor can be situated between the bottom of the buffer reservoir and the base. The weight sensor can comprise a pressure sensor. The weight sensor may comprise a spring scale, a hydraulic scale, a pneumatic scale, or a balance. At least a portion of the pressure sensor can be exposed on a bottom of the buffer reservoir. In some cases, the at least one weight sensor can comprise at least one button load cell, e.g., load cell(s) disposed below the buffer reservoir. The buffer reservoir may be disposed horizontally such that (e.g., all) the load cell(s) are within the horizontal cross section of the buffer reservoir's floor. Alternatively, or additionally a sensor can be configured to monitor the weight of the powder by monitoring a weight of a structure that contains the powder, e.g., the buffer reservoir. One or more position sensors (e.g., height sensors) can measure the height of the powder in the buffer reservoir. The position sensors can be optical sensors. The position sensors can determine a distance between one or more energy sources and a surface of the powder in the container. The sensor may comprise a guided wave radar, e.g., configured to measure an amount of material within the container. Examples of materials, 3D printers, associated methods, software, systems, apparatuses, and devices sensors such as a guided wave radar (GWR), can be found, can be found in International Patent Application Serial No. PCT/US2022/053881, filed Jan. 20, 2023, titled “MATERIAL DETECTION, CONVEYANCE, AND CONDITIONING SYSTEMS,” which is entirely incorporated herein by reference.

In some embodiments, the buffer reservoir and/or weighting system are configured for self-maneuvering. In an example, the weighing system comprises a maneuvering device (e.g., comprising wheels) that facilitate its maneuvering. In an example, the buffer reservoir comprises a maneuvering device (e.g., comprising wheels) that facilitate its maneuvering. The maneuvering device can be controlled, e.g., via remote control.

In some embodiments, the buffer reservoir (e.g., containing the new powder) is disposed on a weighing system, e.g., a scale. The buffer reservoir may be held by a top plane of the weighting system. The buffer reservoir may be aligned by the top plane. In an example, the top plane may comprise one or more supports configured to align the buffer reservoir with respect to the top plane. The top plane may be included in a weighing system. The weighing system may comprise one or more load cells. The weighing system may comprise one or more sensors, e.g., as disclosed herein. The weighing system may comprise a maneuvering device (e.g., wheels), e.g., as disclosed herein. The support(s) may comprise a curved section (e.g., portion) or a non-curved section (e.g., portion). The supports can comprise a curved portion, e.g., be curved. The supports can comprise a non-curved portion, e.g., be non-curved. The supports can comprise a curved plane. The support can comprises a stud. The support can comprise a cylinder. The support can comprise a stopper, e.g., configured to hinder lateral movement of the buffer reservoir. The supports can be configured to respectively match an external shape of a portion of the buffer reservoir. In an example, the supports are parts of a cylinder, and are configured to match (e.g., and support) the cylindrical portion of a buffer reservoir. The top plane may comprise a central aligner. The central aligner may comprise a depression or a protrusion with respect to the exposed surface of the top plate. The buffer reservoir may be configured to engage with the support(s) and/or with the central aligner. The central aligner may be configured to align the center of the buffer reservoir with the center of the top plane such as with a center of the top plane. The central aligner may be configured to align the center of the buffer reservoir with a position at a prescribed distance from the support(s). The central aligner may be configured to align the center of the buffer reservoir with a position of the top plane such that a floor of the buffer reservoir will be disposed in an exposed surface of the top plane. The top plane may be disposed above a mounting plate and/or above the load cell(s). The weighing system may comprise a mounting plate, load cell(s), a top plate, or a maneuvering device. The maneuvering device may be configured to translate the weighing system (with or without the buffer reservoir) about a surface such as a floor. The maneuvering device may comprise wheel(s) or actuato(s). In an example, a wheel is operatively coupled with an actuator. The actuator may manually and/or automatically cause translation of the mounting device, or a component thereof such as a wheel. The actuator may be automatically controlled, e.g., by controller(s). The actuator may be configured for wireless and/or remove communication. Remove communication may comprise (i) communication within the facility in which the maneuvering device is disposed, or (ii) communication outside of the facility in which the maneuvering device is disposed. The load cells may be symmetrically related, e.g., in at least a Cn rotational symmetry, with the rotational axis running (e.g., substantially) along a height of the buffer reservoir and in the middle of the horizontal cross section of the buffer reservoir's floor, and n being the number of load cells. For example, when there are three load cells, they are related in a C3 symmetry, with the symmetry axis running normal to the top. The Cn symmetry axis can go through a location in the top plate above which the center of the horizontal cross section of the buffer reservoir's floor is (e.g., substantially) intended.

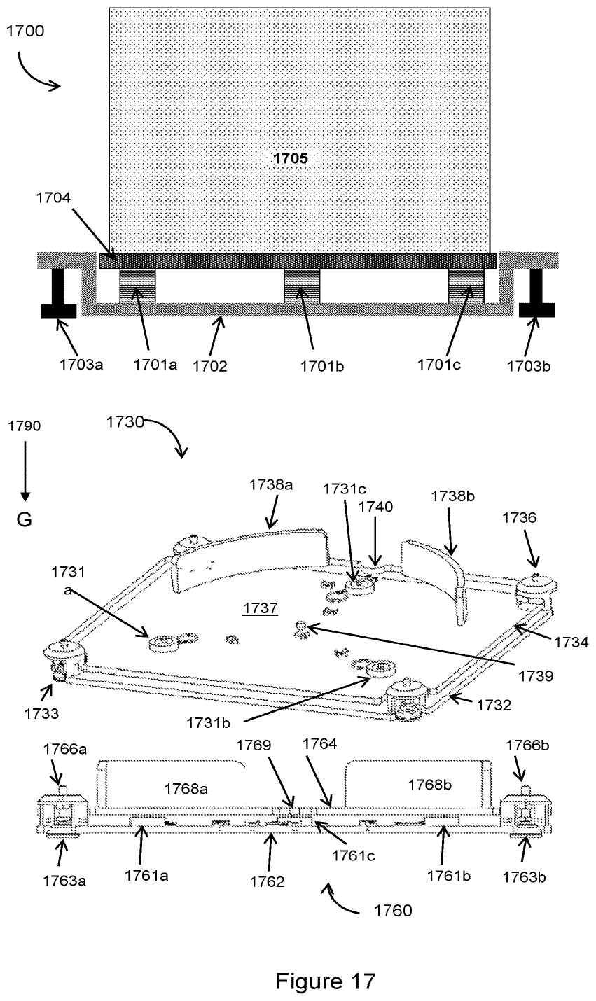

FIG. 17 shows various view examples of a weighting system and associated components arranged with respect to gravitational 1790 pointing to the gravitational center of the ambient environment external to buffer reservoir 1705. Example 1700 shows a schematic front view of a weighing system comprising load cells 1701a, 1701b, and 1701c. The load cells are disposed on mounting plate 1702 (e.g., scale frame) configured to engage with feet 1703a and 1703b. The feet are configured for disposition on a surface such as a floor. Load cells 1703a-c are configured to support top plate 1704, that is configured to support buffer reservoir 1705. Any of the feet can be adjustable, e.g., to level (i) mounting plate 1702, (ii) top late 1704, and/or (iii) floor of buffer reservoir 1705. A feet may be adjustable manually and/or automatically, e.g., using a controllable actuator such as a servo-motor. Example 1730 shows a schematic perspective view of a weighing system comprising load cells 1731a, 1731b, and 1731c shown in this example through top plate 1734 that is transparent, e.g., for didactive purposes. Load cells 1731a-c are disposed on mounting plate 1732 (e.g., scale frame) configured to engage with feet such as foot 1733. Load cells 1733a-c are configured to support top plate 1734, that is configured to support a buffer reservoir (not shown). Any of the feet can be adjustable, e.g., to level (i) mounting plate 1732, (ii) top late 1734, and/or (iii) floor of buffer reservoir (not shown). The feet can be operatively coupled with adjusters such as 1736. The adjuster can be operatively coupled, or include, the actuator. Top plate 1734 comprises top surface 1737 (with respect to gravitational vector 1790) to which two supports 1738a and 1738b are coupled. The supports can be configured to support the buffer reservoir. In the example shown in 1730, the supports comprise curved planes that are parts of a cylinder configured to hold a cylindrical portion of the buffer reservoir. Top plate 1734 comprise optional aligner 1739 configured to align top plate 1734 with mounting plate 1732. In some embodiments, the top plate may comprise an aligner configured to align the buffer reservoir on top plate 1734, e.g., (i) at its center, (ii) with respect to supports and/or (iii) with respect to the load cells. In the example shown in FIG. 17, optional aligner 1739 is in the form of a receptacle. Top plate 1734 comprises depression 1740 configured to accommodate one or more cables, e.g., electrical cables (not shown). Example 1760 shows a schematic side view of a weighing system comprising load cells 1761a, 1761b, and 1761c. Load cells 1761a-c are disposed on mounting plate 1762 (e.g., scale frame) configured to engage with feet such as feet 1763a and 1733b. Load cells 1763a-c are configured to support top plate 1764 that is configured to support buffer reservoir (not shown). Any of the feet can be adjustable, e.g., to level (i) mounting plate 1762, (ii) top late 1764, and/or (iii) floor of buffer reservoir (not shown). Any (e.g., each) of the feet can be operatively coupled with a respective adjuster. For example, foot 1763a is operatively coupled with adjusted 1766a, and foot 1763b is operatively coupled with adjuster 1766b. Two supports 1768a and 1738b are coupled with top plate 1764. The supports can be configured to support the buffer reservoir. In the example shown in FIG. 17, optional aligner 1769 is in the form of a receptacle. Top plate 1764 comprises optional aligner 1769 aligning top plate 1764 with mounting plate 1762.

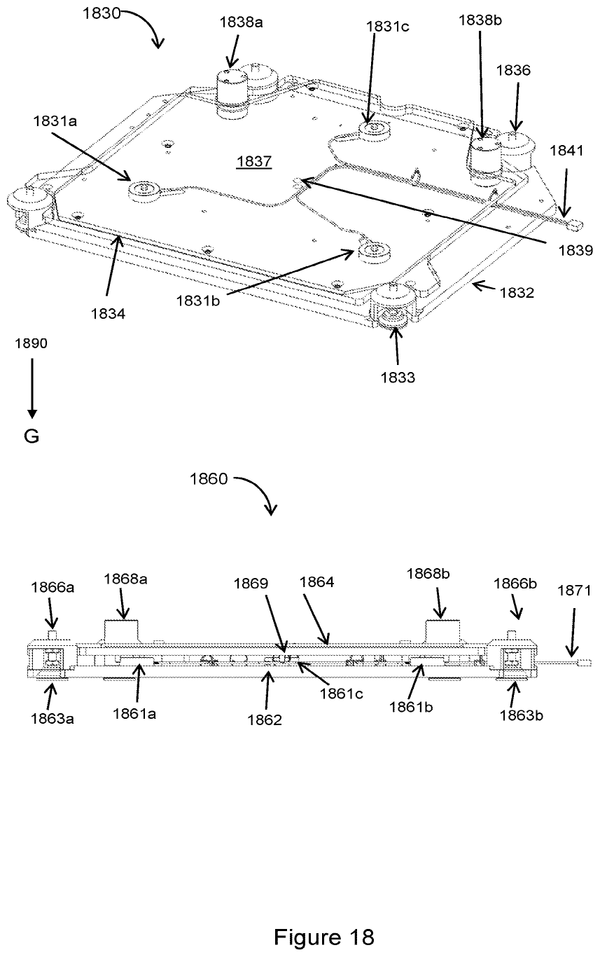

FIG. 18 shows various view examples of a weighting system and associated components arranged with respect to gravitational 1890 pointing to the gravitational center of the ambient environment external to buffer reservoir 1805. Example 1830 shows a schematic perspective view of a weighing system comprising load cells 1831a, 1831b, and 1831c shown in this example through top plate 1834 that is transparent, e.g., for didactive purposes. Load cells 1831a-c are disposed on mounting plate 1832 (e.g., scale frame) configured to engage with feet such as foot 1833. Load cells 1833a-c are configured to support top plate 1834, which is configured to support a buffer reservoir (not shown). Load cells 3733a-c are connected with wiring 1841, e.g., to a control system (now shown). Any of the feet can be adjustable, e.g., to level (i) mounting plate 1832, (ii) top late 1834, and/or (iii) floor of buffer reservoir (not shown). The feet can be operatively coupled with adjusters such as 1836. The adjuster can be operatively coupled, or include, the actuator. Top plate 1834 comprises top surface 1837 (with respect to gravitational vector 1890) to which two supports 1838a and 1838b are coupled, e.g., cylindrical studs. The supports can be configured to support the buffer reservoir. In the example shown in 1830, the supports comprise cylinders. Top plate 1834 comprise optional aligner 1839 configured to align top plate 1834 with mounting plate 1832. In the example shown in FIG. 18, optional aligner 1839 is in the form of a receptacle. Top plate 1834 comprises depression 1840 configured to accommodate one or more cables, e.g., electrical cables (not shown). Example 1860 shows a schematic side view of a weighing system comprising load cells 1861a, 1861b, and 1861c. Load cells 3761a-c are connected with wiring 1871, e.g., to a control system (now shown). Load cells 1861a-c are disposed on mounting plate 1862 (e.g., scale frame) configured to engage with feet such as feet 1863a and 1833b. Load cells 1863a-c are configured to support top plate 1864 configured to support a buffer reservoir (not shown). Any of the feet can be adjustable, e.g., to level (i) mounting plate 1862, (ii) top late 1864, and/or (iii) floor of buffer reservoir (not shown). Any (e.g., each) of the feet can be operatively coupled with a respective adjuster. For example, foot 1863a is operatively coupled with adjusted 1866a, and foot 1863b is operatively coupled with adjuster 186b. Two supports 1868a and 1838b are coupled with top plate 1864. The supports can be configured to support the buffer reservoir. Top plate 1864 is coupled with optional aligner 1869 aligning top plate 1864 with mounting plate 1862.

FIG. 17 shows dependency of oxygen pickup as a function of number of objects built. The oxygen pickup of new powder introduced in batches (e.g., batch loading), is compared with new powder introduced continuously (e.g., continuous loading).

In some embodiments, powder is recycled in a recycling system that is part of, or is operatively coupled with, the three-dimensional printing system. As, as powder cycles through a powder conveyance system of a 3D printer, the powder surface may gradually react with reactive agent (e.g., oxidize) present in the internal atmosphere of the 3D printer. For example, when the powder flows in sections of dilute phase powder conveyance. Without wishing to be bound to theory, the reaction of the powder with the reactive agent(s) may be triggered by collision of powder particles, e.g., in the section(s) of the powder conveyance system in which the powder flows in a higher velocity as compared to other section(s) of the powder conveyance system. The sections of the powder conveyance system in which powder flows in higher velocity may comprise the powder conveyance loop of a 3D printer, e.g., including the layer dispenser (e.g., recoater) loop. Without wishing to be bound to theory, the high velocity collisions of particles with each other and/or particles with wall(s) of powder conveyance channels (such as in corners) may cause plastic deformations at the impact points. The impact points of the powder particle may comprise surface defect(s). The surface defect(s) may comprise a dislocation, a tear, or a (micro) crack. The surface of the particle may comprise a reaction product such as oxide, or a hydride. The defect(s) may allow reactive agent to infiltrate, penetrate and/or diffuse, through the inert surface of the particle (e.g., surface oxide). The reactive agent may comprise oxygen, hydrogen, water, or hydrogen sulfide. The inert surface may act at least in part as a protective surface. The inert surface may be inert with respect to reaction with the reactive agent. The reaction may be during flow of the powder in the powder conveyance system. The reaction may be during printing. The defect(s) may facilitate (e.g., allow) the reaction with the reactive agent to occur in deeper portions the particle away from the surface of the particle and closer to the center of the particle. The defect(s) may cause infiltration (and reaction) in the interior of the powder particle, e.g., even at low levels of reactive agent such as levels of the reactive agent lower than that in the ambient atmosphere external to the 3D printer. The lower levels can be lower it at least about 1, 2, 3, or 4 orders of magnitude. In an example, oxygen reacts with Titanium powder as the powder propagates in the 3D printer from it being dispensed to generate a layer of powder material as part of the powder bed, through its recycling, and back into its deposition to generate a layer of powder material as part of the powder bed, causing the powder to increase in about 3.6 ppm. Such accumulation may generate a gradient of reaction product (e.g., metal oxides) in the printed 3D object. In an example, the rate of oxygen pickup rate can initiate at 25 ppb/layer and reach 100 ppb/layer at the end of a print cycle of a 3D object, e.g., having at least about 10,000 layers, 25,000 layers, 50,000 layers, 80,000 layers or 100,000 layers. Controlling the extent of reaction of the powder with the reactive agent can be by reduction of concentration of the reactive agent in at least a portion of the 3D printer's interior, e.g., in its material conveyance system. The infiltration (and reaction) of the reactive agent to the particle's interior may compromise such way of controlling the extent of the reaction of the reactive agent with the powder, e.g., oxidation reaction. Attenuating (e.g., slowing) the velocity of powder particles during their flow may affect the reaction rate of the powder with the reactive agent. However, it may not be practical to reduce the velocity of the particles carried in the flow to a level that would hinder (e.g., prevent) the plastic deformation from occurring in a way that would enable and/or promote formation of the defects. For example, the threshold for plastic deformation affecting the generation of defects may be lower than typical velocities required for conveyance of the powder in the channels, e.g., by dilute powder phase conveyance. New powder may be (e.g., continuously) loaded into the 3D printing, e.g., during printing. The rate of new powder addition may be (e.g., substantially and/or measurably) equal to the amount of powder loss during and/or as consequence of the printing. Such operation of new powder introduction into the powder conveyance system may result in reaching a steady state of reaction product of the powder with the reactive agent(s) with the powder. The steady state of reaction product may result in lack of (e.g., substantial and/or measurable) gradient of reaction product (e.g., metal oxides) in the resulting 3D object. The steady state for reactive product may comprise an accumulation of at most about 100 ppm, 200 ppm, 300 ppm, or 500 ppm. The reactive product may comprise reaction of the powder with the reaction agent (e.g., oxygen, water, hydrogen, or hydrogen sulfate). The reaction product may be measure according to a marker, e.g., oxygen, hydrate, hydroxide, or bisulfide. The steady state for reactive product may comprise accumulation of at least about 0.2 times (*), 0.25*, 0.3*, 0.4*, 0.5*, or 0.6*the rate of reactive produce accumulation in the powder as compared to a situation in which the new material was not introduced (e.g., continuously) during the printing, and rather introduced at the initiation of a printing cycle. The symbol “*” designates the mathematical operation “times.” The loss of powder may result from: (a) deposition in the powder bed to generate the printed part, and (b) generation of debris. The debris may comprise particulate matter having a FLS smaller than the powder, e.g., comprising soot, smaller spatter, or small splatter. The debris particulate matter having a FLS smaller than the powder may be lost as they accumulate in (and removed by) the gas conveyance system filter(s). The debris particulate matter having a FLS larger than the powder may be lost as they accumulate in (and removed by) the sieve trash reservoir. The percentage (v/v) of powder loss may be at least about 5%, 10%, 20%, 30% or 50% relative to the total volume of the powder bed. The percentage (v/v) of powder loss may be between any of the aforementioned values, e.g., from about 5% to about 50% relative to the total volume of the powder bed. In the steady state, the maximum amount of reaction product (e.g., metal oxides) may be maintained at a level of at most about 500 ppm, 600 ppm, 800 ppm, 1000 ppm, 1300 ppm, 1500 ppm, or 2000 ppm. In the steady state, the maximum level of reaction product (e.g., metal oxides) may be maintained at a level between the aforementioned levels, e.g., from about 500 ppm to about 2000 ppm. Maintaining the powder to be used as starting material at the maximum level of reaction product may be for continuous use of the 3D printer for at least about 1 week, 2 weeks, 4 weeks, 1 month, 3 months, 6 months, 9 months, 1 year, 1.5 years, 2 years, or 5 years. The powder used in the 3D printer may comprise the recycled powder and additional powder compensating for powder lost, e.g., during the printing. Maintaining the powder used as starting material at the maximum level of reaction product may be for continuous use of the 3D printer for any time value between the aforementioned time values (e.g., from 1 week to 5 years).

In some embodiments, the powder reacts with a reactive agent (e.g., oxygen, or water) present in the internal atmosphere of the 3D printer to generate a reaction product (e.g., oxide, or hydride). Such reaction (e.g., surface and/or interior reaction of the powder with the reactive agent) may result in increased level of reactive product in the printed 3D object and/or reduced flowability of the powder (contaminated with the reactive product) in the powder conveyance system, e.g., in the channels thereof. The requested 3D object may have a maximum tolerance (e.g., threshold) requested for the reaction product (e.g., metal oxide) contaminant. In some embodiments, the powder may react with the reactive product in each recycling cycle and thus increase a percentage of the reaction product content in the powder. Such increased reaction product (e.g., oxide) contaminant in the powder utilized as starting material for 3D printing may result in a 3D object having a reaction product (e.g., oxide) content beyond the maximum tolerance requested. Such (e.g., gradual) increase in the content of reaction product in the powder may lead to (e.g., respective gradual) increase in the content of the reaction product in the 3D object. For example, the 3D object may have a (e.g., continuous) gradient of reaction product contaminate in the 3D object, e.g., the reaction product contaminant in an earlier printed layer may have less reaction product contaminant than a later printed layer of the 3D object, e.g., since its starting material has undergone more recycling cycles leading to more accumulation of reaction product in the powder, the reaction product being with the reactive agent present in the internal atmosphere. The reaction rate with the reactive agent may depend on the material type of the powder, e.g., on the metal comprising elemental metal or metal alloy. Some powder (e.g., GRCOP42 alloy) show reduced reaction (e.g., oxidation) relative to other powder such as Titanium or Inconel 718. The recycled powder can increase in an average of at least about 0.5 ppm, 1 ppm, 2 ppm, 2.5 ppm, or 5 ppm in each powder recycling round. For example, oxidization of Titanium powder occurs at a rate of approximately 2.5 ppm addition of oxide each time the powder cycles from the powder reservoir feeding the layer dispensing mechanism, and back to the recycling system ending in the reservoir that feeds the layer dispensing mechanism. Such accumulation of metal oxide may translate to about 40 ppb increase in metal oxide per layer printed. If the same powder is utilized (e.g., as recycled powder) over the course of 3 to 4 building cycles, the recycled powder may exceed the requested oxide limit (e.g., measured as oxygen content limit) content in the resulting 3D object therefrom. In addition to the oxidation, a similar process may allow the infiltration of water into the particle's interior in some materials (e.g., Aluminum alloys) resulting in hydrogen porosity formation. To counteract the effect of reaction product with the reactive agent (e.g., oxygen, hydrogen, and/or water) reacting with the powder, the recycled powder may be supplemented (e.g., diluted) with new (e.g., fresh) powder. Such supplementation can keep the powder stock at sufficiently low reaction product level to comply with its requested levels in the resulting 3D object, the powder stock being utilized as the starting material for the 3D printing.

In some embodiment, a loss of powder occurs during the printing process. The loss of powder may comprise consumption or departure (e.g., attrition) of the powder. During printing, some of the powder may be converted to debris. During printing, powder particles may fuse, coagulate, and/or agglomerate to form debris that does not form part of the 3D object. For example, soot, spatter, and/or splatter may be generated during the printing process as the energy beam irradiates the powder. During recycling, powder may erode, e.g., as it flows in the powder reconveyance system and its associated components such as the recycling system. Such loss of powder may be anticipated and/or predetermined. The loss of powder may pose an opportunity to supplement the recycled powder stock with new (e.g., fresh) powder. In this manner, the powder stock may be supplemented with powder that has a lower content of reaction product (e.g., metal oxide) as compared to powder that has been recycled. Supplementing the recycled powder with the new powder may overall slow down the degradation of the powder that contains an increased level of reaction product. The powder degradation may comprise degradation occurring during cycling of the remainder powder from the powder bed, to the recycling system, and back to be deposited as part of the powder bed. The degradation may result in reduced flowability of the powder. The degradation may result in reduction in a central tendency of the FLS of the powder particles, e.g., reduced particle size distribution drift. The degradation may be due to reaction of at least a portion of the powder with the reactive agent, e.g., oxidation of metals with oxygen to generate a metal oxide. The degradation may comprise an alteration of the physical and/or chemical surface of the powder particles. The rate of (a) reaction product generation during recycling, (b) powder consumption during the 3D printing process, and (c) supplementation of new powder, may reach a steady state in the level of reaction product. The steady sate of reaction product in the powder stock used as a starting material for a 3D print may allow printing 3D object(s) within the requested reaction product tolerance (e.g., maximum threshold).

In some embodiments, new powder is supplemented to recycled powder, e.g., to be used as starting material for a 3D printing operation. The new powder may be continuously, semi-continuously, or intermittently supplemented. Semi-continuous conveyance refers to conveyance of (e.g., new) powder when there is a powder loss. Semi continuous conveyance may be referred to in “just in time conveyance.” Semi continuous conveyance may react to real time powder loss in the system, e.g., as the powder loss is detected by the control system, e.g., by the one or more sensors measuring the powder level. The sensor(s) (e.g., as disclosed herein) may measure the amount of powder directly in the various powder reservoirs as part of, or operatively coupled with, the powder conveyance system. The new powder may be supplemented such that the steady state in the level of reaction product is obtained, e.g., such that the reaction product in the powder stock used as a starting material for a 3D print may allow printing 3D object(s) within the requested reaction product tolerance (e.g., maximum threshold). The added new powder may be mixed into the recycled powder, e.g., to (e.g., substantially) homogenously distribute the new powder in the recycled powder. The mixing scheme may differentiate, e.g., depending at least in part on the manner the powder is removed during and/or after the printing. The powder removal may comprise (a) using a wand to attract the powder (e.g., vacuum wand), (b) powder removed by the remover as part of the layer dispensing mechanism, or (c) other kind of powder removal. The semi continuous powder conveyance may supplement new powder to compensate for powder loss in the powder circulation system. The powder loss may amount of at most about 0.5%, 1%, 3%, or 5% of the powder recirculating in the powder conveyance system, e.g., in a cycle of layer deposition to generate the powder bed, followed by the remainder powder's recycling and ready for a subsequent layer deposition.

In some embodiments, a buffer reservoir may be coupled with a pneumatic material conveyance system. The buffer reservoir may be utilized for loading the new powder. The buffer reservoir may comprise a hopper. New (e.g., fresh) powder may be provided to the buffer reservoir from external source. The buffer reservoir may be purged with robust gas before the new powder may be (a) inserted into the buffer reservoir, and/or (b) added to the recycled powder reservoir. The robust gas may comprise an inert gas. The robust gas may comprise at least one reactive agent at a concentration lower than its concentration in the ambient atmosphere external to the buffer reservoir, e.g., and external to the 3D printer. The addition of the new powder from the buffer reservoir into the recycled material reservoir may be continuous or intermittent. The amount of new powder added may be estimated and/or predetermined, e.g., by the control system of the 3D printer. The amount of new powder to be supplemented may depend on the 3D object(s) printed during a printing cycle. The control system may estimate the amount of powder (a) in the build module and (b) in one or more powder reservoirs of the 3D printing system. The control system my direct addition of supplemented new powder to keep the total powder in the 3D printer at a constant level.

In some embodiments, new (e.g., fresh) powder may be added to a powder conveyance system of a 3D printer. The new powder may be disposed in a container, e.g., placed on a floor. The new powder may flow to (e.g., refill) a reservoir manually and/or automatically, e.g., using at least one controller such as the control system of the 3D printer. In an example, the new powder flows to a reservoir pneumatically. The pneumatic flow of powder may be done automatically, e.g., without user intervention. A user may manually alter a state of an external pneumatic powder conveyance to an “on” state, to flow (e.g., refill) the new powder into the buffer reservoir. Alteration of the state may comprise toggling the state, e.g., by toggling a valve. The buffer reservoir may be disposed away from the floor, e.g., upwards in a direction against the gravitational vector pointing towards the gravitational center of the environment. The powder conveyance system may be able to be loaded with sufficient powder to enable its (e.g., autonomous) operation for at least about 6 hours (h), 6 h, 12 h, 24 h, 48 h, 60 h, 72 h, 84 h, 96 h, 108 h, or 120 h. In some embodiments, the powder conveyance system meets the safety standards in one or more jurisdictions, e.g., regarding harm such as due to powder combustion. A harmful event may occur in the event of a harmful reaction. Harmful may be to the user, to the 3D object, to equipment, and/or to the facility. The harmful event may comprise combustion, ignition, flaring, fuming, burning, bursting, explosion, eruption, smelting, flaming, explosion, or any other safety violation per jurisdictional standards. Such harm is exacerbated the larger the 3D object printed becomes, e.g., by requiring use of a larger powder bed comprising a larger amount of powder. The one or more jurisdictions may comprise the jurisdiction in which the printer is manufactured, or the jurisdiction in which the printer operates. The mechanism utilized to add the new powder to the powder conveyance system to supplement the recycled powder may be utilized to introduce powder to the printer when the printer is empty of powder, e.g., when the printer is in its initial state with respect to the powder. Introduction of the powder into the 3D printer to initiate print may take at most about 0.5 hour (h), 1 h, 2 h, or 3 h. The rate of adding the new powder to the recycled powder may be (e.g., substantially) equal to the rate of powder loss during operation such as during the printing. The addition of new powder volume may be at least about 0.01%, 0.02%, 0.03%, 0.05%, 0.08%, or 0.1% from a volume of a planar layer of powder utilized for the 3D printing. The addition of new powder volume may be at most about 0.02% 0.03%, 0.05%, 0.08%, 0.1%, 0.12% or 0.15% from a volume of a planar layer of powder utilized for the 3D printing. The addition of new powder volume may be between any of the aforementioned values relative to the volume of the planar layer of powder utilized for the 3D printing, e.g., from about 0.01% to about 0.15%, or from about 0.02% to about 0.1%. The new powder may be introduced to the recycled powder at one or more locations along the powder conveyance system. The new powder may be introduced into the sieve, separator (e.g., cyclone) channel, and/or to any reservoir (e.g., hopper).

In some embodiments, new powder may be introduced into the buffer reservoir. The buffer reservoir may or may not be in an atmosphere more inert that that of the ambient environment external to the buffer reservoir. For example, the buffer reservoir may comprise a robust gas. The buffer reservoir and/or the compartment of the powder conveyance system in which the new powder is introduced, may comprise one or more sensors for the reactive agent(s). The one or more sensors may comprise an oxygen sensor, a humidity sensor, a hydrogen sensor, or a hydrogen sulfide sensor. Prior to introduction of the new powder into the powder conveyance system, the new powder may be flushed and/or purged with the robust gas. In an example, the new powder is flushed and/or purged in the buffer reservoir. The buffer reservoir (e.g., with the new powder) may contain environmental conditions (e.g., substantially) similar to those in the powder conveyance system and/or in the processing chamber. For example, the pressure in the buffer reservoir may be different than that in the ambient environment, e.g., the pressure may be an overpressure such as the overpressure (e.g., positive pressure) disclosed herein.

In some embodiments, new powder is added to recycled powder continuously or intermittently, e.g., before, during, and/or after the printing. The powder may be added to the powder conveyance system. The powder may be added from a buffer reservoir into the rest of the powder conveyance system such as to any one or more of its components. The new powder may be added from the buffer reservoir to a receiving component of the powder conveyance system. The receiving component may comprise (a) a reservoir holding recycled powder, and/or (b) the channels of the powder conveyance system. In an example, the new powder is added to a reservoir (e.g., doser) conveying recycled powder to the material dispensing mechanism (e.g., dispenser). Introducing the new powder may be manually and/or automatically. In an example, the new powder may be introduced by turning on the powder conveyance system, e.g., by streaming gas into the powder conveyance system. The gas may be a robust gas, e.g., as disclosed herein. The reservoir (e.g., doser) conveying recycled powder to the dispenser may hold at most about 25 cc, 30 cc, 50 cc, 80 cc, or 100 cc of powder. Introducing the new powder into the receiving component of the powder conveyance system may comprise adjusting one or more characteristics of the internal atmosphere of: the buffer reservoir and/or the receiving component. The adjustment may be to match the atmosphere of the processing chamber, e.g., presiding in the processing chamber at least during the printing.

The one or more characteristics of the atmosphere may comprise temperature, pressure, or reactive agent(s) level. The one or more characteristics of the atmosphere may by any disclosed herein. The temperature may be adjusted to the ambient temperature. The pressure may be adjusted to an overpressure. The reactive agent(s) level may be adjusted to lower than their level in the ambient atmosphere (e.g., external to the powder conveyance system, and/or to the 3D printer). In some embodiments, at least one characteristic of the internal atmosphere of the receiving component and/or the buffer reservoir, are (e.g., substantially) the same as that respective at least one characteristic presiding in the internal atmosphere of the processing chamber at least during the printing. At least during the printing may include before the printing and/or after the printing. For example, the level of reactive agent(s) of the internal atmosphere of the receiving component and/or of the buffer reservoir, may be (e.g., substantially) the same as the reactive agent(s) level presiding in the internal atmosphere of the processing chamber at least during the printing. In an example, the level of oxygen of the internal atmosphere of the receiving component and/or of the buffer reservoir, is (e.g., substantially) the same as the oxygen level presiding in the internal atmosphere of the processing chamber. In some embodiments, at least one characteristic of the internal atmosphere of the receiving component and/or the buffer reservoir, are different from respective at least one characteristic presiding in the internal atmosphere of the processing chamber at least during the printing. For example, the pressure of the internal atmosphere of the receiving component and/or of the buffer reservoir, may be different from the pressure of the internal atmosphere of the processing chamber at least during the printing. In an example, the pressure of the internal atmosphere of the receiving component and/or of the buffer reservoir, is different (e.g., lower) than the pressure of the internal atmosphere of the processing chamber. A pressure differential between the receiving component of the powder conveyance system and the buffer reservoir may aid in conveying the new powder from the buffer reservoir to the receiving component. One or more characteristics of the buffer reservoir's internal atmosphere may be adjusted to that respective one or more characteristics presiding in the atmosphere of the processing chamber atmosphere at least during the printing. At least one characteristic of the receiving component's internal atmosphere may be adjusted to the respective one presiding in the processing chamber atmosphere presiding therein at least during the printing. For example, the channel's atmosphere may be adjusted to that of the processing chamber atmosphere presiding therein at least during the printing. The amount of the new powder added to the receiving component (e.g., per printed layer) may be adjusted based at least in part on measured level of powder it at least one component of the powder conveyance system (e.g., reservoir) experiencing depletion during the printing. The at least one component of the powder conveyance system experiencing the powder depletion can be the same or different from the receiving component. The adjustment may be using one or more sensors. The one or more sensors may comprise a powder level sensor. The powder level sensor may comprise an optical sensor or a sonic sensor. The powder level sensor may comprise a proximity sensor. The powder level sensor may comprise a guided wave radar (GWR) sensor. The GWR sensor may comprise (a) an internal component (e.g., rod) configured to guide preparation of the radar waves and (b) an external component encasing the internal component, distanced from the internal component by a gap. The external component may be porous, e.g., to allow the powder to enter into and exit from the intermediate space disposed between the internal and external components. Entrance and exit of the powder relative to the intermediate space of the GWR may allow the powder level to equilibrate between its level in the rest of the reservoir and its level in the intermediate space.

In some embodiments, powder is missed during operation in the 3D printing system. For example, powder can be mixed as it is transferred in the channel(s) of the powder conveyance system, e.g., in dilute phase powder conveyance. In some embodiments, the 3D printing system (also herein, 3D printer), comprises a powder mixer. The powder mixer may comprise a cyclone, a sieve, or a material dispensing mechanism (e.g., as part of the layer dispensing mechanism). The powder may be mixed during the recycling process. The volume of powder mixed during a printing cycle may be at least about the volume of the powder bed, e.g., as disclosed herein. The volume of powder mixed during a printing cycle may be at least about the volume occupied by the powder in the build module, e.g., as disclosed herein. The volume of powder mixed during a printing cycle may be at least about 100 cubic centimeters (cc), 200 cc, 500 cc, 800 cc, 1000 cc, 1500 cc, or 2000 cc. The volume of powder mixed during a printing cycle may be between any of the aforementioned values, e.g., at least about 100 cc to about 2000 cc. The volume of powder mixed during a printing cycle may be at least about the volume occupied by the powder in the powder reservoirs of the 3D printer. The volume of powder mixed during a printing cycle may be at least about 10 Liters (L), 50 L, 60 L, 80 L, 100 L, 150 L, 200 L, 250 L, or 500 L. The volume of powder mixed during a printing cycle may be between any of the aforementioned values, e.g., at least about 10 L to about 200 L. The volume of powder mixed during a printing cycle may be at least about the volume removed by the powder remover, e.g., and conveyed by the remover to recycling. The volume of powder removed by the powder remover may be at least about 0.1 Liter (L), 0.25 L, 0.5 L, 0.75 L, 1 L, 2 L, 4 L, or 10 L for every deposited planar layer utilized for the 3D printing. The volume of powder mixed during removal process as part of depositing a planar layer utilized for the 3D printing may be between any of the aforementioned values, e.g., at least about 0.1 L to about 10 L.

The 3D printing system may comprise one or more components to facilitate the addition of new powder during the printing, e.g., and the mixing of the new powder with the recycled powder. The one or more additional components may comprise a buffer reservoir, a venturi valve, a dosing valve, a weight scale, sensor, or connection to robust gas. The powder may be delivered through the venturi valve coupled to the buffer reservoir (e.g., as in FIG. 16, 1602). Delivery of the powder may depend at least in part on entrance of robust gas into the venturi valve (e.g., FIG. 16, 1603). The robust gas (e.g., Argon) may flow into the venturi valve to deliver pulses of the new powder into the rest of the powder conveyance system. The flow may be continuous or intermittent. The powder may be delivered into the rest of the powder conveyance system (a) directly into a channel, (b) into the sieve reservoir, (c) into another separator (e.g., cyclone), (d) into a reservoir (e.g., hopper), (e) into the material dispensing system (e.g., powder dispenser), or (f) any combination thereof. In an example, when the robust gas does not flow into the venturi valve, powder will not be introduced from the buffer reservoir, through the venturi valve, and into the rest of the powder conveyance system. In an example, when the robust gas flows continuously into the venturi valve, powder will flow continuously through the venturi valve into the rest of the powder conveyance system. In an example, when the robust gas flows intermittently (e.g., pulse) into the venturi valve, powder will flow intermittently (e.g., pulse) through the venturi valve into the rest of the powder conveyance system. One or more controllers (e.g., any controllers disclosed herein) may be operatively coupled to the gas source delivering the robust gas into the venturi valve coupled to the buffer reservoir. For example, a rate of robust gas pulsation can is controlled by opening the Argon for a set period at a set frequency. The frequency or open time period can be adjusted based at least in part on the long term error accumulation of the amount of recycled powder in the reservoirs vs. the target amount or recycled powder required for the next layer deposition, e.g., as calculated by the controller(s). A weighting system (e.g., scale) and/or powder level sensor(s) can be coupled with the buffer reservoir (e.g., new powder reservoir), e.g., to facilitate assessment of the amount of new is present in the buffer reservoir. Determination (e.g., in real time) and/or estimation (e.g., ahead of time) of the powder loss may aid at least in part in directing timing of new powder addition, and/or the amount of new powder addition. The buffer reservoir can be reversibly detachable and attachable to the rest of the powder conveyance system. The buffer reservoir can be replaced by another buffer reservoir containing new powder (e.g., another batch of new powder). The buffer reservoir may be a standard new powder reservoir. The buffer reservoir may or may not comprise (a) reactive agent(s) sensor(s) or (b) powder level sensor(s). The buffer reservoir may or may not be hermetically sealed. The buffer reservoir may or may not be configured to enclose a pressure different (e.g., above) ambient pressure.

In some embodiments, the 3D printing system may comprise a control system. The control system may comprise one or more controllers. The control system may comprise, or be operatively coupled with, one or more devices, apparatuses, and/or systems of the 3D printing system, including any component of the device(s), apparatuses(s), and/or system(s). The controllers or control mechanisms (e.g., comprising a computer system) may be programmed to implement methods of the disclosure.

In some embodiments, the 3D printer comprises a controller. The controller may monitor and/or direct (e.g., physical) alteration of the operating conditions of the apparatuses, software, and/or methods described herein. The controller may be a manual or a non-manual controller. The controller may be an automatic controller. The controller may operate upon request. The controller may be a programmable controller. The controller may be programed. The controller may comprise a processing unit (e.g., CPU or GPU). The controller may receive an input (e.g., from a sensor). The controller may deliver an output. The controller may be part of a control system comprising multiple controllers. The controller may receive multiple inputs. The controller may generate multiple outputs. The controller may be a single input single output controller (SISO) or a multiple input multiple output controller (MIMO). The controller may interpret the input signal received. The controller may acquire data from the one or more sensors. Acquire may comprise receive or extract. The data may comprise measurement, estimation, determination, generation, or any combination thereof. The controller may comprise feedback control. The controller may comprise feed-forward control. The control may comprise on-off control, proportional control, proportional-integral (PI) control, or proportional-integral-derivative (PID) control. The control may comprise open loop control, or closed loop control scheme(s). The controller may comprise a closed loop control scheme. The controller may comprise an open loop control scheme. The controller may utilize one or more wired and/or wireless networks for communication, e.g., with other controllers or devices, apparatuses, or systems of the 3D printing system and its components. For example, wired ethernet technologies, e.g., a local area networks (LAN). For example, wireless communication technologies, e.g., a wireless local area network (WLAN). The controller may utilize one or more control protocols for communication, for example, with other controller(s) or one or more devices, apparatuses, or systems of the 3D printing system or any of its components. Control protocols can comprise one or more protocols of an internet protocol suite, e.g., transmission control protocol (TCP) or transmission control protocol/internet protocol (TCP/IP). Control protocols can comprise one or more serial communication protocols. Control protocols can comprise one or more of controller area networks or another message-based protocol, e.g., for communication with microcontrollers and devices. Control protocols can interface with one or more serial bus interfaces for communication with the 3D printing system and its components. The controller may comprise a user interface. The user interface may comprise a keyboard, keypad, mouse, touch screen, microphone, speech recognition package, camera, imaging system, or any combination thereof. The outputs may include a display (e.g., screen), speaker, or printer. Examples of controller, control protocols, control systems, 3D printing systems, apparatuses, devices, and any of their components, and 3D printing processes can be found in International Patent Application Serial No. PCT/US17/18191, filed Feb. 16, 2017, titled “ACCURATE THREE-DIMENSIONAL PRINTING,” which is incorporated herein by reference in their entirety.

Control may comprise regulate, modulate, adjust, maintain, alter, change, govern, manage, restrain, restrict, direct, guide, oversee, manage, preserve, sustain, restrain, temper, or vary.

In some embodiments, the methods, systems, device, software and/or the apparatuses described herein comprise a control system. The control system can be in communication with one or more components of the 3D printing system. The control system can be in communication with one or more components facilitating the 3D printing methodologies. The control system can be in communication with one or more energy sources, optical systems, gas flow system, material flow systems, energy (e.g., energy beams), build platform assembly, and/or with any other component of the 3D printing system.

In some embodiments, the 3D printing system comprises a controller. The controller may include one or more components. The controller may comprise a processor. The controller may comprise a specialized hardware (e.g., electronic circuit). The controller may be a proportional-integral-derivative controller (PID controller). The control may comprise dynamic control (e.g., in real time during the 3D printing process). For example, the control of the (e.g., transforming) energy beam may be a dynamic control (e.g., during the 3D printing process). The PID controller may comprise a PID tuning software. The PID control may comprise constant and/or dynamic PID control parameters. The PID parameters may relate a variable to the required power needed to maintain and/or achieve a setpoint of the variable at any given time. The calculation may comprise calculating a process value. The process value may be the value of the variable to be controlled at a given moment in time. For example, the process controller may control a height of at least one portion of the layer of hardened material that deviates from the average surface of the target surface (e.g., exposed surface of the powder bed) by altering the power of the energy source and/or power density of the energy beam, wherein the height measurement is the variable, and the power of the energy source and/or power density of the energy beam are the process value(s). The variable may comprise a temperature or metrological value. The parameters may be obtained and/or calculated using a historical (e.g., past) 3D printing process. The parameters may be obtained in real time, during a 3D printing process. During a 3D printing process, may comprise during the formation of a 3D object, during the formation of a layer of hardened material, or during the formation of a portion of a layer of hardened material. The calculation output may be a relative distance (e.g., height) of the powder bed (e.g., from a cooling mechanism, bottom of the enclosure, optical window, energy source, or any combination thereof). The controller may comprise a feedback control scheme. The feedback control scheme may comprise an open feedback loop control scheme. The feedback loop control scheme may comprise a closed feedback loop control scheme. Feedback control scheme may comprise hardware compensation. Feedback control scheme may comprise software compensation. Control system may comprise, or be operatively coupled with, a metrological detection system and configured to receive measurement data from the metrological detection system, e.g., height mapper. The control system may be configured to generate control signals responsive to the measurement data collected by the metrological detection system.

In some embodiments, a controller of a 3D printing system comprises a metrological detection system. The metrological detection system may be used in the control of 3D printing processes of the 3D printing system. The metrological detection system may be configured to detect distance variations such as vertical distance variations, e.g., height variations. The metrological detection system may be configured to detect distance variations such as horizontal distance variations, e.g., variations with respect to an XY plane. For example, a horizontal distance variation along an X-axis that is oriented parallel to a direction of translation of a translatable component (e.g., a translation mechanism). For example, a horizontal distance variation along a Y-axis that is orientated perpendicular to the direction of translation of the translatable component (e.g., the translation mechanism) and perpendicular to a gravitational vector. The metrological detection system may be configured to detect a vertical (e.g., height) variations in a planar surface, e.g., a planar exposed surface of a powder bed. The metrological detection system may comprise a height mapper system. The metrological detection system may comprise an interferometric optical system. The metrological detection system may comprise a position sensitive device system. The metrological detection system may comprise an optical detector. The metrological detection system may include, or be operatively coupled with, an image processor. The metrological detection system may comprise an imaging detector to monitor irregularities. The image detector may comprise a camera such as a charged coupled device (CCD) camera. The image detector may comprise detecting a location or an area of the printed 3D object and convert it to a pixel in the X-Y (e.g., horizontal) plane. The image detector may comprise detecting an interference pattern generated by an interferometric beam path. The image detector may comprise detecting position of a beam incident on the image detector relative to an imaging region of the image detector. The controller may comprise one or more computational schemes to convert data (e.g., measurement data) from the metrological detection system to generate a result. The one or more computational schemes may be utilized to determine one or more aspects of the build platform assembly, the optical system, and/or of the target surface, e.g., the exposed surface of the powder bed or the build platform surface. The one or more aspects may comprise positional aspects, or localization aspects. The one or more aspects may be absolute or relative. For example, an aspect can include a physical orientation of a moving component of the build module, the moving component comprising a base, substrate, or build platform assembly, the build module assembly comprising the base (also herein “build platform”). For example, an aspect can include a physical orientation of a moving component of the optical system, e.g., of one or more optical assemblies, energy beam paths, or processing cones incident on the target surface. The physical orientation may comprise a relative orientation (e.g., relative to a requested orientation) or an absolute orientation (e.g., relative to a coordinate axis). For example, an aspect may comprise a relative orientation of the target surface or at least one optical assembly (e.g., a plurality of optical assemblies) with respect to an enclosure (e.g., the processing chamber) with respect to a requested orientation, e.g., characterizing offset value(s) of the position (e.g., XY position) of the optical assembly or target surface from the requested value(s). For example, an aspect may include (a) a height (e.g., along a z-axis) of the target surface, (b) an XY position (c) a rotation of the target surface, or (d) any combination of (a), (b), and (c). The orientation may include (A) pitch or roll (e.g., due to movement around the horizontal axis). The controller may utilize one or more computational schemes to measure a height (e.g., along a z-axis) of the target surface (e.g., a phase shift computational scheme). The controller may utilize one or more computational schemes to measure a position (e.g., about the XY plane). The computational scheme may comprise an algorithm. The controller may utilize a computational scheme comprising a (e.g., digital) modulation scheme that conveys data by changing (e.g., modulating) the phase of a reference signal (e.g., carrier wave). Measurements collected by the metrological detection system may be utilized by one or more controllers, for example, to provide feedback controls to one or more control systems. For example, the one or more controllers may process, or direct processing, the measurements at a time including before, after and/or during the 3D printing process (e.g., in real time). The one or more controllers may be integrated in a control system that controls the 3D printing process (e.g., the recoater, gas flow system, and/or energy beam(s)). The control system may be any control system disclosed herein. For example, the control system may be a hierarchical control system. For example, the control system may comprise at least three hierarchical control levels, e.g., at least three, four, or five control levels.

Methods, apparatuses, and/or systems of the present disclosure can be implemented by way of one or more computational schemes. A computational scheme can be implemented by way of software upon execution by one or more computer processors. For example, the processor can be programmed to calculate the path of the energy beam and/or the power per unit area emitted by the energy source (e.g., that should be provided to the powder bed in order to achieve the requested result). Other control and/or computational scheme examples may be found in International Patent Application Serial No. PCT/US17/18191, filed Feb. 16, 2017, titled “ACCURATE THREE-DIMENSIONAL PRINTING;” which is incorporated herein by reference in their entirety.

At times, the 3D object printed by the 3D printing system is a high fidelity 3D object. At times, the generated 3D object (e.g., the hardened cover) is substantially smooth. The generated 3D object may have a deviation from an ideal planar surface (e.g., atomically flat or molecularly flat) of at most about 1.5 nanometers (nm), 2 nm, 3 nm, 4 nm, 5 nm, 10 nm, 15 nm, 20 nm, 25 nm, 30 nm, 35 nm, 100 nm, 300 nm, 500 nm, 1 micrometer (μm), 1.5 μm, 2 μm, 3 μm, 4 μm, 5 μm, 10 μm, 15 μm, 20 μm, 25 μm, 30 μm, 35 μm, 100 μm, 300 μm, 500 μm, or less. The generated 3D object may have a deviation from an ideal planar surface of at least about 1.5 nanometers (nm), 2 nm, 3 nm, 4 nm, 5 nm, 10 nm, 15 nm, 20 nm, 25 nm, 30 nm, 35 nm, 100 nm, 300 nm, 500 nm, 1 micrometer (μm), 1.5 μm, 2 μm, 3 μm, 4 μm, 5 μm, 10 μm, 15 μm, 20 μm, 25 μm, 30 μm, 35 μm, 100 μm, 300 μm, 500 μm, or more. The generated 3D object may have a deviation from an ideal planar surface between any of the afore-mentioned deviation values. The generated 3D object may comprise a pore. The generated 3D object may comprise pores. The pores may be of an average FLS (diameter or diameter equivalent in case the pores are not spherical) of at most about 1.5 nanometers (nm), 2 nm, 3 nm, 4 nm, 5 nm, 10 nm, 15 nm, 20 nm, 25 nm, 30 nm 35 nm, 100 nm, 300 nm, 500 nm, 1 micrometer (μm), 1.5 μm, 2 μm, 3 μm, 4 μm, 5 μm, 10 μm, 15 μm, or 20 μm. The pores may be of an average FLS of at least about 1.5 nanometers (nm), 2 nm, 3 nm, 4 nm, 5 nm, 10 nm, 15 nm, 20 nm, 25 nm, 30 nm, 35 nm, 100 nm, 300 nm, 500 nm, 1 micrometer (μm), 1.5 μm, 2 μm, 3 μm, 4 μm, 5 μm, 10 μm, 15 μm, or 20 μm. The pores may be of an average FLS between any of the afore-mentioned FLS values (e.g., from about 1 nm to about 20 μm). The 3D object (or at least a layer thereof) may have a porosity of at most about 0.05 percent (%), 0.1% 0.2%, 0.3%, 0.4%, 0.5%, 0.6%, 0.7%, 0.8%, 0.9%, 1%, 2%, 3%, 4%, 5%, 6%, 7%, 8%, 9%, 10%, 20%, 30%, 40%, 50%, 60%, 70%, or 80%. The 3D object (or at least a layer thereof) may have a porosity of at least about 0.05%, 0.1%, 0.2%, 0.3%, 0.4%, 0.5%, 0.6%, 0.7%, 0.8%, 0.9%, 1%, 2%, 3%, 4%, 5%, 6%, 7%, 8%, 9%, 10%, 20%, 30%, 40%, 50%, 60%, 70%, or 80%. The 3D object (or at least a layer thereof) may have porosity between any of the afore-mentioned porosity percentages (e.g., from about 0.05% to about 80%, from about 0.05% to about 40%, from about 10% to about 40%, or from about 40% to about 90%). In some instances, a pore may traverse the generated 3D object. For example, the pore may start at a face of the 3D object and end at the opposing face of the 3D object. The pore may comprise a passageway extending from one face of the 3D object and ending on the opposing face of that 3D object. In some instances, the pore may not traverse the generated 3D object. The pore may form a cavity in the generated 3D object. The pore may form a cavity on a face of the generated 3D object. For example, pore may start on a face of the plane and not extend to the opposing face of that 3D object.

The resolution of the printed 3D object may be at least about 1 micrometer, 1.3 micrometers (μm), 1.5 μm, 1.8 μm, 1.9 μm, 2.0 μm, 2.2 μm, 2.4 μm, 2.5 μm, 2.6 μm, 2.7 μm, 3 μm, 4 μm, 5 μm, 10 μm, 20 μm, 30 μm, 40 μm, 50 μm, 60 μm, 70 μm, 80 μm, 90 μm, 100 μm, 200 μm, or more. The resolution of the printed 3D object may be at most about 1 micrometer, 1.3 micrometers (μm), 1.5 μm, 1.8 μm, 1.9 μm, 2.0 μm, 2.2 μm, 2.4 μm, 2.5 μm, 2.6 μm, 2.7 μm, 3 μm, 4 μm, 5 μm, 10 μm, 20 μm, 30 μm, 40 μm, 50 μm, 60 μm, 70 μm, 80 μm, 90 μm, 100 μm, 200 μm, or less. The resolution of the printed 3D object may be any value between the above-mentioned resolution values. At times, the 3D object may have a material density of at least about 99.9%, 99.8%, 99.7%, 99.6%, 99.5%, 99.4%, 99.3%, 99.2% 99.1%, 99%, 98%, 96%, 95%, 94%, 93%, 92%, 91%, 90%, 8%, or 70%. At times, the 3D object may have a material density of at most about 99.5%, 99%, 98%, 96%, 95%, 94%, 93%, 92%, 91%, 90%, 8%, or 70%. At times, the 3D object may have a material density between the afore-mentioned material densities. The resolution of the 3D object may be at least about 100 dots per inch (dpi), 300 dpi, 600 dpi, 1200 dpi, 2400 dpi, 3600 dpi, or 4800 dpi. The resolution of the 3D object may be at most about 100 dpi, 300 dpi, 600 dpi, 1200 dpi, 2400 dpi, 3600 dpi, or 4800 dip. The resolution of the 3D object may be any value between the afore-mentioned values (e.g., from 100 dpi to 4800 dpi, from 300 dpi to 2400 dpi, or from 600 dpi to 4800 dpi). The height uniformity (e.g., deviation from average surface height) of a planar surface of the 3D object may be at least about 100 μm, 90 μm, 80 μm, 70 μm, 60 μm, 50 μm, 40 μm, 30 μm, 20 μm, 10 μm, or 5 μm. The height uniformity of the planar surface may be at most about 100 μm, 90 μm, 80 μm, 70 μm, 60 μm, 50 μm, 40 μm, 30 μm, 20 μm, 10 μm, or 5 μm. The height uniformity of the planar surface of the 3D object may be any value between the afore-mentioned height deviation values (e.g., from about 100 μm to about 5 μm, from about 50 μm to about 5 μm, from about 30 μm to about 5 μm, or from about 20 μm to about 5 μm). The height uniformity may comprise high precision uniformity.

In some embodiments the control system comprises a laser control system. The laser control system may comprise, or may be operatively coupled with, an optical translation control system. The laser control system may comprise, or be operatively coupled with, a laser system (e.g., optical system) of the 3D printing system, e.g., energy sources, optical components, translation mechanism, optical systems, motors, encoders, or the like. At times, the laser control system is operable to control operations of the optical system (e.g., comprising one or more optical assemblies) of the 3D printing system. The control system may be operable to adjust operations of the optical system (e.g., of the one or more optical assemblies) in response to a measured positional deviation of one or more aspects of the translatable optical system. The laser control system may be operable to adjust (e.g., calibrate) one or more characteristics of the irradiating energy (e.g., the energy beam) incident on the target surface, e.g., the exposed surface of the powder bed. Adjusting one or more characteristics of the irradiating energy beam may comprise a software adjustment (e.g., calibration). Adjusting one or more characteristics of the irradiating energy beam may comprise a hardware adjustment (e.g., calibration).

In some embodiments, the laser control system is configured to calibrate one or more characteristics of the irradiating energy (e.g., energy beam) in response to a positional deviation of the target surface, translational mechanism, optical system component(s), build platform assembly, or build platform, from a requested position. For example, the laser control system may be configured to calibrate one or more characteristics of the irradiating energy in response to a positional deviation of the target surface about an XY plane and/or about a rotational axis of the target surface (e.g., rotation about a central axis). For example, the laser control system may calibrate (i) the position at which the irradiating energy contacts a surface (e.g., the target surface), (ii) the shape of the footprint of the energy beam at the (e.g., target) surface, (iii) the XY offset of a first energy beam position at the (e.g., target) surface with respect to a second energy beam position at the (e.g., target) surface, and/or (iv) the XY offset of the energy beam with respect to the (e.g., target) surface. The position at which the energy beam contacts the surface is the position at which the energy beam impinges on the surface.

In some embodiments, the laser control system is configured to calibrate one or more characteristics of the irradiating energy (e.g., energy beam). A calibration may include a comparison of a commanded (e.g., instructed) energy beam position (e.g., at the target surface) compared with an actual (e.g., measured) energy beam position at the target surface. The characteristics of the energy beam may be calibrated along a field of view of the optical system (e.g., and/or detector). The laser control system may calibrate characteristics of a processing cone of the energy (e.g., laser beam). The calibration of the focus mechanism may achieve a requested spot or footprint size for various locations in the field of view of the irradiating energy (e.g., intersection of the processing cone with the target surface and/or calibration structure surface). The power density distribution measure may be calibrated (e.g., substantially) identically, or differently, along the field of view of the irradiating energy. In some embodiments, different positions in the field of view may require different focus offsets and/or or footprint size. Processing cone coverage of the powder bed can depend in part on dimensions of one or more of the mirrors of a scanner, e.g., galvanometric scanner, utilized to direct a path of the energy beam about the target surface. Laser control systems, control systems, controllers and operation thereof, 3D printing systems and processes, apparatus, methods, computer programs, are disclosed in International Patent Application Serial No. PCT/US19/14635 filed Jan. 22, 2019, and U.S. Provisional Patent Application Ser. No. 63/290,878 filed on Dec. 17, 2021, each of which is incorporated herein by reference in its entirety.

At times, a calibration comprises generating a compensation for one or more characteristics of the laser system. A compensation may be effectuated at least in part by a (e.g., energy beam) calibration. At times, an energy beam calibration comprises formation of one or more (e.g., physically printed or optically projected) alignment markers using at least one energy beam directed at a target surface. The one or more alignment markers may form an arrangement (e.g., a pattern). The position(s) of the marker(s) may be according to a requested (e.g., pre-determined) arrangement (e.g., a reference pattern). Requested may be according to a commanded arrangement as directed by commands to a guidance system for directing the energy beam(s). The arrangement (e.g., position(s)) of the one or more alignment markers may be detected by a detection system. The detected position(s) (e.g., measured position(s)) of the alignment marker(s) may be compared to commanded (e.g., requested) position(s). The energy beam calibration may comprise correction (e.g., compensation) of any deviation of the detected position(s) from the commanded position(s). The deviation of the detected position(s) from the commanded position(s) may be caused in part by (a) thermal effects on the energy beam and/or optical components, (b) position deviation of the target surface, (c) a non-uniformity of layer deposition, or (d) a combination thereof. Following application of the (e.g., initial) compensation to the energy beam (e.g., to the guidance system directing the energy beam), further (e.g., additional) calibration may be performed. Further calibration may (e.g., iteratively) improve the compensation of the any deviation between the detected position(s) from the commanded position(s) of the energy beam at the target surface. The deviation may depend on the nature and/or geometry of one or more optical elements of the optical system. The calibration may comprise altering the one or more elements (e.g., position thereof) of the optical system. The calibration may comprise altering a command to one or more elements of the optical system and/or to the energy source.

In some embodiments, the control system utilizes data from a metrological detection system. The control system may use the data to control one or more parameters of the 3D printing. For example, the control system may use the metrology data to control one or more positions of the optical system. At times, the control system may utilize a control scheme comprising a feedback control loop that utilizes alignment data, e.g., collected from one or more metrological detection systems to update control parameters of one or more control systems. Data collected from one or more metrological detection systems may comprise alignment data indicative of a position of at least one component of the optical system, for example, a position of (A) an optical assembly, (B) the array of optical assemblies, (C) the translation mechanism, (D) energy beam(s) of the optical system incident on the target surface, or (E) any combination of (A) to (D). The data collected from one or more metrological detection systems can be utilized by a feedback control loop to adjust a position of the component of the optical system, for example, a position of (A) an optical assembly, (B) the array of optical assemblies, (C) the translation mechanism, (D) energy beam(s) of the optical system incident on the target surface, or (E) any combination of (A) to (D). At times, a control scheme comprises a feedforward control that utilizes alignment data to update control parameters of one or more control systems. Alignment data may comprise historical data, e.g., data collected after a three-dimensional process performed by a three-dimensional printer. Historical data (e.g., historical measurements) may comprise characterization of three-dimensional objects formed utilizing the three-dimensional printer. The historical data may be utilized in a feedforward control to adjust a position of (A) an optical assembly, (B) the array of optical assemblies, (C) the translation mechanism, (D) energy beam(s) of the optical system incident on the target surface, or (E) any combination of (A) to (D). The control system may use the metrology data to control one or more parameters of the energy source and/or energy beam. The one or more measurements from the metrological detection system may be used to alter (e.g., in real time, and/or offline) the computer model. For example, the metrological detection system measurement(s) may be used to alter the optical proximity correction data. For example, the metrological detection system measurement(s) may be used to alter the printing instruction of one or more successive layers (e.g., during the printing of the 3D object).

In some embodiments, the detector and/or controller(s) averages at least a portion of the detected signal over time (e.g., period). In some embodiments, the detector and/or controller(s) reduces (at least in part) noise from the detected signal (e.g., over time). The noise may comprise detector noise, sensor noise, noise from the target surface, or any combination thereof. The noise from the target surface may arise from a deviation from planarity of the target surface (e.g., when a target surface comprises particulate material (e.g., powder)). The reduction of the noise may comprise using a filter, noise reduction algorithm, averaging of the signal over time, or any combination thereof.

In some embodiments, the controller(s) (e.g., continuously or intermittently) calculates an error value during the control time. The intermittent calculation may or may not be periodic. The error value may be the difference between a requested setpoint and a measured process variable. The control may be continuous control (e.g., during the 3D printing process, during formation of the 3D object, and/or during formation of a layer of hardened material). The control may be discontinuous. For example, the control may cause the occurrence of a sequence of discrete events. The control scheme may comprise a continuous, discrete, or batch control. The requested setpoint may comprise a temperature, power, power density, or a metrological (e.g., height) setpoint. The metrological setpoint may relate to the target surface (e.g., the exposed surface of the powder bed). The metrological setpoints may relate to one or more height setpoints of the target surface (e.g., the exposed (e.g., top) surface of the powder bed). The controller(s) may attempt to minimize an error (e.g., temperature and/or metrological error) over time by adjustment of a control variable. The control variable may comprise a direction and/or (electrical) power supplied to any component of the 3D printing apparatus and/or system. For example, direction and/or power supplied to the: energy beam, scanner, motor translating the platform, optical system component, optical diffuser, or any combination thereof.

In some embodiments, the systems, apparatuses, and/or components thereof comprise one or more controllers. The one or more controllers can comprise one or more central processing unit (CPU), input/output (I/O) and/or communications module. The CPU can comprise electronic circuitry that carries out instructions of a computer program by performing basic arithmetic, logical, control and I/O operations specified by the instructions. The controller can comprise a suitable software (e.g., operating system). The control system may optionally include a feedback control and/or feed-forward control loop. The controllers may be shared between one or more systems or apparatuses. Each apparatus or system may have its own controller. Two or more systems and/or its components may share a controller. Two or more apparatuses and/or its components may share a controller. The controller may be any controller (e.g., a controller used in 3D printing) such as, for example, the controller disclosed in Provisional Patent Application Ser. No. 62/252,330 that was filed on Nov. 6, 2015, titled “APPARATUSES, SYSTEMS AND METHODS FOR THREE-DIMENSIONAL PRINTING,” or in Provisional Patent Application Ser. No. 62/325,402 that was filed on Apr. 20, 2016, titled “METHODS, SYSTEMS, APPARATUSES, AND SOFTWARE FOR ACCURATE THREE-DIMENSIONAL PRINTING,” or in PCT Patent Application serial number PCT/US16/59781, that was filed on Oct. 31, 2016, titled “ADEPT THREE-DIMENSIONAL PRINTING”, all three of which are incorporated herein by reference in their entirety.

At times, multiple of tuning schemes can be generated for the one or more controllers, each tuning scheme selectable for a set of operating conditions and/or powder characteristics. For example, tuning scheme may utilize (i) a look-up table (LUT), (ii) historical data, (iii) experiments, (iv) physics simulation, (v) artificial intelligence, (vi) data analysis, and/or (vii) the like. The artificial intelligence may comprise training a plant model (a machine-learned model). The artificial intelligence may comprise data analysis. The training model may be trained utilizing (i) a look-up table (LUT), (ii) historical data, (iii) experiments, (iv) synthesized results from physics simulation, or (v) the like. In some embodiments, control scheme(s) can use a single plant model and project changes due to the temperature based on previously identified models. The control scheme(s) may be inscribed as program instructions (e.g., software).

In some embodiments, the control scheme used the controller(s) disclosed herein involve data analysis. The data analysis techniques involve one or more regression analys(es) and/or calculation(s). The regression analysis and/or calculation may comprise linear regression, least squares fit, Gaussian process regression, kernel regression, nonparametric multiplicative regression (NPMR), regression trees, local regression, semiparametric regression, isotonic regression, multivariate adaptive regression splines (MARS), logistic regression, robust regression, polynomial regression, stepwise regression, ridge regression, lasso regression, elasticnet regression, principal component analysis (PCA), singular value decomposition (SVD)), probability measure techniques (e.g., fuzzy measure theory, Borel measure, Harr measure, risk-neutral measure, Lebesgue measure), predictive modeling techniques (e.g., group method of data handling (GMDH), Naive Bayes classifiers, k-nearest neighbors algorithm (k-NN), support vector machines (SVMs), neural networks, support vector machines, classification and regression trees (CART), random forest, gradient boosting, generalized linear model (GLM)), or any other suitable probability and/or statistical analys(es). A learning scheme may comprise neural networks. The leaning scheme may comprise machine learning. The learning scheme may comprise pattern recognition. The learning scheme may comprise artificial intelligence, data miming, computational statistics, mathematical optimization, predictive analytics, discrete calculus, or differential geometry. The learning schemes may comprise supervised learning, reinforcement learning, unsupervised learning, semi-supervised learning. The learning scheme may comprise bias-variance decomposition. The learning scheme may comprise decision tree learning, associated rule learning, artificial neural networks, deep learning, inductive logic programming, support vector machines, clustering, Bayesian networks, reinforcement learning, representation learning, similarity and metric learning, sparse dictionary learning, or genetic algorithms (e.g., evolutional algorithm). The non-transitory computer media may comprise any of the computational schemes disclosed herein. The controller and/or processor may comprise the non-transitory computer media. The software may comprise any of the computational schemes disclosed herein. The controller and/or processor may comprise the software. The learning scheme may comprise random forest scheme.

In some embodiments, the control system utilizes a physics simulation in, e.g., in a computer model (e.g., comprising a prediction model, statistical model, a thermal model, or a thermo-mechanical model). The computer model may provide feedforward information to the control system. The computer model may provide the feed forward control scheme. There may be more than one computer models (e.g., at least 1, 2, 3, 4, 5, 6, 7, 8, 9 or 10 different computer models). The controller may (e.g., dynamically) switch between the computer models to predict and/or estimate the behavior of the optical elements. Dynamic includes changing computer models (e.g., in real time) based at least in part on a sensor input or based on a controller decision that may in turn be based at least in part on monitored target temperature. The dynamic switch may be performed in real-time, e.g., during operation of the optical system and/or during printing 3D object(s). The controller may be configured (e.g., reconfigured) to include additional one or more computer models and/or readjust the existing one or more computer models. A prediction may be done offline (e.g., predetermined) and/or in real-time. Examples of the calibration, control systems, controllers, and operation thereof, 3D printing systems and processes, apparatus, methods, and computer programs, are disclosed in International Patent Application serial number PCT/US19/14635, filed Jan. 22, 2019, titled “CALIBRATION IN THREE-DIMENSIONAL PRINTING,” which is incorporated herein by reference in its entirety.

In some instances, the processing unit includes one or more cores. The computer system may comprise a single core processor, multi core processor, or a plurality of processors for parallel processing. The processing unit may comprise one or more central processing unit (CPU) and/or a graphic processing unit (GPU). The multiple cores may be disposed in a physical unit (e.g., Central Processing Unit, or Graphic Processing Unit). The processing unit may include one or more processing units. The physical unit may be a single physical unit. The physical unit may be a die. The physical unit may comprise cache coherency circuitry. The multiple cores may be disposed in close proximity. The physical unit may comprise an integrated circuit chip. The integrated circuit chip may comprise one or more transistors. The close proximity may allow substantial preservation of communication signals that travel between the cores. The close proximity may diminish communication signal degradation. A core as understood herein is a computing component having independent central processing capabilities. The computing system may comprise a multiplicity of cores, which may be disposed on a single computing component. The multiplicity of cores may include two or more independent central processing units. The independent central processing units may constitute a unit that read and execute program instructions. The independent central processing units may constitute parallel processing units. The parallel processing units may be cores and/or digital signal processing slices (DSP slices). The multiplicity of cores can be parallel cores. The multiplicity of DSP slices can be parallel DSP slices. The multiplicity of cores and/or DSP slices can function in parallel. In some processors (e.g., FPGA), the cores may be equivalent to multiple digital signal processor (DSP) slices (e.g., slices). The plurality of DSP slices may be equal to any of plurality core values mentioned herein. The processor may comprise low latency in data transfer (e.g., from one core to another). Latency may refer to the time delay between the cause and the effect of a physical change in the processor (e.g., a signal). Latency may refer to the time elapsed from the source (e.g., first core) sending a packet to the destination (e.g., second core) receiving it (also referred as two-point latency). One-point latency may refer to the time elapsed from the source (e.g., first core) sending a packet (e.g., signal) to the destination (e.g., second core) receiving it, and the designation sending a packet back to the source (e.g., the packet making a round trip). The latency may be sufficiently low to allow a high number of floating point operations per second (FLOPS).

In some instances, the computer system includes hyper-threading technology. The computer system may include a chip processor with integrated transform, lighting, triangle setup, triangle clipping, rendering engine, or any combination thereof. The rendering engine may be capable of processing at least about 10 million polygons per second. The rendering engines may be capable of processing at least about 10 million calculations per second. As an example, the GPU may include a GPU by Nvidia, ATI Technologies, S3 Graphics, Advanced Micro Devices (AMD), or Matrox. The processing unit may be able to process scheme (e.g., algorithm) comprising a matrix or a vector. The core may comprise a complex instruction set computing core (CISC), or reduced instruction set computing (RISC).

In some instances, the computer system includes an electronic chip that is reprogrammable (e.g., field programmable gate array (FPGA)). For example, the FPGA may comprise Tabula, Altera, or Xilinx FPGA. The electronic chips may comprise one or more programmable logic blocks (e.g., an array). The logic blocks may compute combinational functions, logic gates, or any combination thereof. The computer system may include custom hardware. The custom hardware may comprise a computational scheme, e.g., embedded thereon.

In some instances, the computer system includes configurable computing, partially reconfigurable computing, reconfigurable computing, or any combination thereof. The computer system may include a FPGA. The computer system may include an integrated circuit that performs the computational scheme. For example, the reconfigurable computing system may comprise FPGA, CPU, GPU, or multi-core microprocessors. The reconfigurable computing system may comprise a High-Performance Reconfigurable Computing architecture (HPRC). The partially reconfigurable computing may include module-based partial reconfiguration, or difference-based partial reconfiguration. The FPGA may comprise configurable FPGA logic, and/or fixed-function hardware comprising multipliers, memories, microprocessor cores, first in-first out (FIFO) and/or error correcting code (ECC) logic, digital signal processing (DSP) blocks, peripheral Component interconnect express (PCI Express) controllers, ethernet media access control (MAC) blocks, or high-speed serial transceivers. DSP blocks can be DSP slices.

In some examples, the computing system includes an integrated circuit. The computing system may include an integrated circuit that performs the computational scheme (e.g., control scheme). In some instances, the controller uses calculations, real time measurements, or any combination thereof to regulate the energy beam(s).

In some embodiments, a user develops at least one 3D printing instruction and directs the 3D printer (e.g., through communication with the 3D printer processor) to print in a requested manner according to the developed at least one 3D printing instruction. A user may or may not be able to control (e.g., locally or remotely) the 3D printer controller, e.g., depending on permission preferences. For example, a client may not be able to control the 3D printing controller (e.g., maintenance of the 3D printer).

In some embodiments, the user (e.g., other than a client) processor may use real-time and/or historical 3D printing data of one or more 3D printers. The 3D printing data may comprise metrology data. The user processor may comprise quality control. The quality control may use a statistical method (e.g., statistical process control (SPC)). The user processor may log excursion log, report when a signal deviates from the nominal level, or any combination thereof. The user processor may generate a configurable response. The configurable response may comprise a print/pause/stop command (e.g., automatically) to the 3D printer (e.g., to the 3D printing processor). The configurable response may be based on a user defined parameter, threshold, or any combination thereof. The configurable response may result in a user defined action. The user processor may control the 3D printing process and ensure that it operates at its full potential. For example, at its full potential, the 3D printing process may make a maximum number of 3D object with a minimum of waste and/or 3D printer down time. The SPC may comprise a control chart, design of experiments, and/or focus on continuous improvement.

In some embodiments, the 3D printing system comprises a computer system. The computer system can control (e.g., direct, monitor, and/or regulate) various features of printing methods, apparatuses and systems of the present disclosure, such as, for example, control force, translation, heating, cooling and/or maintaining the temperature of a powder bed, process parameters (e.g., chamber pressure), scanning rate (e.g., of the energy beam and/or the platform), scanning route of the energy source, position and/or temperature of the cooling member(s), application of the amount of energy emitted to a selected location, or any combination thereof. The computer system can be part of, or be in communication with, a 3D printing system or apparatus. The computer may be coupled with one or more mechanisms disclosed herein, and/or any parts thereof. For example, the computer may be coupled with one or more sensors, valves, switches, motors, pumps, scanners, optical components, or any combination thereof.

In some embodiments, the computer system utilizes program instructions to execute, or direct execution of, operation(s). The program instructions can be inscribed in a machine executable code. Methods as described herein can be implemented by way of machine (e.g., computer processor) executable code stored on an electronic storage location of the computer system, such as, for example, on the memory, or electronic storage unit. The machine executable or machine-readable code can be provided in the form of software. During use, the processor can execute the code. In some cases, the code can be retrieved from the storage unit and stored on the memory for ready access by the processor. In some situations, the electronic storage unit can be precluded, and machine-executable instructions are stored on memory. The code can be pre-compiled and configured for use with a machine having a processer adapted to execute the code or can be compiled during runtime. The code can be supplied in a programming language that can be selected to enable the code to execute in a pre-compiled or as-compiled fashion.

In some embodiments, the computer system comprises a memory. The memory may comprise a random-access memory (RAM), dynamic random access memory (DRAM), static random access memory (SRAM), synchronous dynamic random access memory (SDRAM), ferroelectric random access memory (FRAM), read only memory (ROM), programmable read only memory (PROM), erasable programmable read only memory (EPROM), electrically erasable programmable read only memory (EEPROM), a flash memory, or any combination thereof. The flash memory may comprise a negative-AND (NAND) or NOR logic gates. A NAND gate (negative-AND) may be a logic gate which produces an output which is false only if all its inputs are true. The output of the NAND gate may be complemented to that of the AND gate. The storage may include a hard disk (e.g., a magnetic disk, an optical disk, a magneto-optic disk, a solid-state disk, etc.), a compact disc (CD), a digital versatile disc (DVD), a floppy disk, a cartridge, a magnetic tape, and/or another type of computer-readable medium, along with a corresponding drive.

In some embodiments, the computer system comprises an electronic storage unit. The electronic storage unit can be a data storage unit (or data repository) for storing data. In some embodiments, the storage unit stores files, such as drivers, libraries, and saved programs. The storage unit can store user data (e.g., user preferences and user programs). In some cases, the computer system can include one or more additional data storage units that are external to the computer system, such as located on a remote server that is in communication with the computer system through the network (e.g., an intranet or the Internet).

Aspects of the systems, apparatuses, and/or methods provided herein, such as the computer system, can be embodied in programming (e.g., using a software). Various aspects of the technology may be thought of as “product,” “object,” or “articles of manufacture” typically in the form of machine (or processor) executable code and/or associated data that is carried on or embodied in a type of machine-readable medium. Machine-executable code can be stored on the electronic storage unit, such memory (e.g., read-only memory, random-access memory, flash memory) or a hard disk. The storage may comprise non-volatile storage media. “Storage” type media can include any or all of the tangible memory of the computers, processors or the like, or associated modules thereof, such as various semiconductor memories, tape drives, disk drives, external drives, and the like, which may provide non-transitory storage at any time for the software programming.

In some embodiments, the computer system may comprise a processor or a plurality of processors. The processor may be a processing unit. The processing unit may include one or more processing units. The processor (e.g., 3D printer processor) may be programmed to implement methods of the disclosure. The processing unit can execute a sequence of machine-readable instructions, which can be embodied in a program or software. The instructions can be directed to the processing unit, which can subsequently program or otherwise configure the processing unit to implement methods of the present disclosure. Examples of operations performed by the processing unit can include fetch, decode, execute, and write back. The processing unit may interpret and/or execute instructions. The processor may include a microprocessor, a data processor, a central processing unit (CPU), a graphical processing unit (GPU), a system-on-chip (SOC), a co-processor, a network processor, an application specific integrated circuit (ASIC), an application specific instruction-set processor (ASIPs), a controller, a programmable logic device (PLD), a chipset, a field programmable gate array (FPGA), or any combination thereof. The processing unit can be part of a circuit, such as an integrated circuit. One or more other components of the system can be included in the circuit.

The processor may be configured to process control protocols, e.g., communicate with one or more components of the 3D printer system using the control protocols. Control protocols can be one or more of the internet protocol suite, e.g., transmission control protocol (TCP) or transmission control protocol/internet protocol (TCP/IP). Control protocols can be one or more of serial communication protocols. Control protocols can be one or more of controller area networks or another message-based protocol, e.g., for communication with microcontrollers and devices. Control protocols can interface with one or more serial bus interfaces for communication with the 3D printing system and its components. The control protocol can be any control protocol disclosed herein.

In some embodiments, the plurality of processors may form a network architecture. At least two of the plurality of the 3D printer processors may interact with each other. In some embodiments, a 3D printer processor interacts with at least one processor that acts as a 3D printer interface (also referred to herein as “machine interface processor”). The one or more machine interface processors may be connected to at least one 3D printer processor. The connection may be through a wire (e.g., cable) and/or be wireless (e.g., via Bluetooth technology). In some embodiments, the machine interface processor directs 3D print job production, 3D printer management, 3D printer monitoring, or any combination thereof.

The computer system can be operatively coupled with a computer network (“network”), e.g., with the aid of the communication interface. The network can be the Internet, an internet and/or extranet, or an intranet and/or extranet that is in communication with the Internet. In some cases, the network is a telecommunication and/or data network. The network can include one or more computer servers, which can enable distributed computing, such as cloud computing. The network, in some cases with the aid of the computer system, can implement a peer-to-peer network, which may enable devices coupled with the computer system to behave as a client or a server.

In some embodiments, the 3D printer comprises communicating through the network. The computer system can communicate with one or more remote computer systems through the network. For instance, the computer system can communicate with a remote computer system of a user (e.g., operator). Examples of remote computer systems include personal computers (e.g., portable PC), slate or tablet PC's (e.g., Apple® iPad, Samsung® Galaxy Tab), telephones, Smart phones (e.g., Apple® iphone, Android-enabled device, Blackberry®), or personal digital assistants. A user (e.g., client) can access the computer system via the network.

In some instances, all or portions of the software are at times communicated through the Internet and/or other telecommunication networks. Such communications, for example, may enable loading of the software from one computer or processor into another, for example, from a management server or host computer into the computer platform of an application server. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium or media that participate(s) in providing instructions to a processor for execution.

In some embodiments, the 3D printer comprises a communication technology. The communication may comprise wired or wireless communication. For example, the systems, apparatuses, and/or parts thereof may comprise Bluetooth, wi-fi, or global positioning system (GPS), or radio-frequency (RF) technology. The RF technology may comprise ultrawideband (UWB) technology. Systems, apparatuses, and/or parts thereof may comprise a communication port. The communication port may be a serial port or a parallel port. The communication port may be a Universal Serial Bus port (e.g., USB). The systems, apparatuses, and/or parts thereof may comprise USB ports. The USB can be micro or mini-USB. The surface identification mechanism may comprise a plug and/or a socket (e.g., electrical, AC power, DC power). The systems, apparatuses, and/or parts thereof may comprise an electrical adapter (e.g., AC and/or DC power adapter). The systems, apparatuses, and/or parts thereof may comprise a power connector. The power connector can be an electrical power connector. The power connector may comprise a magnetically attached power connector. The power connector can be a dock connector. The connector can be a data and power connector. The connector may comprise pins. The connector may comprise at least about 10, 15, 18, 20, 22, 24, 26, 28, 30, 40, 42, 45, 50, 55, 80, or 100 pins.

In some instances, the system and/or apparatus described herein (e.g., controller) and/or any of their components comprise an output and/or an input device. The input device may comprise a keyboard, touch pad, or microphone. The output device may be a sensory output device. The output device may include a visual, tactile, or audio device. The audio device may include a loudspeaker. The visual output device may include a screen and/or a printed hard copy (e.g., paper). The output device may include a printer. The input device may include a camera, a microphone, a keyboard, or a touch screen.

In some instances, the computer system comprises an electronic display. The computer system can include or be in communication with an electronic display that comprises a user interface (UI) for providing, for example, a model design or graphical representation of a 3D object to be printed. Examples of UI's include, without limitation, a graphical user interface (GUI) and web-based user interface. The computer system can monitor and/or control various aspects of the 3D printing system. The control may be manual and/or programmed. The control may rely on feedback mechanisms (e.g., from the one or more sensors). The control may rely on historical data. The feedback mechanism may be pre-programmed. The feedback mechanisms may rely on input from sensors (described herein) that are connected to the control unit (i.e., control system or control mechanism e.g., computer) and/or processing unit. The computer system may store historical data concerning various aspects of the operation of the 3D printing system. The historical data may be retrieved at predetermined times and/or at a whim. The historical data may be accessed by an operator and/or by a user. The historical, sensor, and/or operative data may be provided in an output unit such as a display unit. The output unit (e.g., monitor) may output (e.g., display) various parameters of the 3D printing system (as described herein) in real time or in a delayed time. The output unit may output the current 3D printed object (e.g., real time display of the 3D object as it is being printed), the requested 3D printed object (e.g., according to a model), the printed 3D object or any combination thereof. The output unit may output the cleaning progress of the object, or various aspects thereof. The output unit may output the printing progress of the 3D printed object. The output unit may output at least one of the total time, time remaining, and time expanded on printing the 3D object. The output unit may output (e.g., display, voice, and/or print) the status of sensors, their reading, and/or time for their calibration or maintenance. The output unit may output the type of material(s) used and various characteristics of the material(s) such as temperature and flowability of the powder. The output unit may display the amount of a certain gas in the chamber. The output unit may output the amount of oxidizing gas (e.g., oxygen), hydrogen, water vapor, or any of the gases mentioned herein, and pressure in the printing chamber (i.e., the chamber where the 3D object is being printed). The computer may generate a report comprising various parameters of the 3D printing system, method, and or objects at predetermined time(s), on a request (e.g., from an operator), and/or at a whim. The output unit may comprise a screen, printer, or speaker. The control system may provide a report. The report may comprise any items recited as optionally output by the output unit.

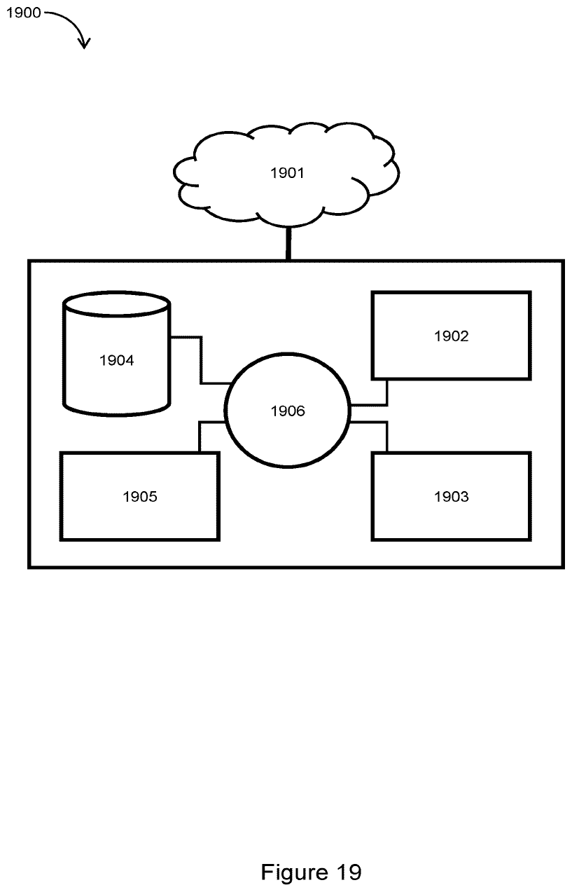

FIG. 19 is a schematic example of a computer system 1900 that is programmed or otherwise configured to facilitate the formation of a 3D object according to the methods provided herein. The computer system 1900 can include a processing unit 1906 (also “processor,” “computer” and “computer processor” used herein). The computer system may include memory or memory location 1902 (e.g., random-access memory, read-only memory, flash memory), electronic storage unit 1904 (e.g., hard disk), communication interface 1903 (e.g., network adapter) for communicating with one or more other systems, and peripheral devices 1905, such as cache, other memory, data storage and/or electronic display adapters. The memory 1902, storage unit 1904, interface 1903, and peripheral devices 1905 are in communication with the processing unit 1906 through a communication bus (solid lines), such as a motherboard.

All publications, patents, and patent applications mentioned in this specification are herein incorporated by reference to the same extent as if each individual publication, patent, or patent application was specifically and individually indicated to be incorporated by reference.

While preferred embodiments of the present invention have been shown, and described herein, it will be obvious to those skilled in the art that such embodiments are provided by way of example only. It is not intended that the present disclosure be limited by the specific examples provided within the specification. While the present disclosure has been described with reference to the afore-mentioned specification, the descriptions and illustrations of the embodiments herein are not meant to be construed in a limiting sense. Numerous variations, changes, and substitutions will now occur to those skilled in the art without departing from the present disclosure. Furthermore, it shall be understood that all aspects of the present disclosure are not limited to the specific depictions, configurations, or relative proportions set forth herein which depend upon a variety of conditions and variables. It should be understood that various alternatives to the embodiments described herein might be employed in practicing the present disclosure. It is therefore contemplated that the present disclosure shall also cover any such alternatives, modifications, variations, or equivalents. It is intended that the following claims define the scope of the present disclosure and that methods and structures within the scope of these claims and their equivalents be covered thereby.

What is claimed is:

1. A device for three-dimensional (3D) printing a three-dimensional (3D) object, the device comprising:
a buffer reservoir configured to enclose a first powder material to be used for the 3D printing;
a valve operatively coupled to the buffer reservoir and configured to provide the first powder material to a second powder material to generate a starting material for the 3D printing, the second powder material being previously used in the 3D printing or in another 3D printing operation;
a powder conveyance system operatively coupled to the valve and configured to allow the starting material to pass therethrough;
wherein at least a portion of the second powder material is degraded during its passage in the powder conveyance system or during the 3D printing; and
wherein the valve is configured to facilitate addition of the first material to the powder conveyance system if a ratio of the degraded portion of the second powder material to the remaining portion of the second powder material is above a threshold.

2. The device of claim 1, wherein the powder conveyance system is configured to enclose a robust gas comprising a reactive agent in a concentration lower than that in an ambient atmosphere external to the powder conveyance system, the reactive agent being configured to react with the powder material to generate a reaction product (a) during propagation of the powder material in the powder conveyance system and/or (b) during the printing, the degradation of the powder material comprising the reaction product.

3. The device of claim 1, wherein the first powder material and the second powder material include elemental metal, metal alloy, an allotrope of elemental carbon, or a ceramic.

4. The device of claim 1, wherein the powder conveyance system further comprises a separator operatively coupled to the valve.

5. The device of claim 4, wherein the separator includes a cyclonic separator or a sieve assembly.

6. The device of claim 1, wherein the powder conveyance system is configured to mix the first powder material with the second powder material to generate the starting material.

7. The device of claim 1, wherein the powder conveyance system is configured to mix the first powder material with the second powder material at least in part by flowing the first powder material with the second powder material in a channel of the powder conveyance system, inserting the first powder material into a separator of the powder conveyance system, or adding the first powder material and the second powder material into a reservoir of the powder conveyance system.

8. The device of claim 1, further comprising a sensor configured to detect the ratio of the degraded portion of the second powder material to the remaining portion of the second powder material.

9. The device of claim 1, wherein the valve is configured to control flow of the first powder material into the powder conveyance system continuously, intermittently, or not flow.

10. The device of claim 1, wherein the powder conveyance system is configured to direct the starting material to a material dispensing mechanism configured to dispense the starting material layerwise to facilitate print the 3D object.

11. The device of claim 1, wherein the buffer reservoir is configured to enclose an internal atmosphere that is different by at least one characteristic from an ambient environment external to the buffer reservoir.

12. A system for three-dimensional (3D) printing a three-dimensional (3D) object comprising one or more memory devices configured to store instructions that, when executed by one or more processors, cause the one or more processors to:
detect, via a sensor, a ratio of a degraded powder material to a non-degraded powder material in a first powder material, wherein at least a portion of the first powder material is disposed within a powder conveyance system;
determine, via a processor, if the ratio of the degraded powder material to the non-degraded powder material is above a threshold;
if the ratio of the degraded powder material to the non-degraded powder material is above the threshold, actuate a valve to provide an amount of non-degraded powder material from a second powder material disposed within a buffer reservoir to the portion of the first powder material disposed within the powder conveyance system, the buffer reservoir being coupled to the powder conveyance system via the valve; and
mix, via the powder conveyance system, the first powder material with the second powder material to form a starting material.

13. The system of claim 12, wherein the powder conveyance system is configured to enclose a robust gas comprising a reactive agent in a concentration lower than that in an ambient atmosphere external to the powder conveyance system, the reactive agent being configured to react with the first powder material to generate a reaction product while the powder material is disposed within the powder conveyance system or during the 3D printing.

14. The system of claim 12, wherein the first powder material and the second powder material include elemental metal, metal alloy, an allotrope of elemental carbon, or a ceramic.

15. The system of claim 12, wherein the powder conveyance system further comprises a separator operatively coupled to the valve.

16. The system of claim 15, wherein the separator includes a cyclonic separator or a sieve assembly.

17. The system of claim 12, wherein the powder conveyance system is configured to mix the first powder material with the second powder material at least in part by flowing the first powder material with the second powder material in a channel of the powder conveyance system, inserting the first powder material into a separator of the powder conveyance system, or adding the first powder material and the second powder material into a reservoir of the powder conveyance system.

18. The system of claim 12, wherein the valve is configured to control flow of the second powder material into the powder conveyance system continuously, intermittently, or not flow.

19. The system of claim 12, wherein the powder conveyance system is configured to direct the starting material to a material dispensing mechanism configured to dispense the starting material layerwise to facilitate the 3D printing.

20. The system of claim 12, wherein the buffer reservoir is configured to enclose an internal atmosphere that is different by at least one characteristic from an ambient environment external to the buffer reservoir.
